(19) United States
(12) Patent Application Publication
(10) Pub. No.: US 2012/0161617 A1
(43) Pub. Date: Jun. 28, 2012

(54) ORGANIC ELECTROLUMINESCENCE DEVICE

(75) Inventor: Eiji Fukuzaki, Kanagawa (JP)

(73) Assignee: FUJIFILM CORPORATION, Tokyo (JP)

(21) Appl. No.: 13/393,361

(22) PCT Filed: Aug. 27, 2010
(86) PCT No.: PCT/JP2010/065092

§ 371 Date: Feb. 29, 2012

(30) Foreign Application Priority Data
Aug. 31, 2009 (JP) 2009-201154

(51) Int. Cl. H05B 33/14; C09K 11/06

(52) U.S. Cl. 313/504; 252/301.16

(57) ABSTRACT

An organic electroluminescence device including a substrate having thereon a pair of electrodes and at least one organic layer including a light-emitting layer containing a light-emitting material between the pair of electrodes, wherein the light-emitting layer contains at least each of a specific 3,3′-dicarbazolylbiphenyl compound and an iridium complex having a specific structure.

### TECHNICAL FIELD

The present invention relates to a luminescence device capable of emitting light by converting electric energy to light, in particular, an organic electroluminescence device (a luminescence device or an EL device).

### BACKGROUND ART

Organic electroluminescence (EL) devices are attracting public attention as promising display devices for capable of emitting light of high luminance with low voltage. An important characteristic value of the organic electroluminescence devices is consumed electric power. The consumed electric power is expressed by the product of voltage and current, and the lower the value of voltage necessary to obtain desired brightness and the lower the value of current, the less can be made the consumed electric power of the device.

As a trial to lower the value of current flowing to a device, luminescence devices using light emission from Ir(ppy)₃: tris-ortho-metalated complex of Iridium(III) with 2-phenylpyridine are reported (refer to, e.g., US 2008-0297033). These phosphorescent devices are greatly improved in external quantum efficiency as compared with conventional luminescence devices of singlet state and have achieved to lessen the value of current.

A device using a phosphorescent material whose durability is improved and light emission spectrum is sharpened by the introduction of an alkyl group into a specific position is reported (refer to WO 09/073,245), but further improvement of durability is desired (in particular, at the time of high luminance drive for illumination use and the like).

As phosphorescent devices having a high light emitting efficiency and improved durability, devices using, as the host material, a compound having a biphenyl-linked carbazole structure are reported (refer to WO 00/070,655 and WO 04/101,707), but further improvement is required of these devices in the point of durability.

Further, in the manufacture of an organic electroluminescence device, for forming a film of an organic layer provided between a pair of electrodes, a vacuum deposition method is used as the deposition method and a spin coating method, a printing method and an inkjet method are used as the wet method.

Above all by the use of a wet process, it also becomes possible to use a polymeric organic compound that is difficult to form a film by a dry process such as deposition or the like. Therefore, the film obtained by a wet process is suitable in the point of durability such as flexibility and film strength for use in a flexible display or the like, and is especially preferred in the case of being used as a large area film.

However, there is such a problem that an organic electroluminescence device obtained by a wet process is inferior in the durability of device.

### SUMMARY OF THE INVENTION

An object of the invention is to provide an organic electroluminescence device having high durability (in particular, at the time of high luminance drive) and little in aberration of chromaticity after deterioration of the device.

The above object has been achieved by the following means.

An organic electroluminescence device including a substrate having thereon a pair of electrodes and at least one organic layer including a light-emitting layer containing a light-emitting material between the pair of electrodes,

wherein the light-emitting layer contains at least each of a compound represented by the following formula (1) and a compound represented by the following formula (D-1).

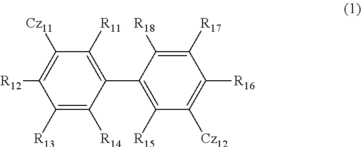

In formula (1), each of R₁₁ to R₁₈ independently represents a hydrogen atom or a substituent; and each of Cz₁₁ and Cz₁₂ independently represents the following partial structure (Cz-1).

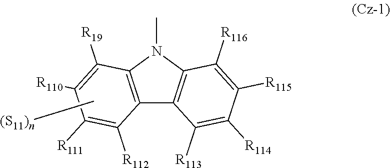

In formula (Cz-1), each of R₁₉ to R₁₁₆ independently represents a hydrogen atom or a substituent; S₁₁ represents substituent (S) shown below, which is substituted for any one of R₁₉ to R₁₁₂; R₁ represents an alkyl group; R₂ represents a hydrogen atom or an alkyl group; R₃ represents a hydrogen atom or an alkyl group; and n represents an integer of 0 or 1.

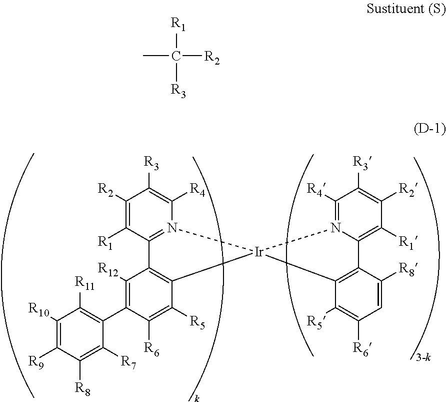

In formula (D-1), each of R₁ to R₁₂ independently represents a hydrogen atom or a substituent; each of R₁′ to R₈′ independently represents a hydrogen atom or a substituent, and at least one of R₁ to R₁₂ and R₁′ to R₈′ represents an alkyl group or an aryl group; and k is an integer of 0 to 3, and when k is 0, the sum total of the carbon atoms of R₁′ to R₈′ is 2 or more.

The organic electroluminescence device according to [1], wherein the compound represented by formula (1) is a compound represented by the following formula (2).

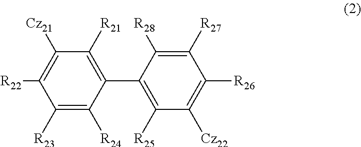

In formula (2), each of R₂₁ to R₂₈ independently represents a hydrogen atom or a substituent; and each of Cz₂₁ and Cz₂₂ independently represents the following partial structure (Cz-2).

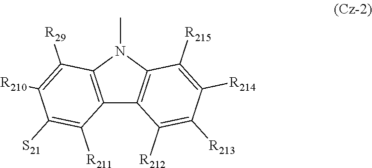

In formula (Cz-1), each of R₂₉ to R₂₁₅ independently represents a hydrogen atom or a substituent; and S₂₁ represents the above substituent (S).

The organic electroluminescence device according to [1], wherein the compound represented by formula (1) is a compound represented by the following formula (3).

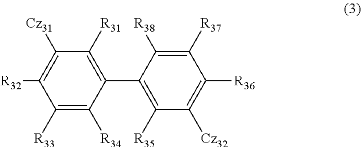

In formula (3), each of R₃₁ to R₃₈ independently represents a hydrogen atom or a substituent; and each of Cz₃₁ and Cz₃₂ independently represents the following partial structure (Cz-3).

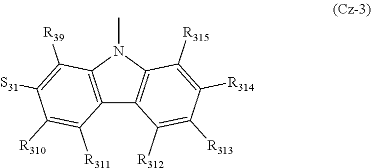

In formula (Cz-3), each of R₃₉ to R₃₁₅ independently represents a hydrogen atom or a substituent; and S₃₁ represents the above substituent (S).

The organic electroluminescence device according to [1], wherein at least one of R₁ to R₁₂ and R₁′ to R₈′ in formula (D-1) represents a methyl group, an isobutyl group, a neopentyl group, a phenyl group, or a tolyl group.

The organic electroluminescence device according to [1], wherein at least one of R₁ to R₁₂ and R₁′ to R₈′ in formula (D-1) represents a methyl group, an isobutyl group, or a neopentyl group.

The organic electroluminescence device according to any of [1] to [3], wherein the compound represented by formula (D-1) is a compound represented by the following formula (D-2).

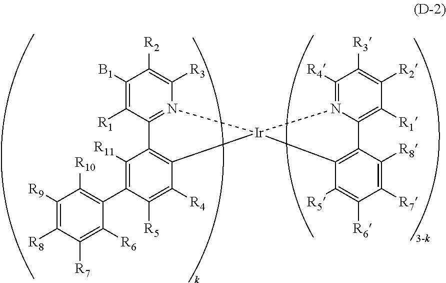

In formula (D-2), each of R₁ to R₁₁ independently represents a hydrogen atom or a substituent; each of R₁′ to R₈′ independently represents a hydrogen atom or a substituent; B₁ represents a methyl group, an isobutyl group, or a neopentyl group; and k is an integer of 1 to 3.

The organic electroluminescence device according to any of [1] to [3], wherein the compound represented by formula (D-1) is a compound represented by the following formula (D-3).

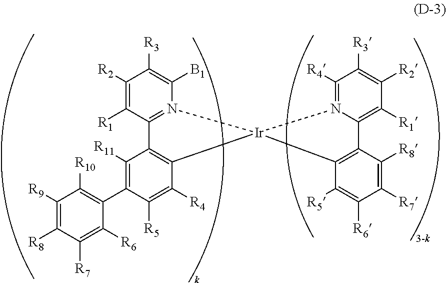

In formula (D-3), each of R₁ to R₁₁ independently represents a hydrogen atom or a substituent; each of R₁′ to R₈′ independently represents a hydrogen atom or a substituent; B₁ represents a methyl group, an isobutyl group, or a neopentyl group; and k is an integer of 1 to 3.

The organic electroluminescence device according to any of [1] to [3], wherein the compound represented by formula (D-1) is a compound represented by the following formula (D-4).

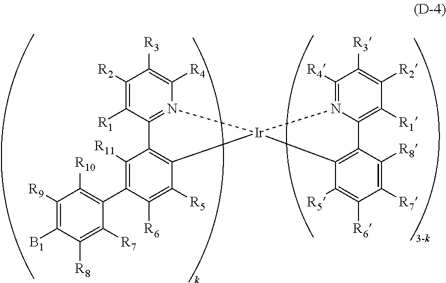

In formula (D-4), each of R₁ to R₁₁ independently represents a hydrogen atom or a substituent; each of R₁′ to R₈′ independently represents a hydrogen atom or a substituent; B₁ represents a methyl group, an isobutyl group, or a neopentyl group; and k is an integer of 1 to 3.

The organic electroluminescence device according to any of [1] to [3], wherein the compound represented by formula (D-1) is a compound represented by the following formula (D-5).

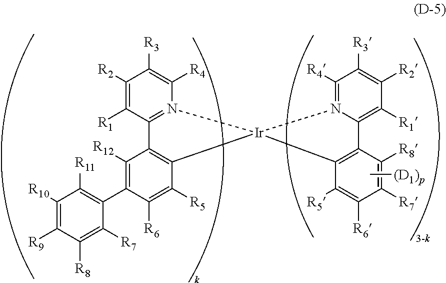

In formula (D-5), each of R₁ to R₁₂ independently represents a hydrogen atom or a substituent; each of R₁′ to R₈′ independently represents a hydrogen atom or a substituent, and at least one of R₁ to R₁₂ and R₁′ to R₈′ represents a methyl group, an isobutyl group, or a neopentyl group; D₁ represents an electron-withdrawing group selected from a fluorine atom, a trifluoromethyl group and a cyano group, D₁ is substituted for any of R₅′ to R₈′, and each of a plurality of D₁ may be the same with or different from every other D₁; k represents an integer of 1 to 3; and p represents an integer of 1 to 4.

The organic electroluminescence device according to any of [1] to [3], wherein the compound represented by formula (D-1) is a compound represented by the following formula (D-6).

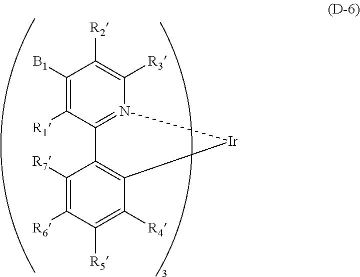

In formula (D-6), each of R₁′ to R₇′ independently represents a hydrogen atom or a substituent, and at least one of R₁′ to R₇′ represents an alkyl group; and B₁ represents a methyl group, an isobutyl group, or a neopentyl group.

The organic electroluminescence device according to any of [1] to [3], wherein the compound represented by formula (D-1) is a compound represented by the following formula (D-7).

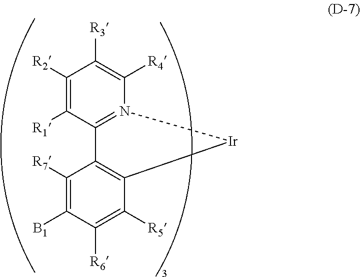

In formula (D-7), each of R₁′ to R₇′ independently represents a hydrogen atom or a substituent, and at least one of R₁′ to R₇′ represents an alkyl group; and B₁ represents a methyl group, an isobutyl group, or a neopentyl group.

The organic electroluminescence device according to any of [1] to [11], wherein the light-emitting layer containing at least each of the compound represented by the above formula (1) and the compound represented by the above formula (D-1) is formed by a wet process.

A composition containing at least each of a compound represented by the following formula (1) and a compound represented by the following formula (D-1).

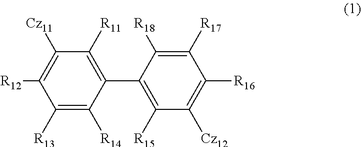

In formula (1), each of R¹¹ to R₁₈ independently represents a hydrogen atom or a substituent; and each of Cz₁₁ and Cz₁₂ independently represents the following partial structure (Cz-1).

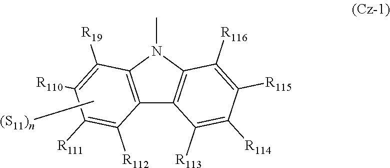

In formula (Cz-1), each of R₁₉ to R₁₁₆ independently represents a hydrogen atom or a substituent; S₁₁ represents substituent (S) shown above, which is substituted for any one of R₁₉ to R₁₁₂; and n represents an integer of 0 or 1.

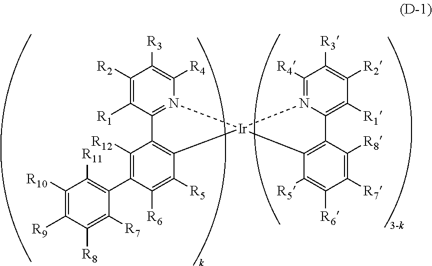

In formula (D-1), each of R₁ to R₁₂ independently represents a hydrogen atom or a substituent; each of R₁′ to R₈′ independently represents a hydrogen atom or a substituent, and at least one of R₁ to R₁₂ and R₁′ to R₈′ represents an alkyl group or an aryl group; and k is an integer of 0 to 3.

A light-emitting layer containing at least each of a compound represented by the following formula (1) and a compound represented by the following formula (D-1).

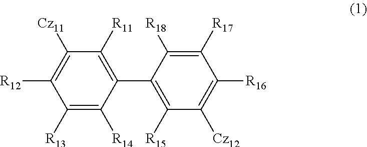

In formula (1), each of R₁₁ to R₁₈ independently represents a hydrogen atom or a substituent; and each of Cz₁₁ and Cz₁₂ independently represents the following partial structure (Cz-1).

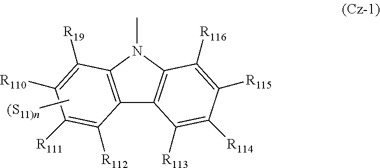

In formula (Cz-1), each of R₁₉ to R₁₁₆ independently represents a hydrogen atom or a substituent; S₁₁ represents substituent (S) shown above, which is substituted for any one of R₁₉ to R₁₁₂; and n represents an integer of 0 or 1.

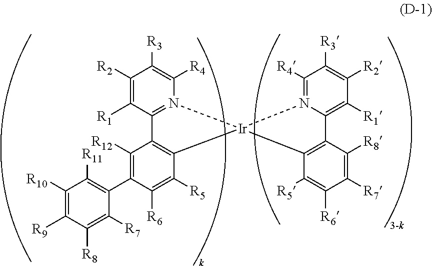

In formula (D-1), each of R₁ to R₁₂ independently represents a hydrogen atom or a substituent; each of R₁′ to R₈′ independently represents a hydrogen atom or a substituent, and at least one of R₁ to R₁₂ and R₁′ to R₈′ represents an alkyl group or an aryl group; and k is an integer of 0 to 3.

A light emission apparatus using the organic electroluminescence device described in any of [1] to [12].

A display apparatus using the organic electroluminescence device described in any of [1] to [12].

An illumination apparatus using the organic electroluminescence device described in any of [1] to [12].

The invention can provide an organic electroluminescence device having high durability (in particular, at the time of high luminance drive) and little in aberration of chromaticity after deterioration of the device.

### BRIEF DESCRIPTION OF THE DRAWINGS

FIG. 1 is a schematic view showing an example of the constitution of the organic electroluminescence device according to the invention.

FIG. 2 is a schematic view showing an example of light emission apparatus according to the invention.

FIG. 3 is a schematic view showing an example of illumination apparatus according to the invention.

### DESCRIPTION OF EMBODIMENTS

An organic electroluminescence device according to the invention includes a substrate having thereon a pair of electrodes and at least one organic layer including a light-emitting layer containing a light-emitting material between the pair of electrodes, wherein the light-emitting layer contains at least each of a compound represented by formula (1) and a compound represented by formula (D-1).

The compound represented by formula (1) is a compound group called 3,3′-dicarbazolylbiphenyl in which the carbazole structure is linked via 3,3′-biphenyl. As the minimum triplet excited state (T1) energy level (e.g., 3,3′-dicarbazolylbiphenyl, 68 kcal/mol) of the compound represented by formula (1) is large as compared with T1 energy level (60 kcal/mol) of CBP (4,4′-dicarbazolylbiphenyl) ordinary used as the light emitting layer host material, it is thought that decomposition reaction from excitation state easily occurs, and lowering of driving durability of a device easily occurs. However, in the invention, by the use of the compound represented by formula (1) and the compound represented by formula (D-1) in combination, durability of a device can be improved (in particular, at the time of high luminance drive).

As compared with CBP, the compound represented by formula (1) is high in oxidation potential in cyclic voltamogram (CV) measurement (for example, oxidation potential of 3,3′-dicarbazolylbiphenyl: E=1.4 V, oxidation potential of CBP: E=1.3 V (compared in the potential showing maximum electric current value, reference electrode: Ag/Ag⁺)), and it is thought that a chemically unstable dicationic state is difficult to form. Further, the compound represented by formula (1) linked via 3,3′-biphenyl does not form a quinoid structure in a dicationic state, accordingly the compound is difficult to become an emission quencher of low T1 even when a dicationic state is deactivated. On the other hand, it is thought that since CBP can take a quinoid structure in a dicationic state, an emission quencher of low T1 is easily formed.

Holes and electrons injected to a device are recombined in a light-emitting layer and form excitons, thus the organic electroluminescence device emits light. Since holes injected to a device are mainly injected to the host material in a light emitting layer, the duration of life of the device relies upon durability of the host material in a cationic state. When the compound represented by formula (1) is used as the host material, it is thought that a chemically unstable dicationic state is difficult to be formed as compared with CBP, so that decomposition of the host material from the dication and generation of a quencher are reduced, as a result the duration of life of the device is prolonged. In particular, at the time of high luminance drive, a vast quantity of current flows to the device and the amount of holes injected into the light-emitting layer increases, and the charge balance in the light-emitting layer becomes excess of holes because of the difference of charge mobility (holes and electrons). Thus, it is presumed that dications of the host material are more likely to be generated, and durability of the device greatly increases by the use of the compound represented by formula (1), which is difficult to form a dicationic state, as the host material.

Further, by the use in combination of the compound represented by formula (1) and the compound represented by formula (D-1) which is protected with an alkyl group on the specific position, the intermolecular distance between the light-emitting material and the host material is increased, so that it is thought that dimerization reaction and decomposition reaction between the host material in a cationic state and the light emitting material are restrained and the durability of the device is further improved. The effect by the introduction of an alkyl group comes out more strongly in dimerization reaction and decomposition reaction with chemically more unstable dications of the host material, and increase in durability of the device at the time of high luminance driving is presumably made possible.

Further, by the decreases of dimerization reaction and decomposition reaction, generations of charge trapping and light emission constituent of low T1 energy (emission constituent of long wavelength) that exert a baneful influence upon chromaticity are restrained, so that aberration of chromaticity at the time of driving deterioration is expected to lessen.

### [Compound Represented by Formula (1)]

The compound represented by formula (1) will be described in detail below.

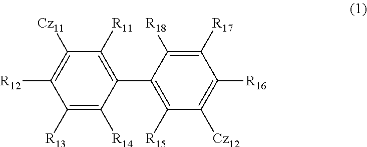

In formula (1), each of R₁₁ to R₁₅ independently represents a hydrogen atom or a substituent. Each of Cz₁₁ and Cz₁₂ independently represents the following partial structure (Cz-1).

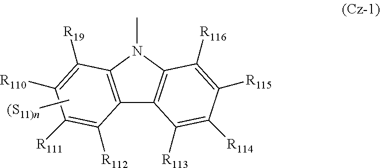

In formula (Cz-1), each of R₁₉ to R₁₁₆ independently represents a hydrogen atom or a substituent. S₁₁ represents substituent (S) shown below, which is substituted for any one of R₁₉ to R₁₁₂. R₁ represents an alkyl group, R₂ represents a hydrogen atom or an alkyl group, and R₃ represents a hydrogen atom or an alkyl group. n represents an integer of 0 or 1.

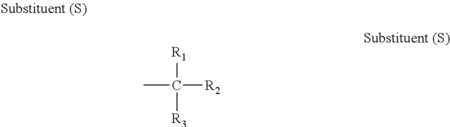

In formula (1), each of R₁₁ to R₁₈ independently represents a hydrogen atom or a substituent. As the examples of the substituents represented by R₁₁ to R₁₈, the following substituent group A can be applied thereto.

### (Substituent Group A)

The examples of substituent group A include an alkyl group (preferably having 1 to 30 carbon atoms, more preferably 1 to 20 carbon atoms, and especially preferably 1 to 10 carbon atoms, e.g., methyl, ethyl, isopropyl, tert-butyl, n-octyl, n-decyl, n-hexadecyl and the like are exemplified), an alicyclic hydrocarbon group (preferably having 1 to 30 carbon atoms, more preferably 1 to 20 carbon atoms, and especially preferably 1 to 10 carbon atoms, e.g., adamantyl, cyclopropyl, cyclopentyl, cyclohexyl and the like are exemplified), an alkenyl group (preferably having 2 to 30 carbon atoms, more preferably 2 to 20 carbon atoms, and especially preferably 2 to 10 carbon atoms, e.g., vinyl, allyl, 2-butenyl, 3-pentenyl and the like are exemplified), an alkynyl group (preferably having 2 to 30 carbon atoms, more preferably 2 to 20 carbon atoms, and especially preferably 2 to 10 carbon atoms, e.g., propargyl, 3-pentynyl and the like are exemplified), an aryl group (preferably having 6 to 30 carbon atoms, more preferably 6 to 20 carbon atoms, and especially preferably 6 to 12 carbon atoms, e.g., phenyl, p-methylphenyl, naphthyl, anthranyl and the like are exemplified), an amino group (preferably having 0 to 30 carbon atoms, more preferably 0 to 20 carbon atoms, and especially preferably 0 to 10 carbon atoms, e.g., amino, methylamino, dimethylamino, diethylamino, dibenzylamino, diphenylamino, ditolylamino and the like are exemplified), an alkoxy group (preferably having 1 to 30 carbon atoms, more preferably 1 to 20 carbon atoms, and especially preferably 1 to 10 carbon atoms, e.g., methoxy, ethoxy, butoxy, 2-ethylhexyloxy and the like are exemplified), an aryloxy group (preferably having 6 to 30 carbon atoms, more preferably 6 to 20 carbon atoms, and especially preferably 6 to 12 carbon atoms, e.g., phenyloxy, 1-naphthyloxy, 2-naphthyloxy and the like are exemplified), a heterocyclic oxy group (preferably having 1 to 30 carbon atoms, more preferably 1 to 20 carbon atoms, and especially preferably 1 to 12 carbon atoms, e.g., pyridyloxy, pyrazyloxy, pyrimidyloxy, quinolyloxy and the like are exemplified), an acyl group (preferably having 1 to 30 carbon atoms, more preferably 1 to 20 carbon atoms, and especially preferably 1 to 12 carbon atoms, e.g., acetyl, benzoyl, formyl, pivaloyl and the like are exemplified), an alkoxycarbonyl group (preferably having 2 to 30 carbon atoms, more preferably 2 to 20 carbon atoms, and especially preferably 2 to 12 carbon atoms, e.g., methoxycarbonyl, ethoxycarbonyl and the like are exemplified), an aryloxycarbonyl group (preferably having 7 to 30 carbon atoms, more preferably 7 to 20 carbon atoms, and especially preferably 7 to 12 carbon atoms, e.g., phenyloxycarbonyl and the like are exemplified), an acyloxy group (preferably having 2 to 30 carbon atoms, more preferably 2 to 20 carbon atoms, and especially preferably 2 to 10 carbon atoms, e.g., acetoxy, benzoyloxy and the like are exemplified), an acylamino group (preferably having 2 to 30 carbon atoms, more preferably 2 to 20 carbon atoms, and especially preferably 2 to 10 carbon atoms, e.g., acetylamino, benzoylamino and the like are exemplified), an alkoxycarbonylamino group (preferably having 2 to 30 carbon atoms, more preferably 2 to 20 carbon atoms, and especially preferably 2 to 12 carbon atoms, e.g., methoxycarbonylamino and the like are exemplified), an aryloxycarbonylamino group (preferably having 7 to 30 carbon atoms, more preferably 7 to 20 carbon atoms, and especially preferably 7 to 12 carbon atoms, e.g., phenyloxycarbonylamino and the like are exemplified), a sulfonylamino group (preferably having 1 to 30 carbon atoms, more preferably 1 to 20 carbon atoms, and especially preferably 1 to 12 carbon atoms, e.g., methanesulfonylamino, benzenesulfonylamino and the like are exemplified), a sulfamoyl group (preferably having 0 to 30 carbon atoms, more preferably 0 to 20 carbon atoms, and especially preferably 0 to 12 carbon atoms, e.g., sulfamoyl, methylsulfamoyl, dimethylsulfamoyl, phenylsulfamoyl and the like are exemplified), a carbamoyl group (preferably having 1 to 30 carbon atoms, more preferably 1 to 20 carbon atoms, and especially preferably 1 to 12 carbon atoms, e.g., carbamoyl, methylcarbamoyl, diethylcarbamoyl, phenylcarbamoyl and the like are exemplified), an alkylthio group (preferably having 1 to 30 carbon atoms, more preferably 1 to 20 carbon atoms, and especially preferably 1 to 12 carbon atoms, e.g., methylthio, ethylthio and the like are exemplified), an arylthio group (preferably having 6 to 30 carbon atoms, more preferably 6 to 20 carbon atoms, and especially preferably 6 to 12 carbon atoms, e.g., phenylthio and the like are exemplified), a heterocyclic thio group (preferably having 1 to 30 carbon atoms, more preferably 1 to 20 carbon atoms, and especially preferably 1 to 12 carbon atoms, e.g., pyridylthio, 2-benzimidazolylthio, 2-benzoxazolylthio, 2-benzothiazolylthio and the like are exemplified), a sulfonyl group (preferably having 1 to 30 carbon atoms, more preferably 1 to 20 carbon atoms, and especially preferably 1 to 12 carbon atoms, e.g., mesyl, tosyl and the like are exemplified), a sulfinyl group (preferably having 1 to 30 carbon atoms, more preferably 1 to 20 carbon atoms, and especially preferably 1 to 12 carbon atoms, e.g., methanesulfinyl, benzenesulfinyl and the like are exemplified), an ureido group (preferably having 1 to 30 carbon atoms, more preferably 1 to 20 carbon atoms, and especially preferably 1 to 12 carbon atoms, e.g., ureido, methylureido, phenylureido and the like are exemplified), a phosphoric amide group (preferably having 1 to 30 carbon atoms, more preferably 1 to 20 carbon atoms, and especially preferably 1 to 12 carbon atoms, e.g., diethylphosphoric amide, phenylphosphoric amide and the like are exemplified), a hydroxyl group, a mercapto group, a halogen atom (e.g., a fluorine atom, a chlorine atom, a bromine atom, and an iodine atom), a cyano group, a sulfo group, a carboxyl group, a nitro group, a hydroxamic acid group, a sulfino group, a hydrazino group, an imino group, a heterocyclic group (preferably having 1 to 30 carbon atoms, and more preferably 1 to 12 carbon atoms, the examples of the hetero atoms include e.g., a nitrogen atom, an oxygen atom and a sulfur atom, and specifically imidazolyl, pyridyl, quinolyl, furyl, thienyl, piperidyl, morpholino, benzoxazolyl, benzimidazolyl, benzothiazolyl, carbazolyl, azepinyl and the like are exemplified), a silyl group (preferably having 3 to 40 carbon atoms, more preferably 3 to 30 carbon atoms, and especially preferably 3 to 24 carbon atoms, e.g., trimethylsilyl, triphenylsilyl and the like are exemplified), and a silyloxy group (preferably having 3 to 40 carbon atoms, more preferably 3 to 30 carbon atoms, and especially preferably 3 to 24 carbon atoms, e.g., trimethylsilyloxy, triphenylsilyloxy and the like are exemplified).

Each of R₁₁ to R₁₈ may further have a substituent, and the above substituent group A can be applied to the substituent. Two or more of these substituents may be bonded to each other to form a ring.

Each of R₁₁ to R₁₈ preferably represents a hydrogen atom, an alkyl group, an alicyclic hydrocarbon group, an aryl group, a fluorine group, an amino group, an alkoxy group, an aryloxy group, a heterocyclic oxy group, an alkylthio group, an arylthio group, a heterocyclic thio group, a cyano group, a heterocyclic group, a silyl group, or a silyloxy group, more preferably represents a hydrogen atom, an alkyl group, an alicyclic hydrocarbon group, an aryl group, a fluorine group, a cyano group, a silyl group, or a heterocyclic group, still more preferably a hydrogen atom, an alkyl group, an alicyclic hydrocarbon group, an aryl group, a fluorine group or a cyano group, and especially preferably a hydrogen atom, an aryl group, or an alkyl group.

Each of R₁₉ to R₁₁₆ represents a hydrogen atom or a substituent, and the foregoing substituent group A can be applied to the substituent.

Each of R₁₉ to R₁₁₆ may further have a substituent, and the above substituent group A can be used as the substituent. Further, two or more of these substituents may be bonded to each other to form a ring.

Each of R₁₉ to R₁₁₆ preferably represents a hydrogen atom, an alkyl group, an alicyclic hydrocarbon group, an aryl group, a fluorine group, an amino group, an alkoxy group, an aryloxy group, a heterocyclic oxy group, an alkylthio group, an arylthio group, a heterocyclic thio group, a cyano group, a heterocyclic group, a silyl group, or a silyloxy group, more preferably represents a hydrogen atom, an alkyl group, an alicyclic hydrocarbon group, an aryl group, a fluorine group, a cyano group, a silyl group, or a heterocyclic group, still more preferably a hydrogen atom, an alkyl group, an alicyclic hydrocarbon group, an aryl group, a fluorine group or a cyano group, still yet preferably a hydrogen atom or an alkyl group, still further preferably a hydrogen atom or an alkyl group having 1 to 3 carbon atoms, and especially preferably a hydrogen atom.

S₁₁ represents substituent (S) shown above, which is substituted for any one of R₁₉ to R₁₁₂.

R₁ represents an alkyl group. R₁ preferably represents a methyl group, an ethyl group, a propyl group, an isopropyl group, a butyl group, or a tert-butyl group, more preferably a methyl group, an ethyl group, a propyl group, an isopropyl group, or a tert-butyl group, still more preferably a methyl group, an ethyl group, an isopropyl group, or a tert-butyl group, and especially preferably a methyl group, an ethyl group, or a tert-butyl group.

R₂ represents a hydrogen atom or an alkyl group. R₂ preferably represents a hydrogen atom, a methyl group, an ethyl group, a propyl group, an isopropyl group, a butyl group, or a tert-butyl group, more preferably a hydrogen atom, a methyl group, an ethyl group, or a propyl group, still more preferably a hydrogen atom or a methyl group, and especially preferably a methyl group.

R₃ represents a hydrogen atom or an alkyl group. R₃ preferably represents a hydrogen atom or a methyl group, and more preferably a methyl group.

R₁, R₂ and R₃ may be bonded to each other to form a ring. In the case of forming a ring, number of the member of ring is not especially restricted, but it is preferably 5- or 6-membered ring, and more preferably a 6-membered ring.

As substituent (S), the following (a) to (x) can be preferably exemplified, more preferably (a) to (j) and (w), still more preferably (a) to (g), still yet preferably (a) to (e), and especially preferably (a) to (c).

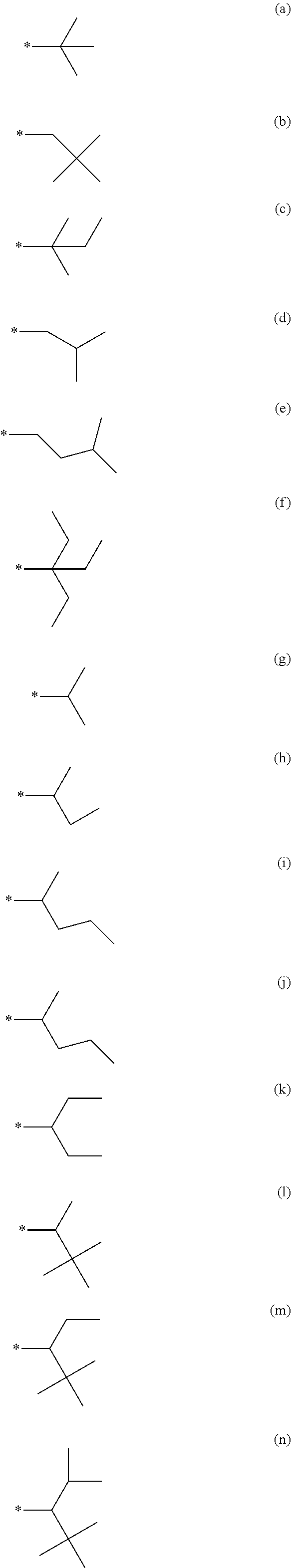

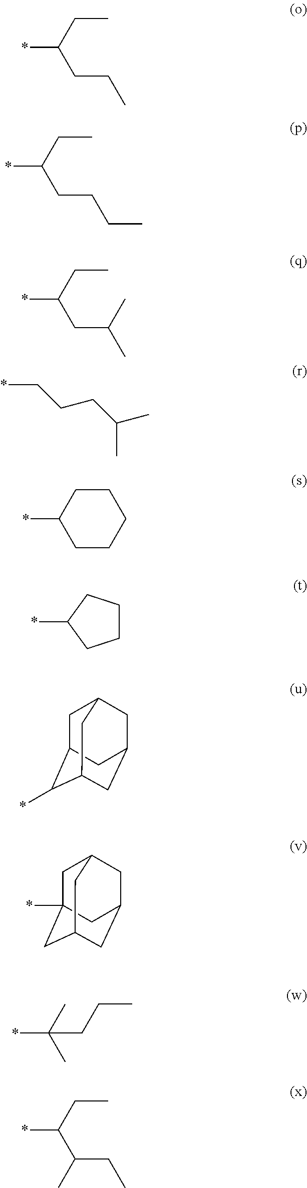

In formula (1), n represents an integer of 0 or 1, and preferably 1. By the introduction of the substituent represented by S₁₁, the activated position in a cationic or anionic state of the carbazole structure is protected, as a result decomposition reaction of the host material in the device is lessened and durability of the device is further improved.

One of the preferred embodiments of the compound represented by formula (1) is a compound represented by the following formula (2). The activated position of the compound represented by formula (2) in a cationic state of the carbazole structure is protected, as a result decomposition reaction of the host material in the device is lessened and durability of the device is further improved.

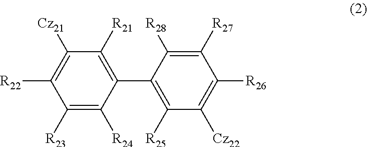

In formula (2), each of R₂₁ to R₂₈ independently represents a hydrogen atom or a substituent. Each of Cz₂₁ and Cz₂₂ independently represents the following partial structure (Cz-2).

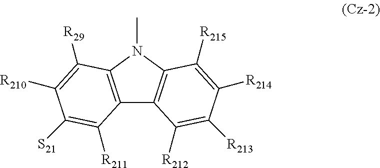

In formula (Cz-2), each of R₂₉ to R₂₁₅ independently represents a hydrogen atom or a substituent. S₂₁ represents the above substituent (S).

In formula (2), R₂₁ to R₂₈, Cz₂₁, Cz₂₂, R₂₉ to R₂₁₅, and S₂₁ respectively have the same meaning as R₁₁ to R₁₈, Cz₁₁, Cz₁₂, R₁₉ to R₁₁₆ and S₁₁ in formula (1), and preferred ranges are also the same.

One of the preferred embodiments of the compound represented by formula (1) is a compound represented by the following formula (3). The activated position of the compound represented by formula (3) in an anionic state of the carbazole structure is protected, as a result decomposition reaction of the host material in the device is lessened and durability of the device is further improved.

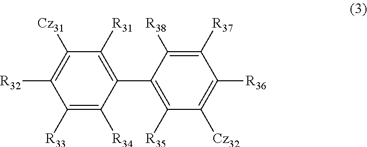

In formula (3), each of R₃₁ to R₃₈ independently represents a hydrogen atom or a substituent. Each of Cz₃₁ and Cz₃₂ independently represents the following partial structure (Cz-3).

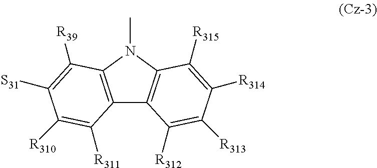

In formula (Cz-3), each of R₃₉ to R₃₁₅ independently represents a hydrogen atom or a substituent. S₃₁ represents the above substituent (S).

In formula (3), R₃₁ to R₃₈, Cz₃₁, Cz₃₂, R₃₉ to R₃₁₅, and S₃₁ respectively have the same meaning as R₁₁ to R₂₈, Cz₁₁, Cz₁₂, R₁₉ to R₁₁₆ and S₁₁ in formula (1), and preferred ranges are also the same.

The preferred specific examples of the compounds represented by any of formulae (1) to (3) are shown below, but the invention is by no means restricted thereto.

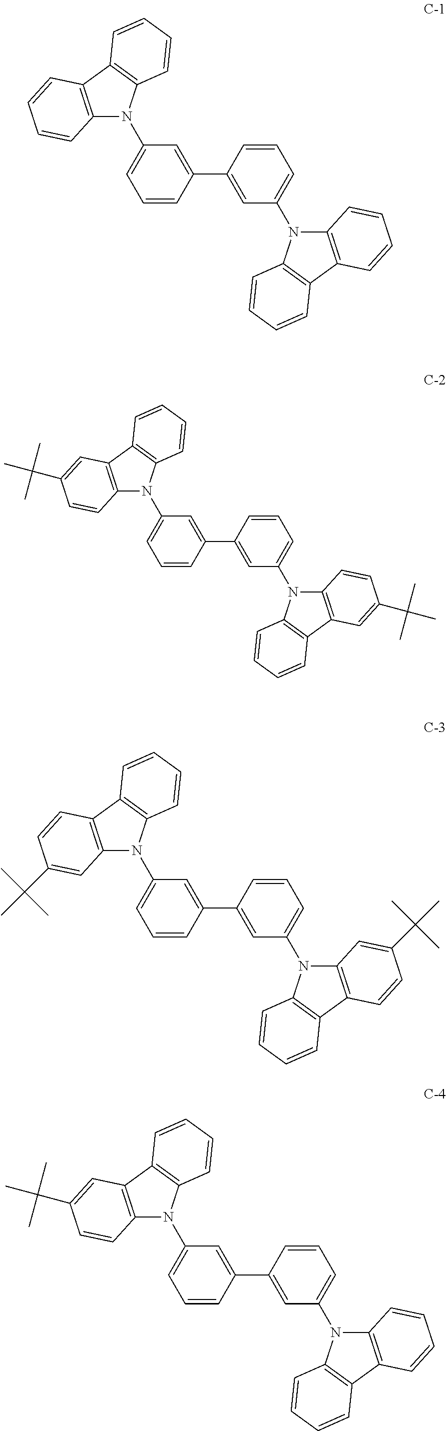

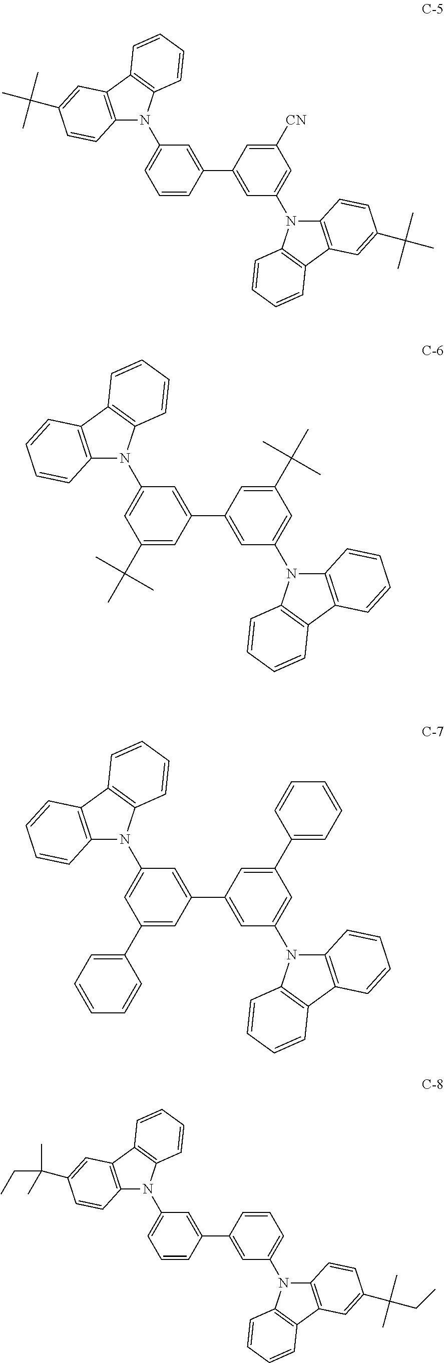

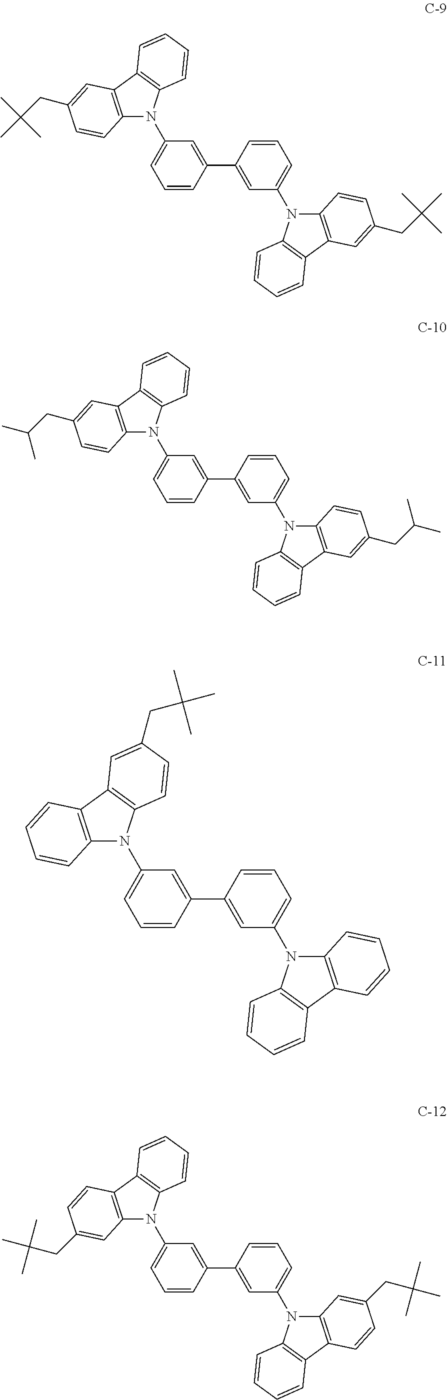

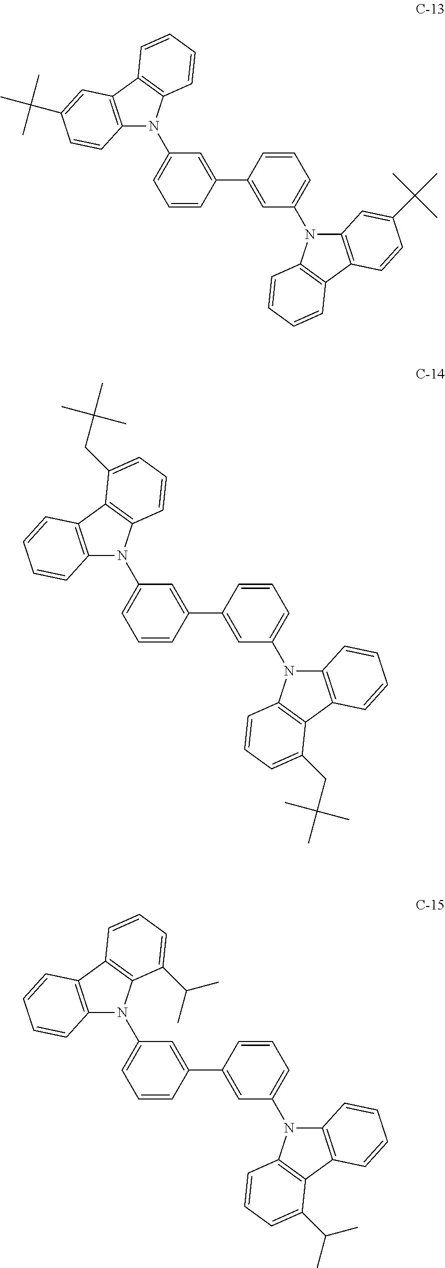

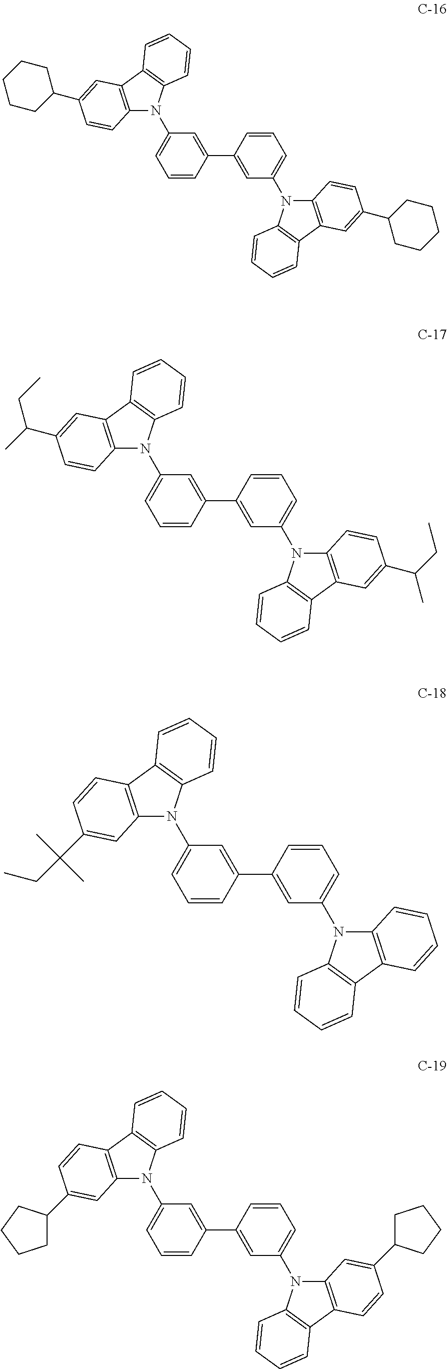

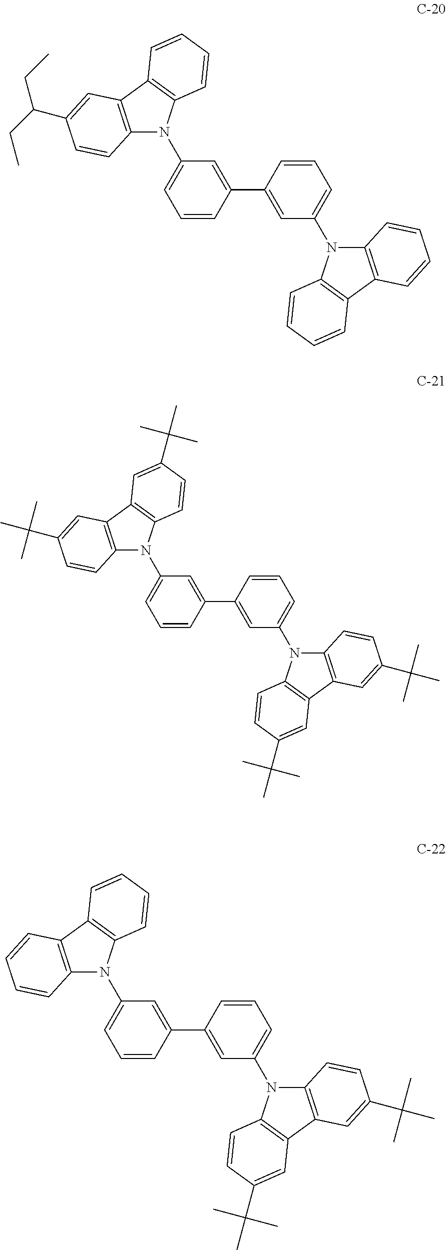

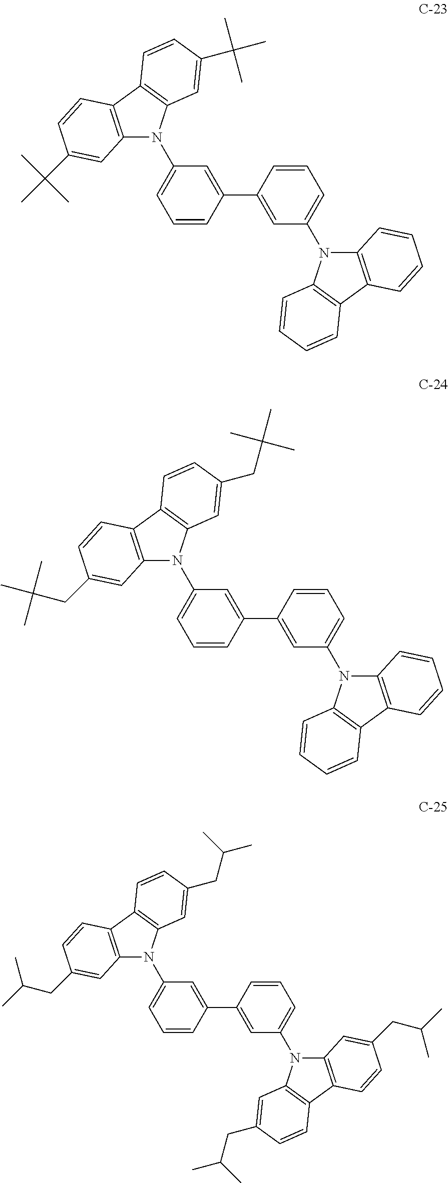

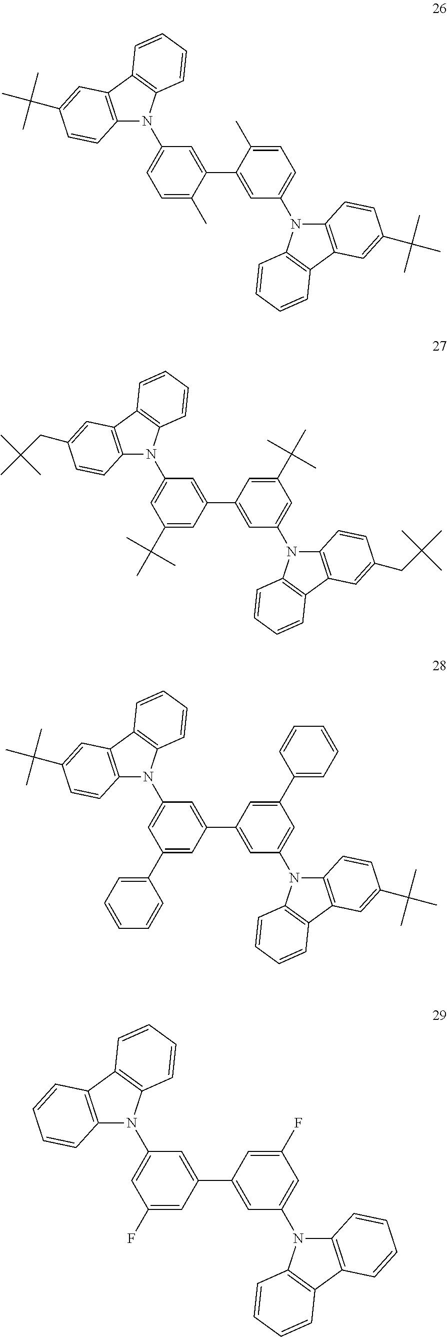

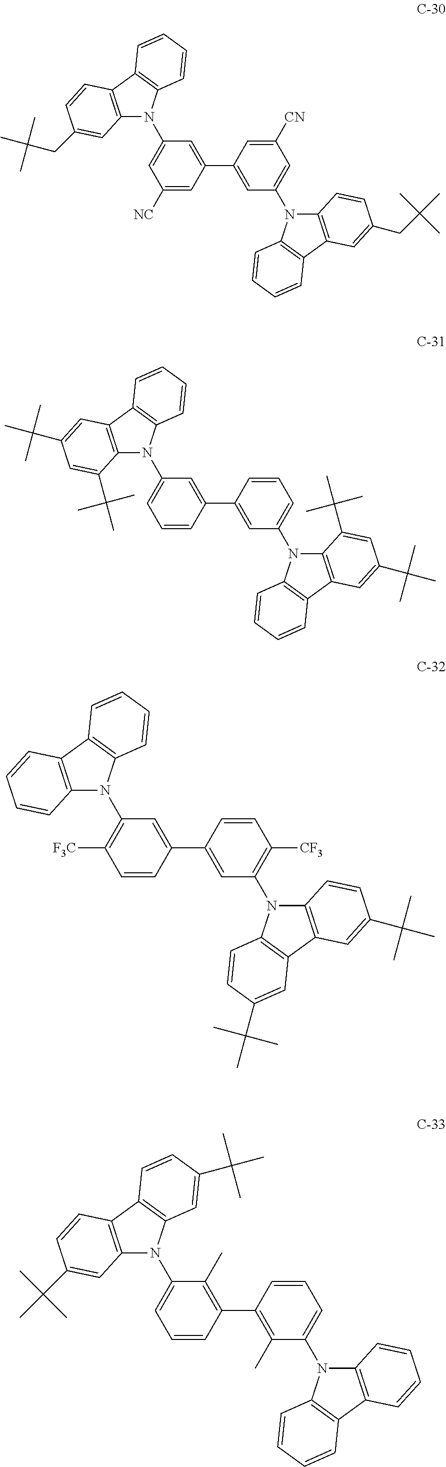

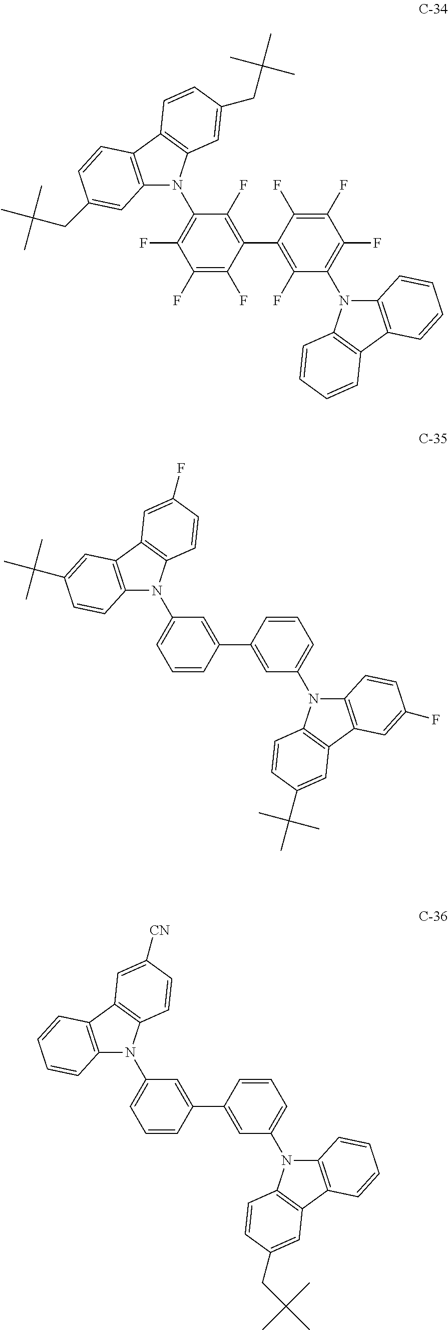

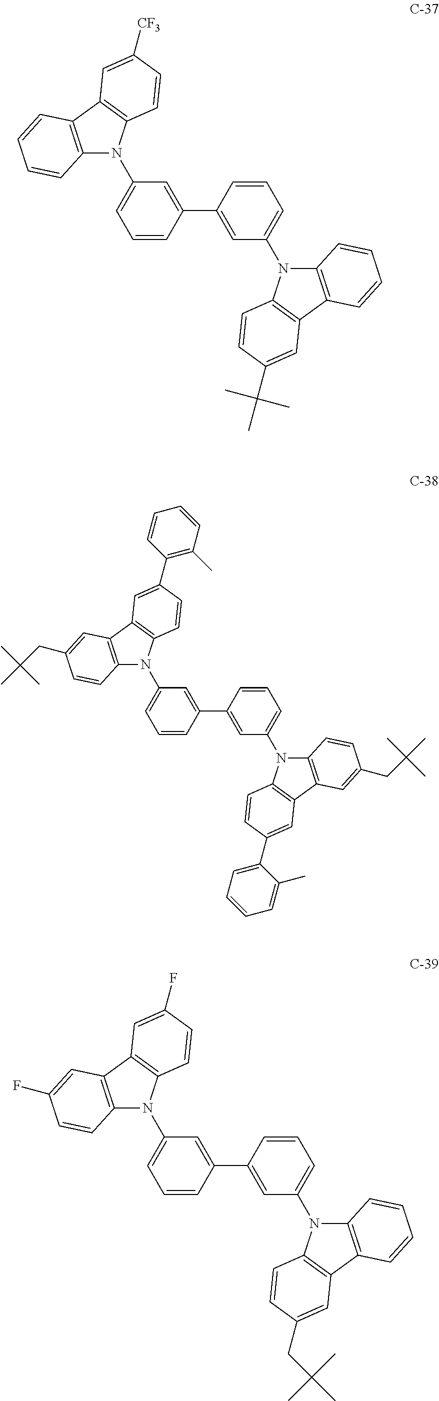

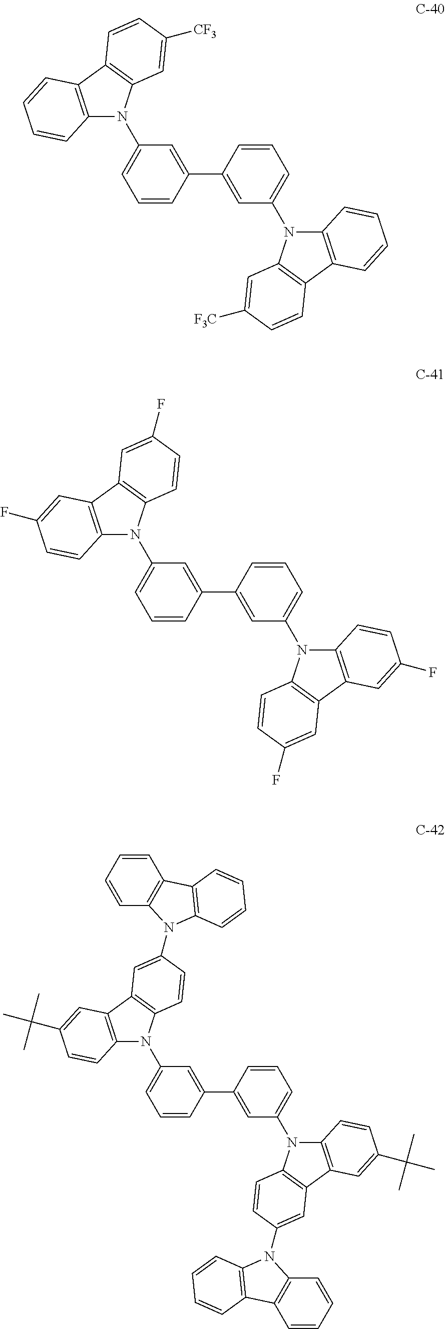

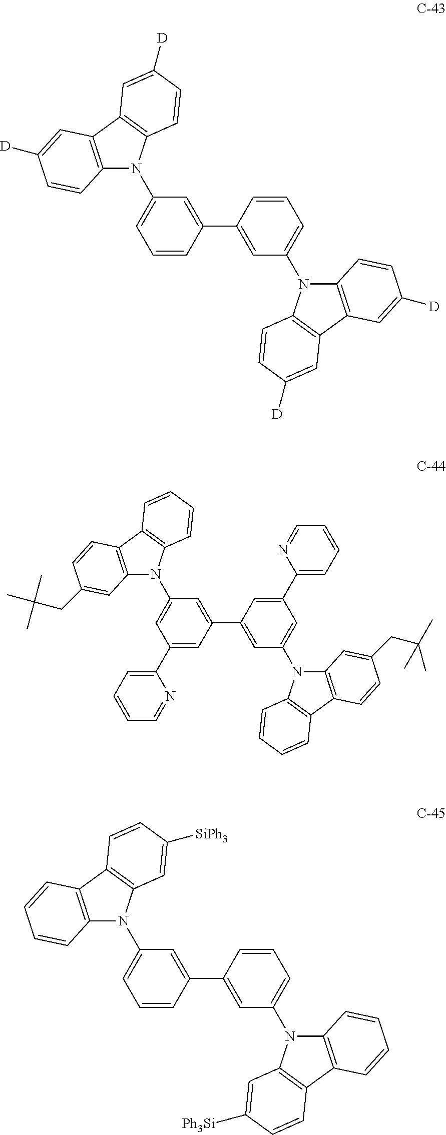

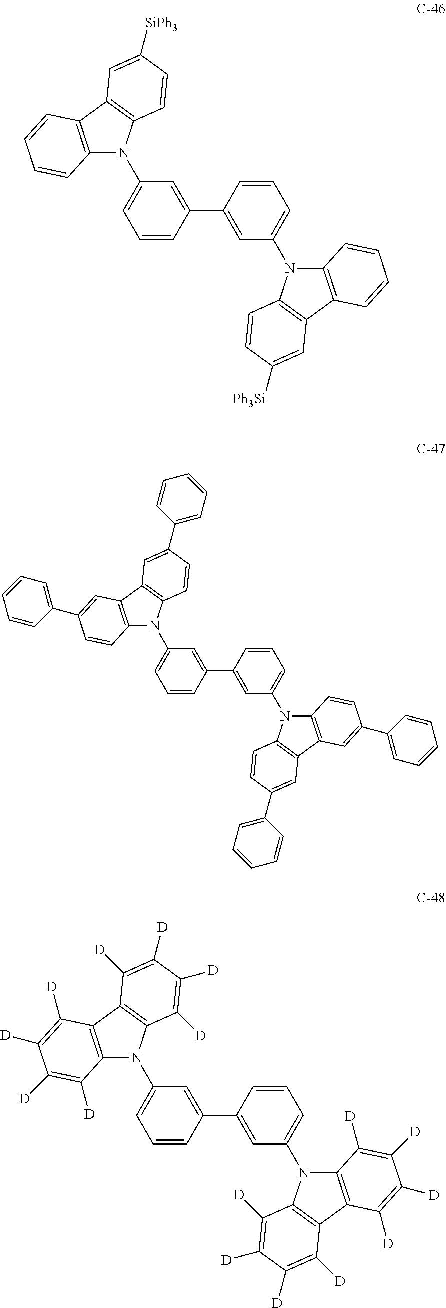

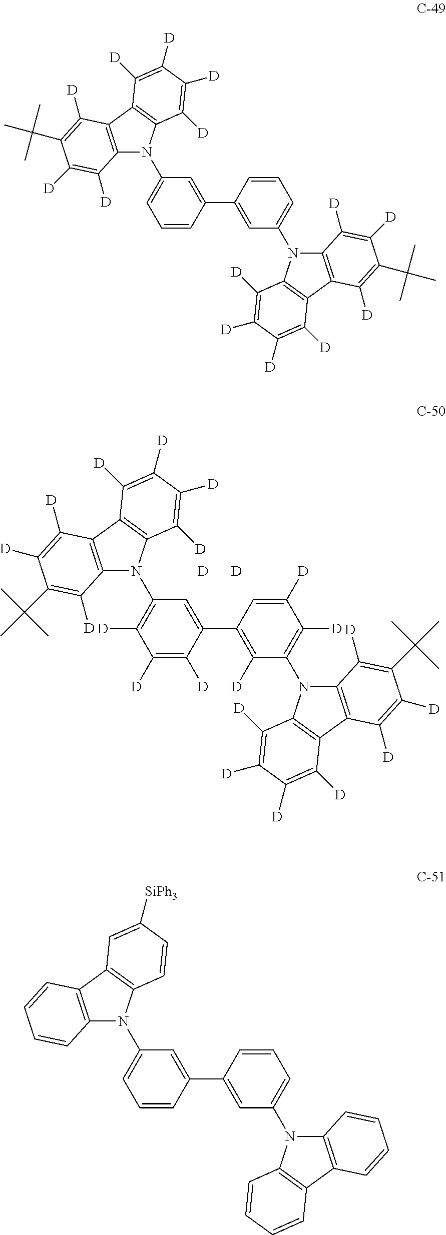

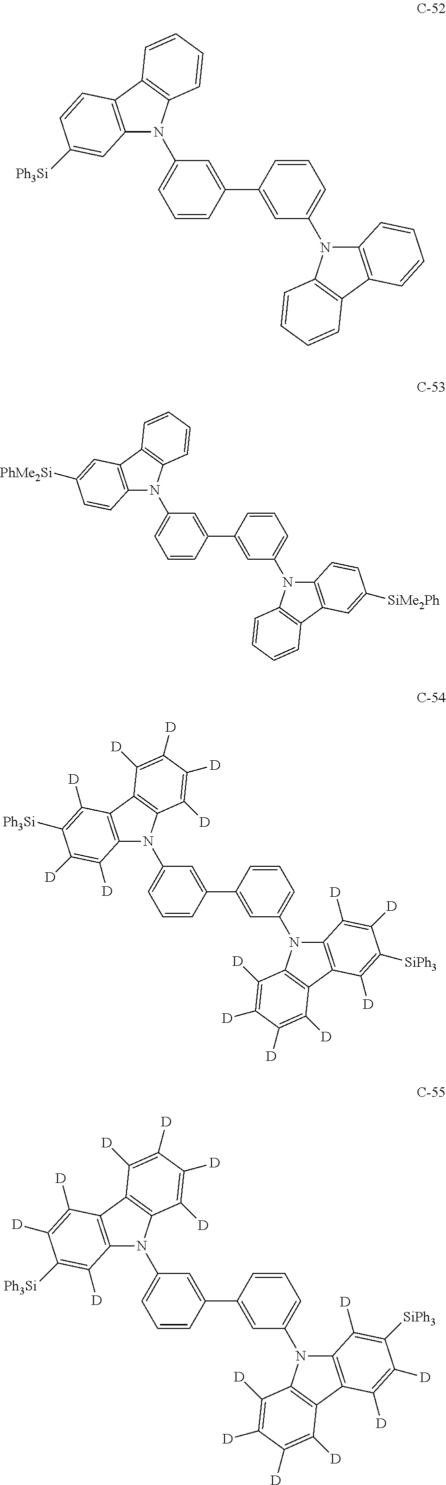

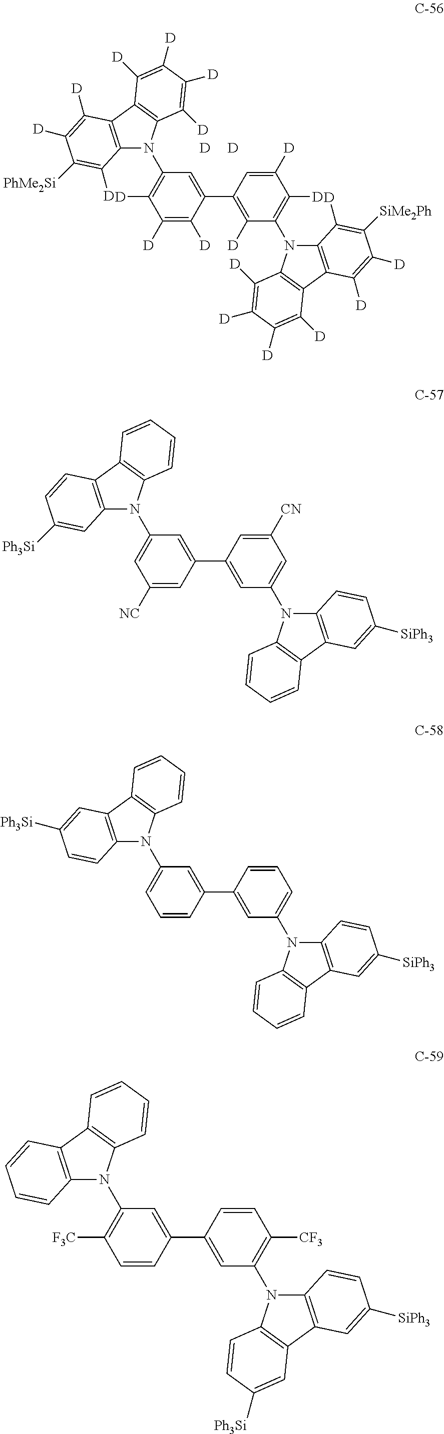

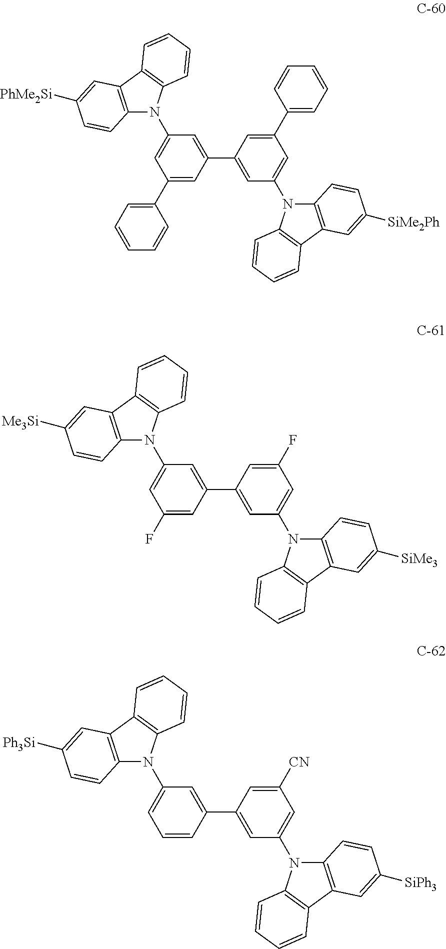

The compounds represented by any of formulae (1) to (3) can be synthesized by combining various known synthesizing methods.

Most generally, concerning the carbazole compounds, synthesis by dehydrogenation aromatization after Aza-Cope rearrangement of the condensation product of aryl hydrazine and cyclohexane derivative (L. F. Tietze and Th. Eicher, translated by Takano and Ogasawara, Precision Organic Syntheses, p. 339, published by Nanko-Do) is exemplified. Further, concerning the coupling reaction of the obtained carbazole compound and aryl halide compound using a palladium catalyst, the methods described in Tetrahedron Letters, Vol. 39, p. 617 (1998), ibid., Vol. 39, p. 2367 (1998), and ibid., Vol. 40, p. 6393 (1999) are exemplified. The reaction temperature and reaction time are not especially restricted and the conditions described in the above documents can be applied thereto.

As the synthesis example of the compound represented by formula (1), the synthesis example of exemplified compound C-2 is shown below. Exemplified compound C-2 can be synthesized according to the following reaction scheme.

### (Synthesis of Exemplified Compound C-2)

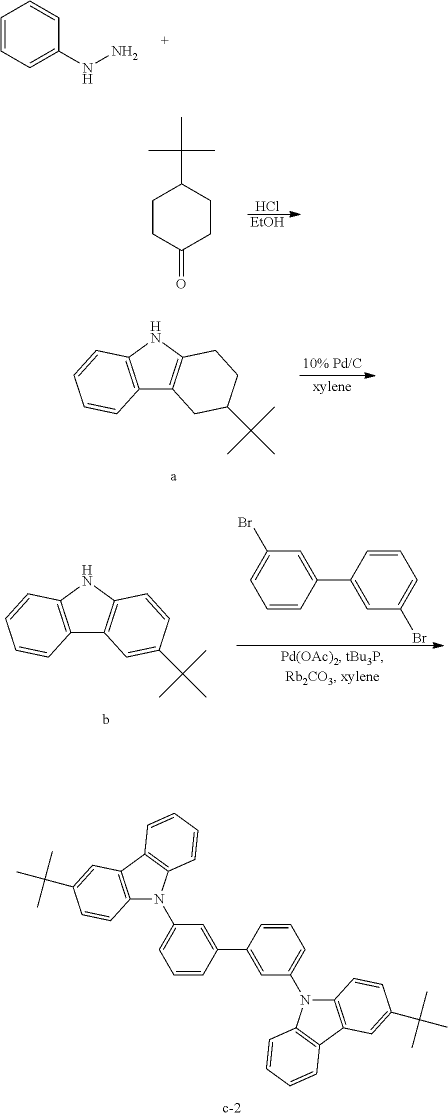

1-Equivalent of 4-tert-butylcyclohexanone is added to an ethanol-hydrochloric acid solution of phenylhydrazine, and the solution is stirred for 4 hours under refluxing with heating to obtain compound “a” in a yield of 90%. Compound “a” is reduced by palladium/carbon (10%) in a xylene solvent to synthesize compound “b” in a yield of 61%. Under nitrogen atmosphere, in a xylene solvent, adding 0.45-equivalents of 3,3′-dibromobiphenyl, 0.05-equivalents of palladium acetate, and 5-equivalents of rubidium carbonate to compound “b”, and then 0.15-equivalents of tri-tert-butylphosphine is added thereto, and the reaction solution is subjected to reaction for 8 hours by refluxing at the boiling temperature to thereby obtain exemplified compound C-2 in a yield of 84%.

In the invention, the compound represented by formula (1) is contained in a light-emitting layer in view of the improvement of durability (in particular, durability at the time of high luminance drive) but the use is not restricted thereto, and the compound may be contained in any layer in addition to the light-emitting layer in the organic layer. Besides the light-emitting layer, the compound represented by formula (1) may be contained in any of a hole-injecting layer, a hole-transporting layer, an electron transporting layer, an electron-injecting layer, an exciton-blocking layer, and a charge-blocking layer, or the compound may be contained in two or more of these layers.

The compound represented by formula (1) may be contained in both layers of the light-emitting layer and the contiguous layer thereto.

(Compound represented by formula D-1)

The compound represented by formula (D-1) will be described below.

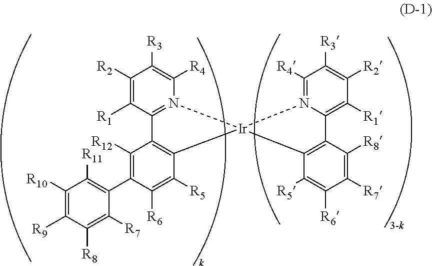

in formula (D-1), each of R₁ to R₁₂ independently represents a hydrogen atom or a substituent. Each of R₁′ to R₈′ independently represents a hydrogen atom or a substituent. At least one of R₁ to R₁₂ and R₁′ to R₈′ represents an alkyl group or an aryl group. k is an integer of 0 to 3, and when k is 0, the sum total of the carbon atoms of R₁′ to R₈′ is 2 or more.

Each of R₁ to R₁₂ independently represents a hydrogen atom or a substituent, and the groups exemplified above as substituent group A can be used as the substituent.

Each of R₁ to R₁₂ may further have a substituent, and the foregoing substituent group A can be applied to the substituent. Further, two or more of the substituents may be bonded to each other to form a ring.

Each of R₁ to R₁₂ preferably represents a hydrogen atom, an alkyl group, an alicyclic hydrocarbon group, an aryl group, a fluorine group, an amino group, an alkoxy group, an aryloxy group, a heterocyclic oxy group, an alkylthio group, an arylthio group, a heterocyclic thio group, a cyano group, a heterocyclic group, a silyl group, or a silyloxy group, more preferably a hydrogen atom, an alkyl group, an alicyclic hydrocarbon group, an aryl group, a fluorine group, a cyano group, a silyl group, or a heterocyclic group, still more preferably a hydrogen atom, an alkyl group, an alicyclic hydrocarbon group, an aryl group, a fluorine group or a cyano group, and especially preferably a hydrogen atom or an alkyl group.

Each of R₁′ to R₈′ represents a hydrogen atom or a substituent, and the foregoing substituent group A can be applied to the substituent.

Each of R₁′ to R₈′ may further have a substituent, and the foregoing substituent group A can be applied to the substituent. Two or more of the substituents may be bonded to each other to form a ring.

Each of R₁′ to R₈′ preferably represents a hydrogen atom, an alkyl group, an alicyclic hydrocarbon group, an aryl group, a fluorine group, a trifluoromethyl group, an amino group, an alkoxy group, an aryloxy group, a heterocyclic oxy group, an alkylthio group, an arylthio group, a heterocyclic thio group, a cyano group, a heterocyclic group, a silyl group, or a silyloxy group, more preferably a hydrogen atom, an alkyl group, an alicyclic hydrocarbon group, an aryl group, a fluorine group, a trifluoromethyl group, a cyano group, a silyl group, or a heterocyclic group, still more preferably a hydrogen atom, an alkyl group, an alicyclic hydrocarbon group, an aryl group, a fluorine group, a trifluoromethyl group and a cyano group, and especially preferably a hydrogen atom, an alkyl group, a fluorine group, a trifluoromethyl group, or a cyano group.

The alkyl group or aryl group for substituting at least one of R₁ to R₁₂ and R₁′ to R₈′ is preferably a methyl group, an isobutyl group, a neopentyl group, a phenyl group, or a tolyl group, more preferably a methyl group, an isobutyl group, or a neopentyl group, and still more preferably a methyl group or an isobutyl group.

When k is 0, it is preferred that at least two of R₁′ to R₈′ represent an alkyl group or an aryl group. Preferred of these groups are a methyl group, an isobutyl group, a neopentyl group, a phenyl group, and a tolyl group, more preferred are a methyl group, an isobutyl group, and a neopentyl group, and still more preferred are a methyl group and an isobutyl group.

k is preferably 1.

One of the preferred embodiments of the compound represented by formula (D-1) is a compound represented by the following formula (D-2).

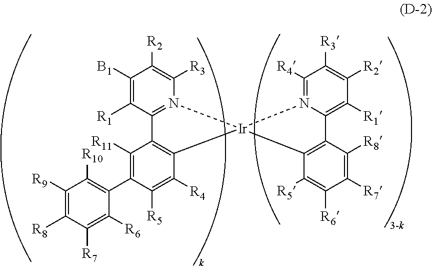

In formula (D-2), each of R₁ to R₁₁ independently represents a hydrogen atom or a substituent. Each of R₁′ to R₈′ independently represents a hydrogen atom or a substituent. B₁ represents a methyl group, an isobutyl group or a neopentyl group. k represents an integer of 1 to 3.

In formula (D-2), R₁ to R₁₁ and R₁′ to R₃′ respectively have the same meaning as R₁ to R₁₂ and R₁′ to R₈′ in formula (D-1) and preferred ranges are also the same.

B₁ represents a methyl group, an isobutyl group or a neopentyl group, and preferably a methyl group or an isobutyl group.

k represents an integer of 1 to 3, and preferably 1.

One of the preferred embodiments of the compound represented by formula (D-1) is a compound represented by the following formula (D-3).

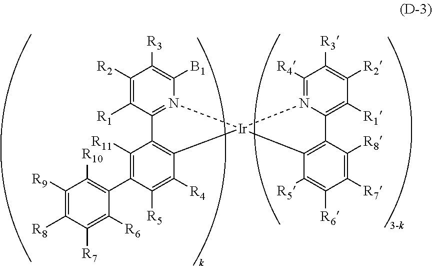

In formula (D-3), each of R₁ to R₁₁ independently represents a hydrogen atom or a substituent. Each of R₁′ to R₈′ independently represents a hydrogen atom or a substituent. B₁ represents a methyl group, an isobutyl group, or a neopentyl group. k represents an integer of 1 to 3.

In formula (D-3), R₁ to R₁₁ and R₁′ to R₈′ respectively have the same meaning as R₁ to R₁₂ and R₁′ to R₈′ in formula (D-1) and preferred ranges are also the same.

B₁ represents a methyl group, an isobutyl group, or a neopentyl group, and preferably a methyl group or an isobutyl group.

k represents an integer of 1 to 3, and preferably 1.

One of the preferred embodiments of the compound represented by formula (D-1) is a compound represented by the following formula (D-4).

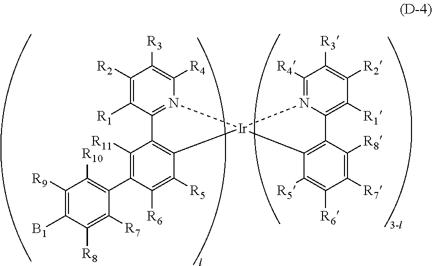

In formula (D-4), each of R₁ to R₁₁ independently represents a hydrogen atom or a substituent. Each of R₁′ to R₈′ independently represents a hydrogen atom or a substituent. B₁ represents a methyl group, an isobutyl group, or a neopentyl group. k represents an integer of 1 to 3.

In formula (D-4), R₁ to R₁₁ and R₁′ to R₈′ respectively have the same meaning as R₁ to R₁₂ and R₁′ to R₈′ in formula (D-1) and preferred ranges are also the same.

B₁ represents a methyl group, an isobutyl group, or a neopentyl group, and preferably a methyl group or an isobutyl group.

k represents an integer of 1 to 3, and preferably 1.

One of the preferred embodiments of the compound represented by formula (D-1) is a compound represented by the following formula (D-5).

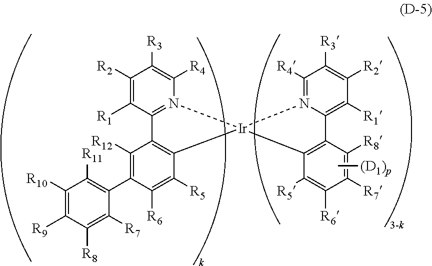

In formula (D-5), each of R₁ to R₁₂ independently represents a hydrogen atom or a substituent. Each of R₁′ to R₈′ independently represents a hydrogen atom or a substituent. At least one of R₁ to R₁₂ and R₁′ to R₈′ represents a methyl group, an isobutyl group or a neopentyl group. D₁ is an electron-withdrawing group selected from a fluorine atom, a trifluoromethyl group and a cyano group. D₁ is substituted with any of R₅′ to R₈′. Each D₁ may be the same with or different from every other D₁. k represents an integer of 1 to 3. p represents an integer of 1 to 4.

In formula (D-5), R₁ to R₁₂ and R₁′ to R₈′ respectively have the same meaning as R₁ to R₁₂ and R₁′ to R₈′ in formula (D-1) and preferred ranges are also the same.

At least one of R₁ to R₁₂ and R₁′ to R₈′ is preferably a methyl group, an isobutyl group, or a neopentyl group, and more preferably a methyl group or an isobutyl group.

D₁ is an electron-withdrawing group represented by a fluorine atom, a trifluoromethyl group or a cyano group, preferably a fluorine atom or a cyano group, and more preferably a cyano group. D₁ is substituted for any of R₅′ to R₈′, and each of each D₁ may be the same with or different from every other D₁.

p represents an integer of 1 to 4, and preferably 1 to 3. When a trifluoromethyl group or a cyano group is substituted with any of R₅′ to R₈′ as D₁, the number of the trifluoromethyl group and the cyano group is preferably one.

k represents an integer of 1 to 3; and preferably 2.

One of the preferred embodiments of the compound represented by formula (D-1) is a compound represented by the following formula (D-6).

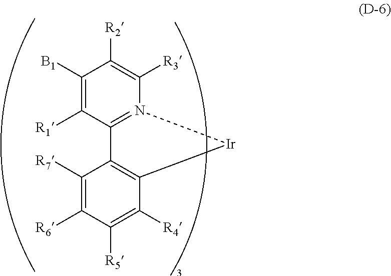

In formula (D-6), each of R₁′ to R₇′ independently represents a hydrogen atom or a substituent. At least one of R₁′ to R₇′ represents an alkyl group. B₁ represents a methyl group, an isobutyl group or a neopentyl group.

In formula (D-6), R₁′ to R₇′ respectively have the same meaning as R₁′ to R₈′ in formula (D-1) and preferred ranges are also the same.

B₁ represents a methyl group, an isobutyl group or a neopentyl group, preferably a methyl group or an isobutyl group, and more preferably a methyl group.

The alkyl group for substituting at least one of R₁′ to R₇′ is preferably a methyl group, an isobutyl group, or a neopentyl group, and more preferably a methyl group or an isobutyl group.

When B₁ represents a methyl group, it is preferred that R₃′ also represents a methyl group.

One of the preferred embodiments of the compound represented by formula (D-1) is a compound represented by the following formula (D-7).

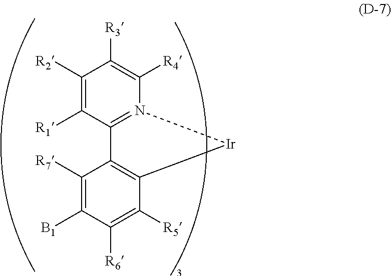

In formula (D-7), each of R₁′ to R₇′ independently represents a hydrogen atom or a substituent. At least one of R₁′ to R₇′ represents an alkyl group. B₁ represents a methyl group, an isobutyl group or a neopentyl group.

In formula (D-7), each of R₁′ to R₇′ respectively have the same meaning as R₁′ to R₈′ in formula (D-1) and preferred ranges are also the same.

B₁ represents a methyl group, an isobutyl group or a neopentyl group, preferably a methyl group or an isobutyl group, and more preferably a methyl group.

The alkyl group for substituting at least one of R₁′ to R₇′ is preferably a methyl group, an isobutyl group, or a neopentyl group, and more preferably a methyl group or an isobutyl group.

When B₁ represents a methyl group, it is preferred that R₅′ also represents a methyl group.

The preferred specific examples of the compounds represented by any of formulae (D-1) to (D-7) are shown below, but the invention is not restricted thereto.

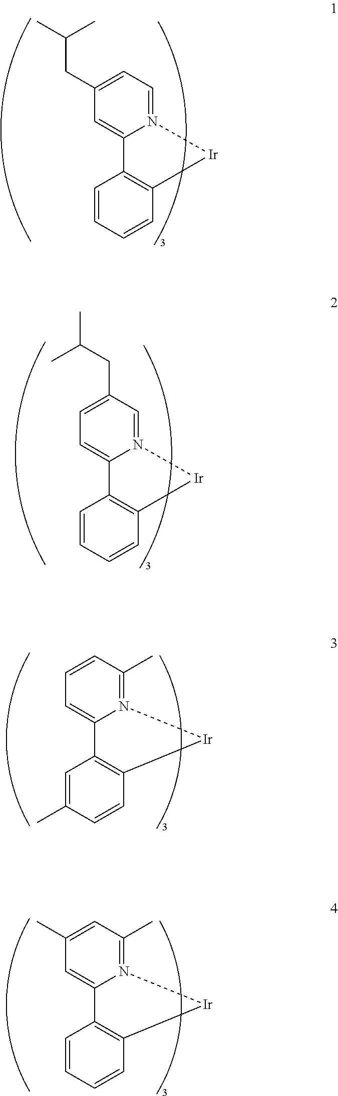

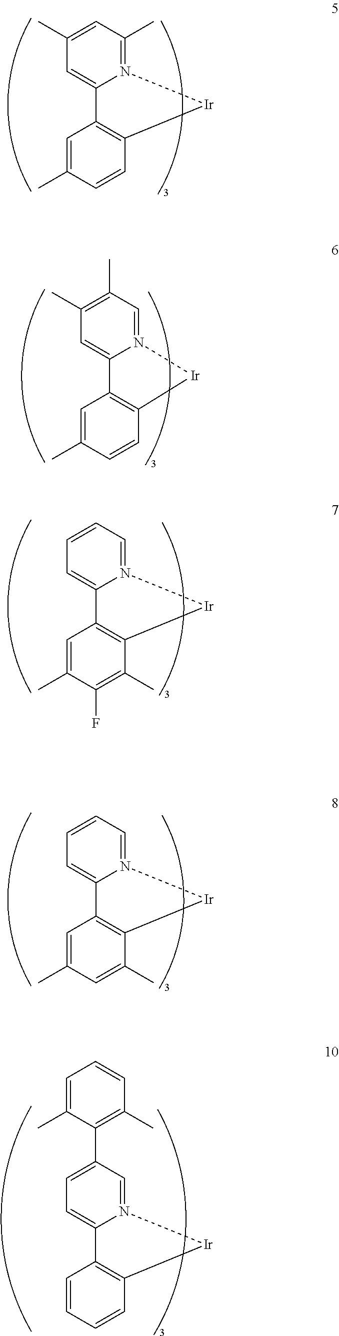

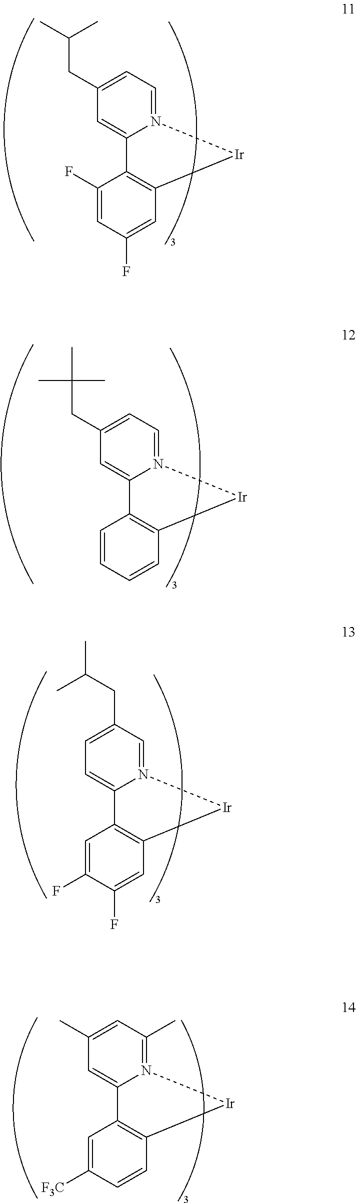

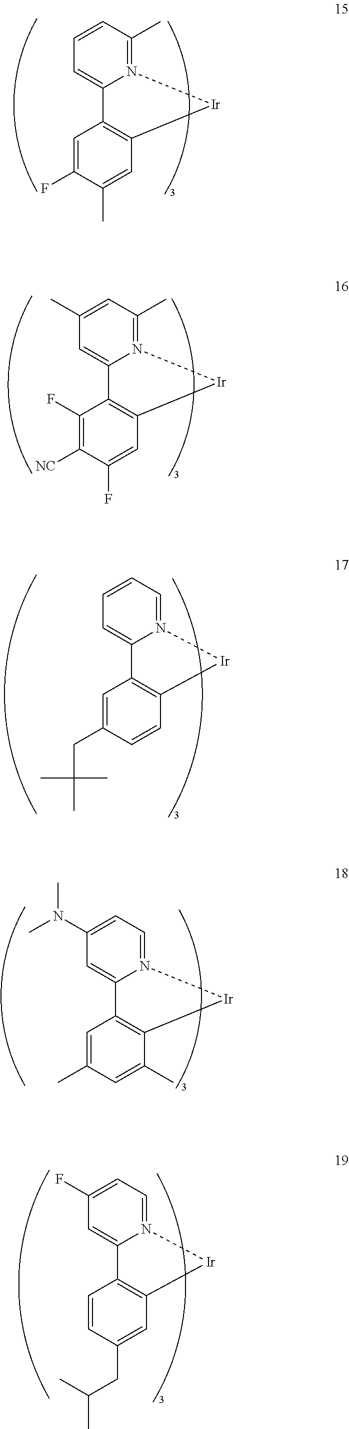

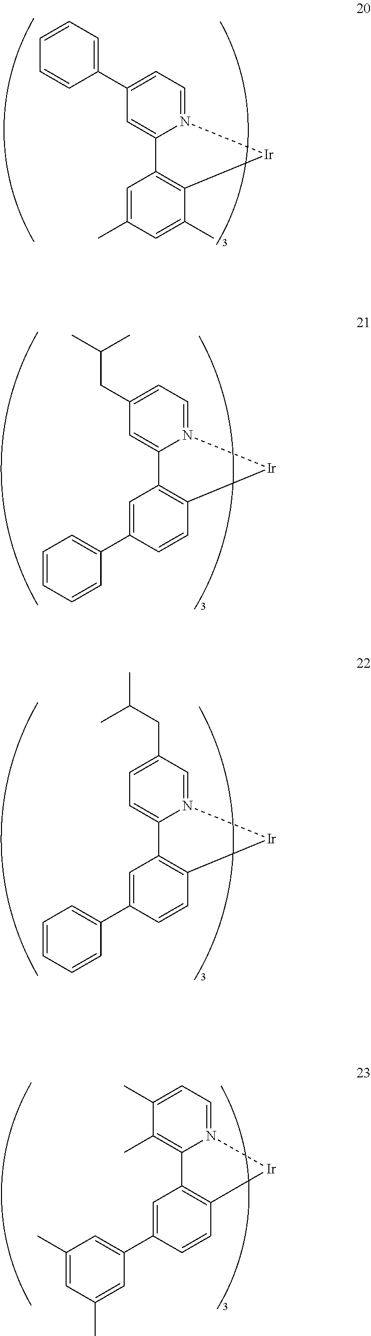

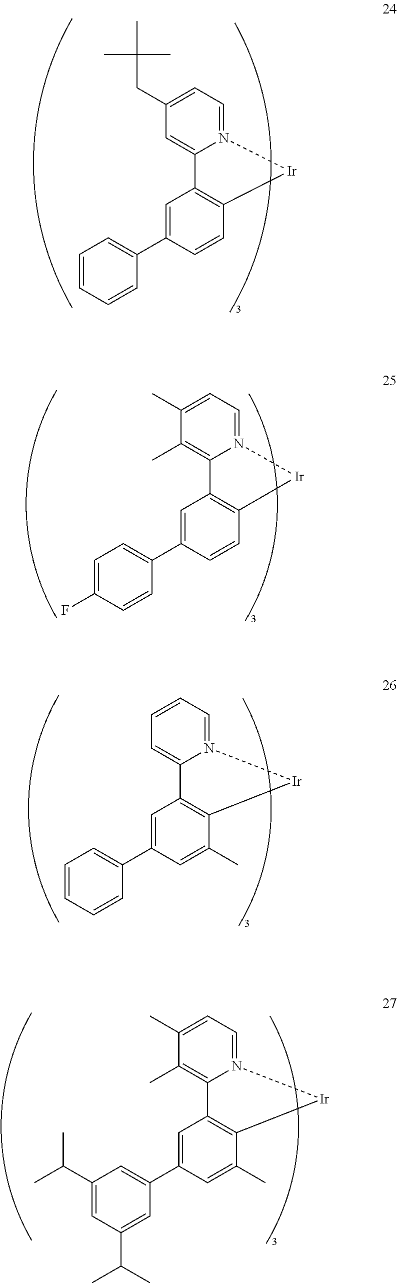

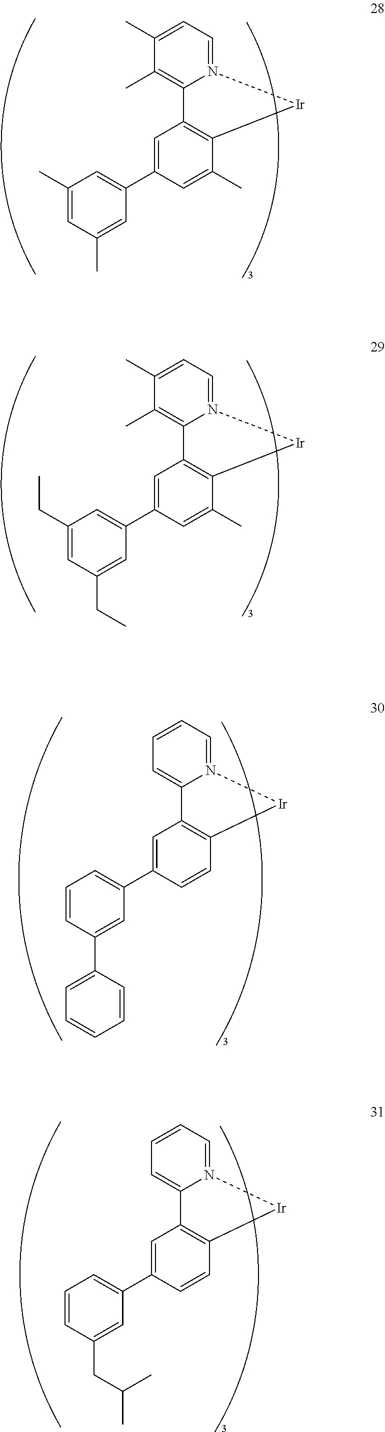

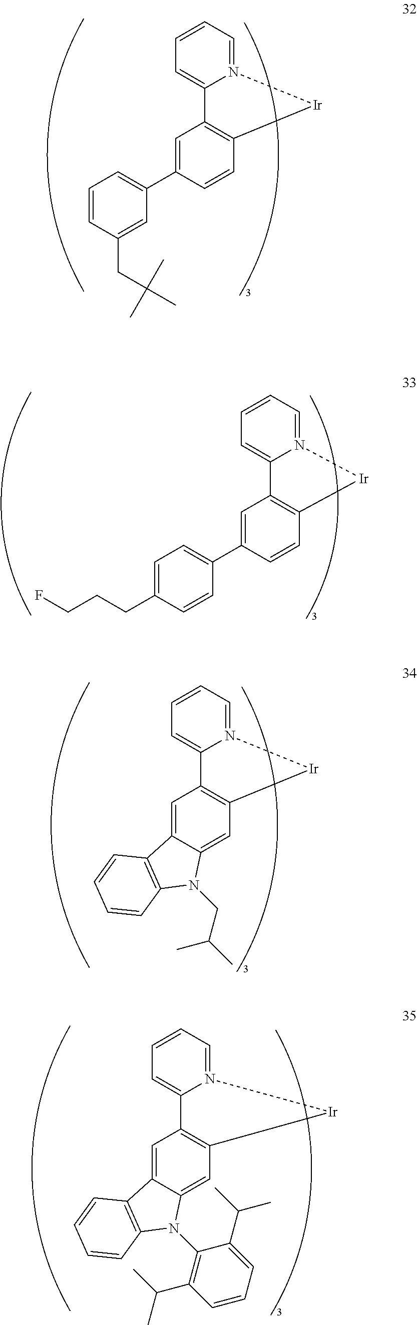

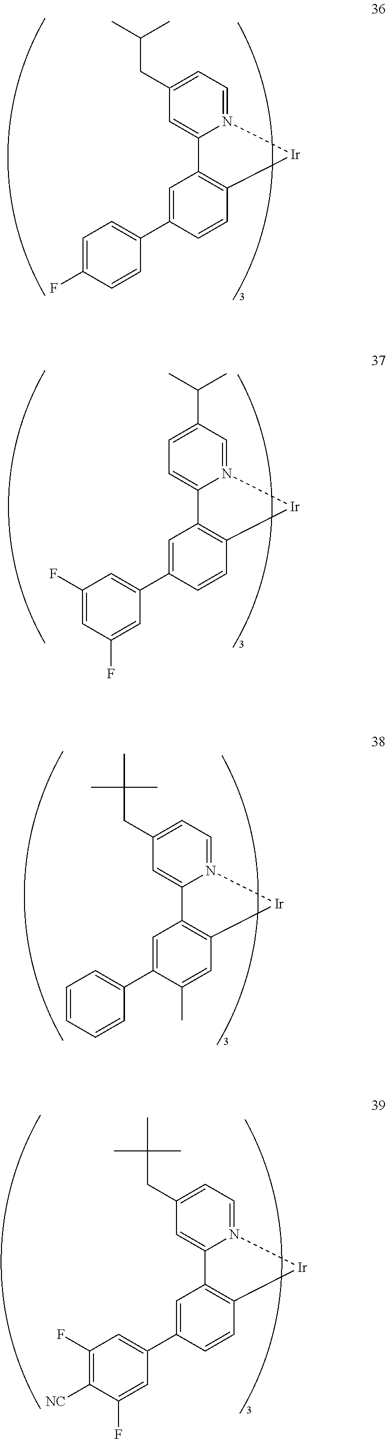

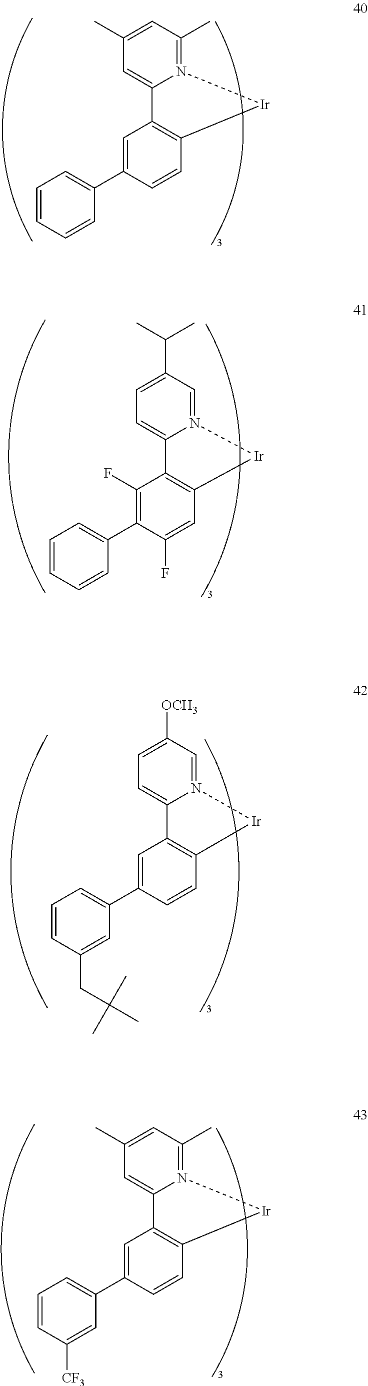

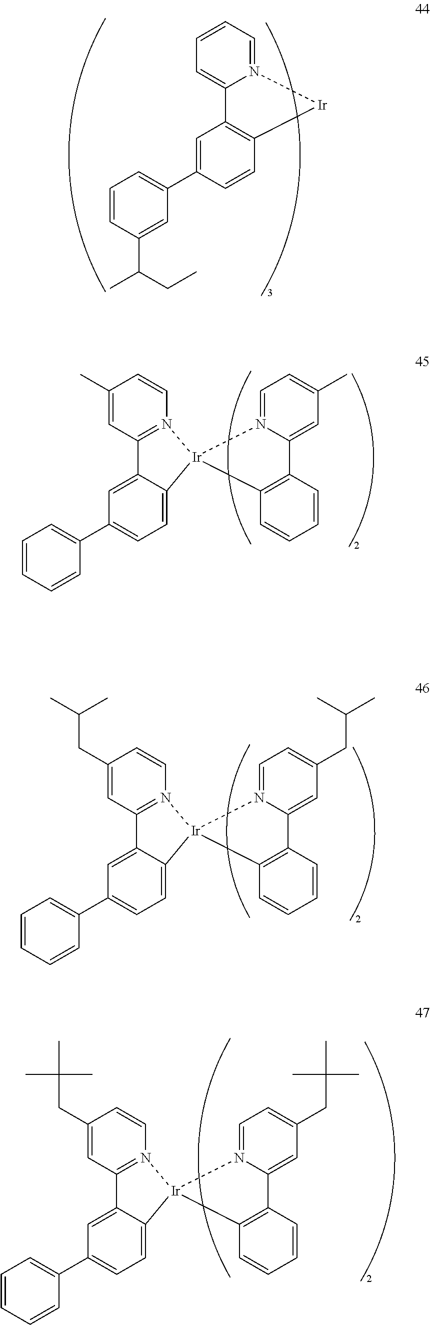

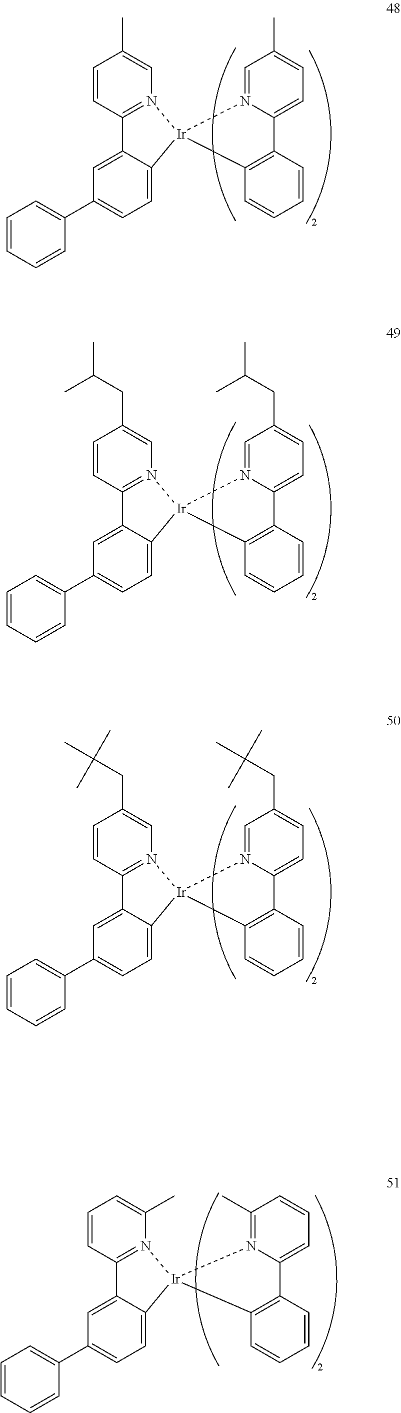

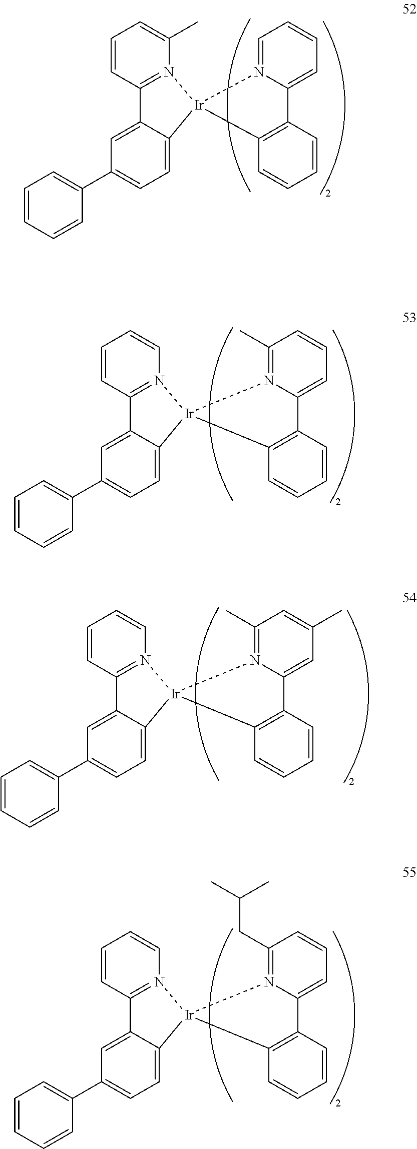

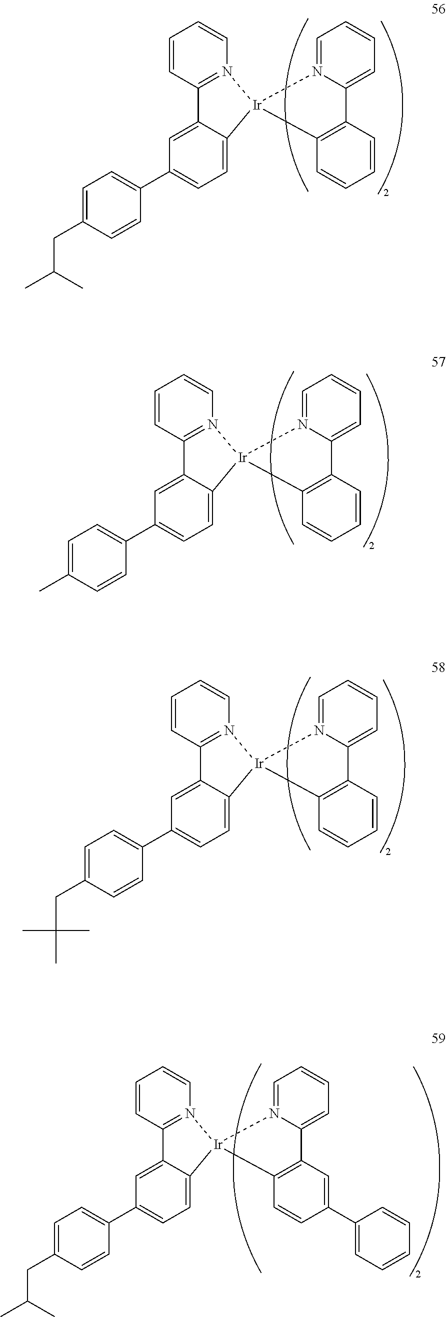

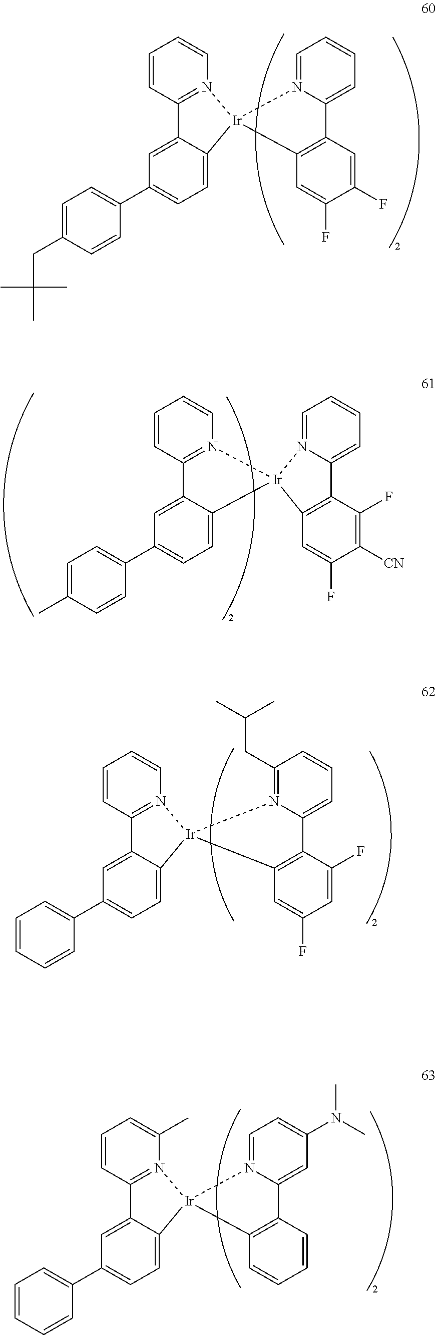

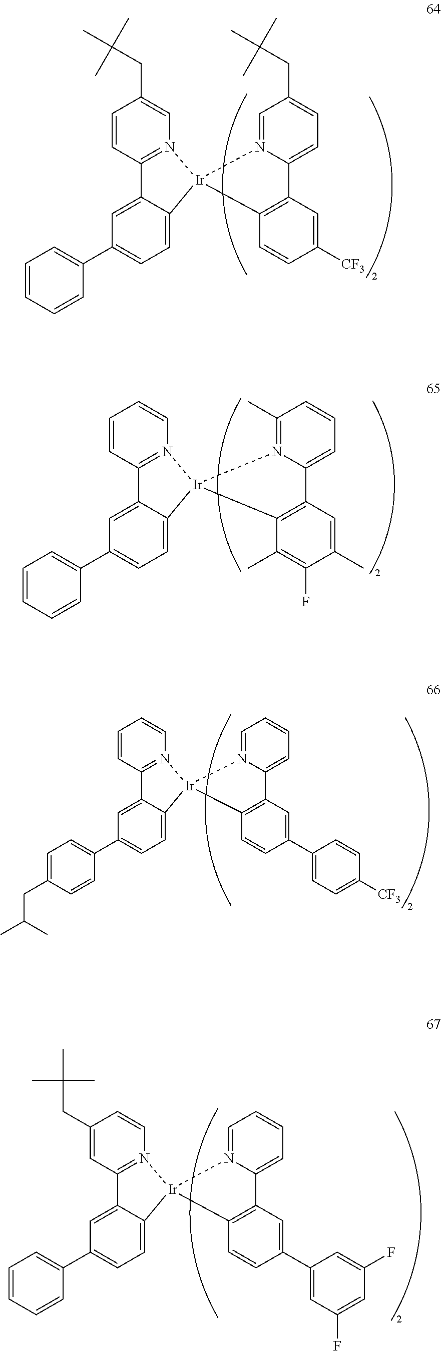

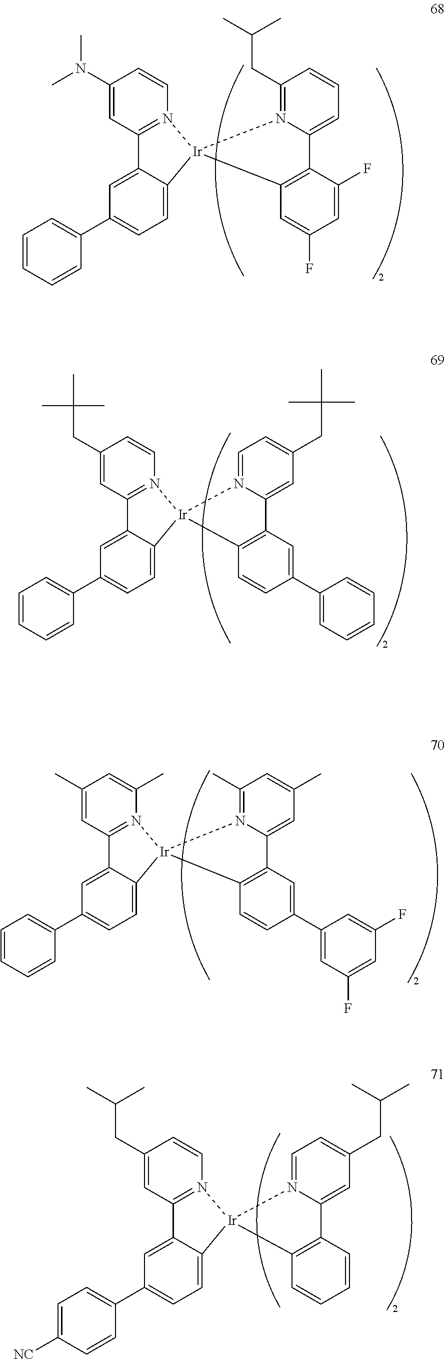

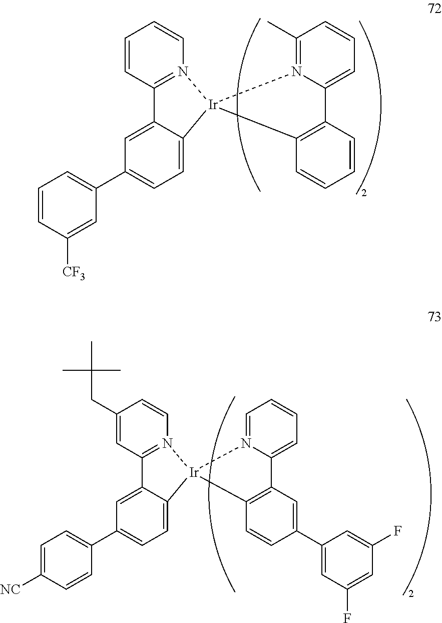

The compounds represented by any of formulae (D-1) to (D-7) can be synthesized by combining various known synthesis methods, for example, these compounds can be synthesized according to the method disclosed in WO 2009/073245 and WO 2009/073246.

The invention also relates to a composition containing at least each of the compound represented by formula (1) and the compound represented by formula (D-1).

By using the composition of the invention, an, organic electroluminescence device having high durability (in particular, at the time of high luminance drive) and little in aberration of chromaticity after deterioration of the device can be obtained.

Other components can also be added to the composition of the invention. For example, host materials other than the compound of formula (1), light-emitting materials other than the light-emitting material of formula (D-1), and materials containing hydrocarbon groups alone (preferably the hydrocarbon compound shown below) can be added to the composition of the invention.

It is preferred that any layer of the organic layers of the organic electroluminescence device in the invention further contains a hydrocarbon compound, and it is more preferred for the light-emitting layer to contain the hydrocarbon compound.

Further, the hydrocarbon compound is preferably a compound represented by the following formula (VI).

By appropriately using the compound represented by formula (VI) together with a light-emitting material, the interaction between the molecules of materials can be suitably controlled and the energy gap interaction between contiguous molecules can be made uniform, so that it becomes possible to further lower the driving voltage.

Further, the compound represented by formula (VI) for use in an organic electroluminescence device is excellent in chemical stability and accompanied by little alteration of the material during driving of the device, so that efficiency reduction of the organic electroluminescence device and lowering of duration of life of the device by decomposed product of the material can be prevented.

The compound represented by formula (VI) will be described below.

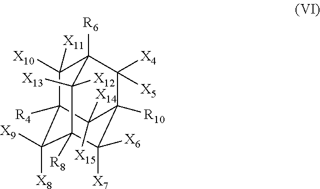

In formula (VI), each of R₄, R₆, R₈, R₁₀ and X₄ to X₁₅ independently represents a hydrogen atom, an alkyl group or an aryl group.

The alkyl group represented by each of R₄, R₆, R₈, R₁₀ and X₄ to X₁₅ in the formula (VI) may have as a substituent an adamantane structure or an aryl structure, and the number of carbon atoms in the alkyl group is preferably from 1 to 70, far preferably from 1 to 50, further preferably from 1 to 30, still further preferably from 1 to 10, especially preferably from 1 to 6. And the most preferable alkyl groups are linear alkyl groups having 2 to 6 carbon atoms.

Examples of the alkyl group represented by each of R₄, R₆, R₈, R₁₀ and X₄ to X₁₅ in the formula (VI) include an n-C₅₀H₁₀₁ group, an n-C₃₀H₆₁ group, 3-(3,5,7-triphenyladamantane-1-yl)propyl group (number of carbon atoms: 31), a trityl group (number of carbon atoms: 19), 3-(adamantane-1-yl)propyl group (number of carbon atoms: 13), 9-decalyl group (number of carbon atoms: 10), a benzyl group (number of carbon atoms: 7), a cyclohexyl group (number of carbon atoms: 6), a n-hexyl group (number of carbon atoms: 6), an n-pentyl group (number of carbon atoms: 5), an n-butyl group (number of carbon atoms: 4), an n-propyl group (number of carbon atoms: 3), a cyclopropyl group (number of carbon atoms: 3), an ethyl group (number of carbon atoms: 2) and a methyl group (number of carbon atoms: 1).

The aryl group represented by each of R₄, R₆, R₈, R₁₀ and X₄ to X₁₅ in the formula (VI) may have as a substituent an adamantane structure or an alkyl structure, and the number of carbon atoms the aryl group has is preferably from 6 to 30, far preferably from 6 to 20, further preferably from 6 to 15, especially preferably from 6 to 10, the most preferably is 6.

Examples of the aryl group represented by each of R₄, R₆, R₈, R₁₀ and X₄ to X₁₅ in the formula (VI) include a 1-pyrenyl group (number of carbon atoms: 16), a 9-anthracenyl group (number of carbon atoms: 14), a 1-naphthyl group (number of carbon atoms: 10), a 2-natphthyl group (number of carbon atom: 10), a p-t-butylphenyl group (number of carbon atoms: 10), a 2-m-xylyl group (number of carbon atoms: 8), a 5-m-xylyl group (number of carbon atoms: 8), an o-tolyl group (number of carbon atoms: 7), a m-tolyl group (number of carbon atoms: 7), a p-tolyl group (number of carbon atoms: 7) and a phenyl group (number of carbon atoms: 6).

Although each of R₄, R₆, R₈ and R₁₀ in the formula (VI) may be either a hydrogen atom, or an alkyl group, or an aryl group, from the viewpoint that high glass transition temperatures are preferable, it is preferable that at least one of them is an aryl group, it is far preferable that at least two of them are aryl groups, and it is particularly preferable that 3 or 4 of them are aryl groups.

Although each of X₄ to X₁₅ in the formula (VI) may represent either a hydrogen atom, or an alkyl group, or an aryl group, it is preferable that each stands for a hydrogen atom or an aryl group, especially a hydrogen atom.

The organic electroluminescence devices are made using a vacuum deposition process or a solution coating process, and therefore, in terms of vacuum deposition suitability and solubility, the molecular weight of the compounds represented by the formula (VI) in the invention is preferably 2,000 or below, far preferably 1,200 or below, especially 1,000 or below. Also, from the viewpoint of vacuum deposition suitability, the molecular weight is preferably 250 or above, far preferably 350 or above, particularly preferably 400 or above. This is because, when the compounds have too low molecular weight, their vapor pressure becomes low and change from a vapor phase to a solid phase does not occur, and it is therefore difficult for the compounds to form organic layers.

The compound represented by the formula (VI) is preferably in solid phase at room temperature (25° C.), far preferably solid phase in a range from room temperature to 40° C., especially preferably solid phase in a range from room temperature to 60° C.

In the case of using the compound which, though represented by the formula (VI), is not in solid phase at room temperature, it is possible to form a solid phase at ordinary temperatures by combining the compound with other substances.

Uses of the compound represented by the formula (VI) are not limited, and the compound may be incorporated into any of the organic layers. The layer into which the compound represented by the formula (VI) in the invention is introduced is preferably a layer selected from a light emitting layer, a hole injection layer, a hole transport layer, an electron transport layer, an electron injection layer, an exciton block layer and a charge block layer, or a combination of two or more of these layers, far preferably a layer selected from the light emitting layer, the hole injection layer, the hole transport layer, the electron transport layer and the electron injection layer, or a combination of two or more of these layers, especially preferably a layer selected from the light emitting layer, the hole injection layer and the hole transport layer, or a combination of at least two of these layers, the most preferably the light emitting layer.

When the compound represented by the formula (VI) is used in an organic layer, its content is required to be limited so as not to inhibit charge transportability, and therefore it is preferable from 0.1% to 70% by mass, far preferable from 0.1% to 30% by mass, especially preferable from 0.1% to 25% by mass.

When the compound represented by the formula (VI) is used in two or more organic layers, its content in each organic layer is preferably in the range specified above.

Only one kind of a compound represented by formula (VI) may be contained in any organic layer, or a plurality of kinds of compounds represented by formula (VI) may be contained in combination in an arbitrary ratio.

Specific examples of the hydrocarbon compound are illustrated below, but the present invention is not limited thereto.

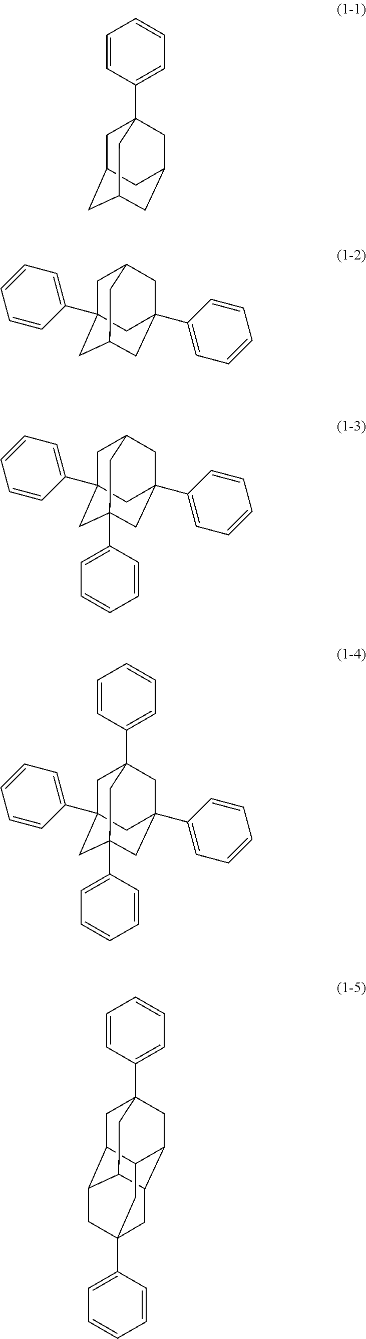

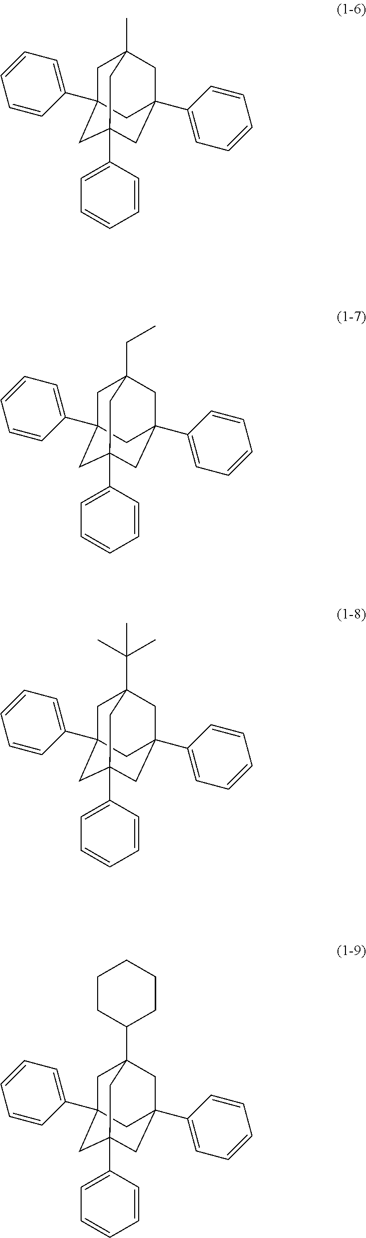

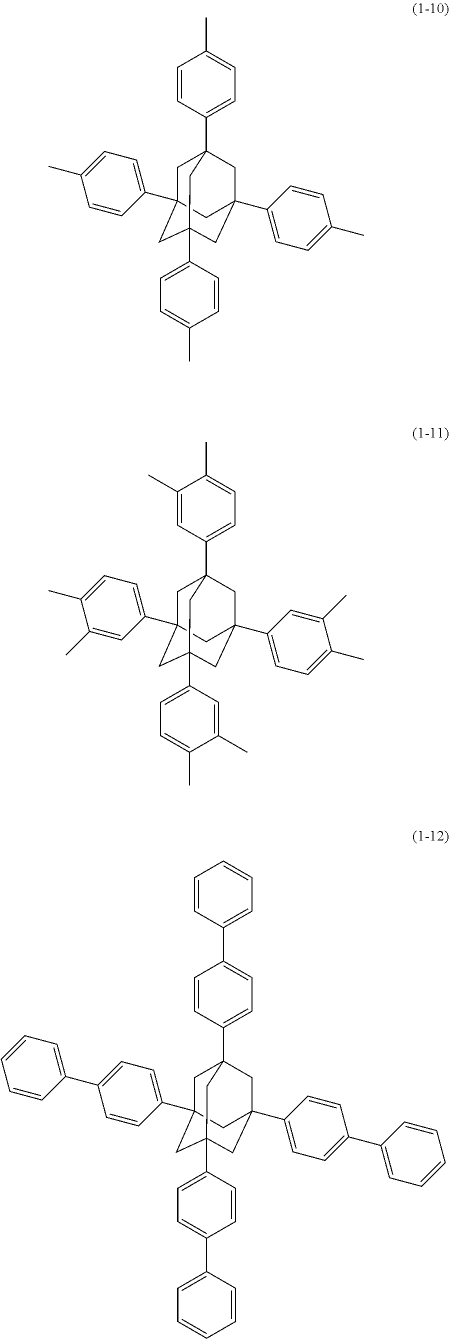

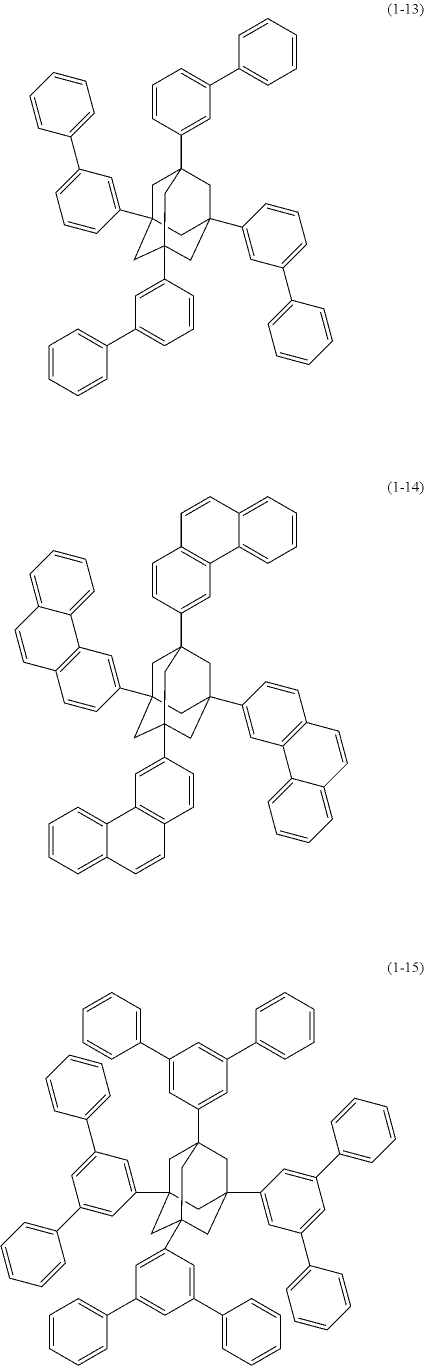

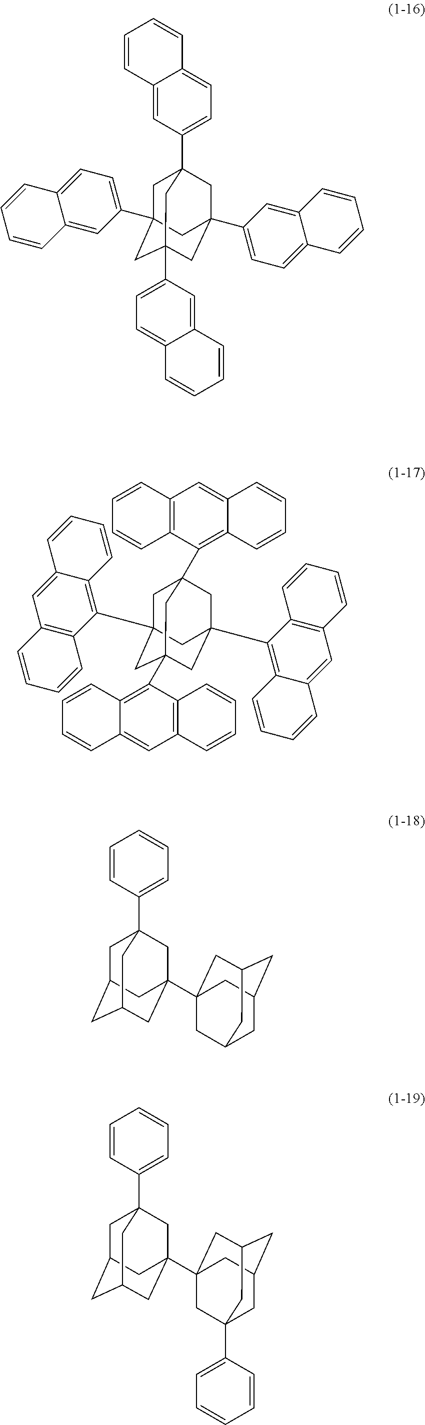

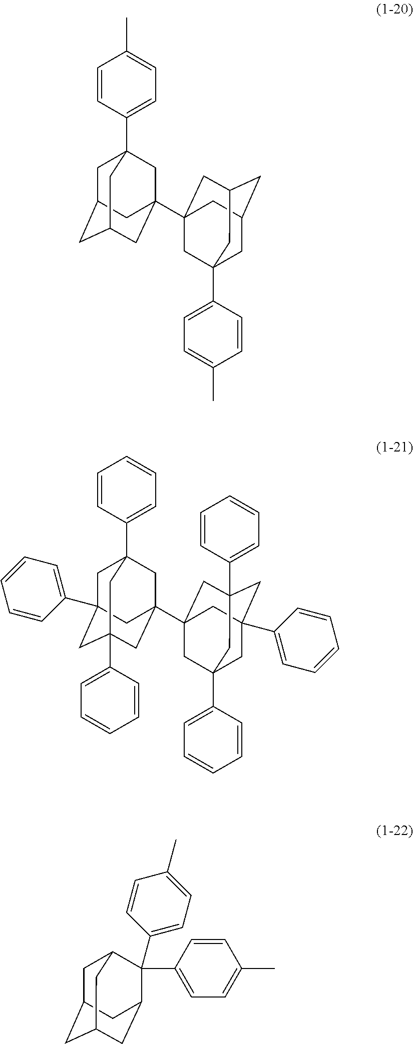

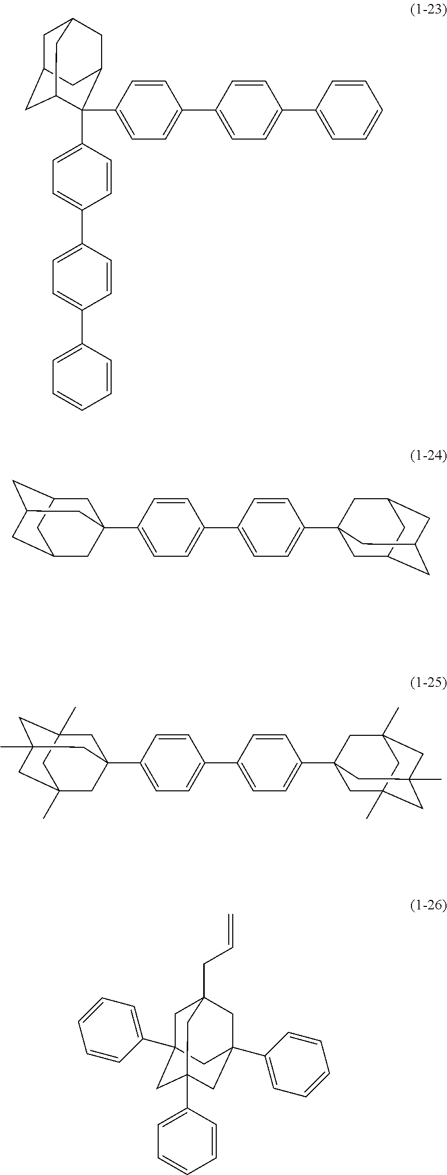

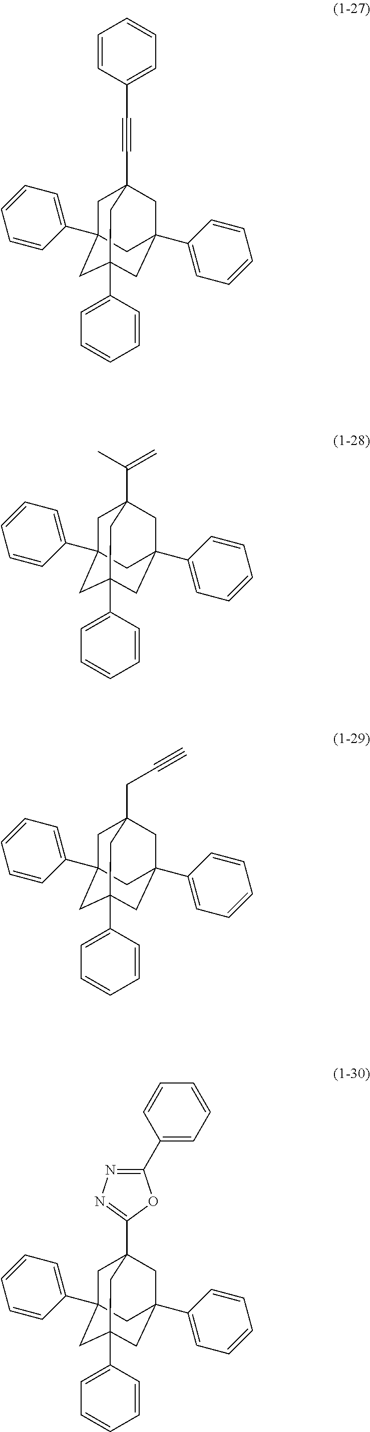

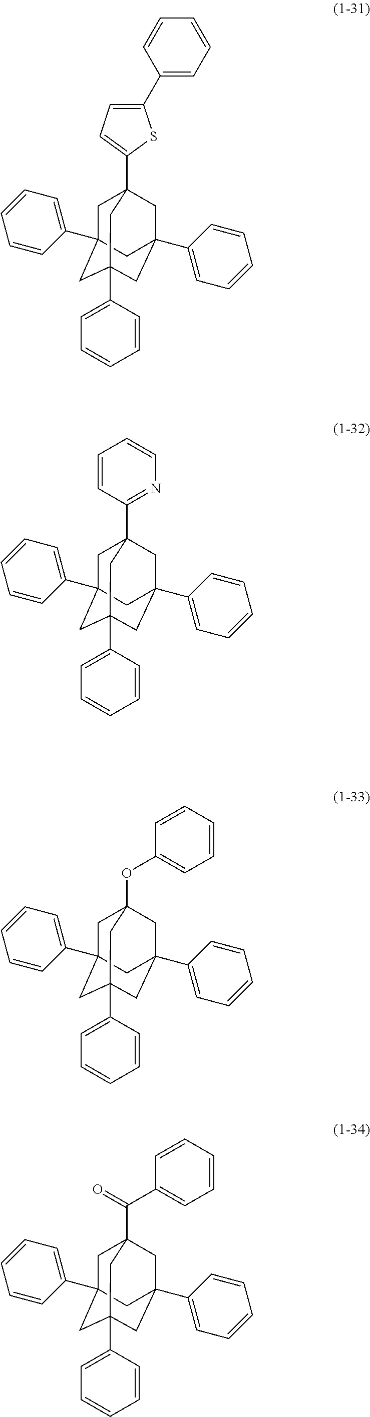

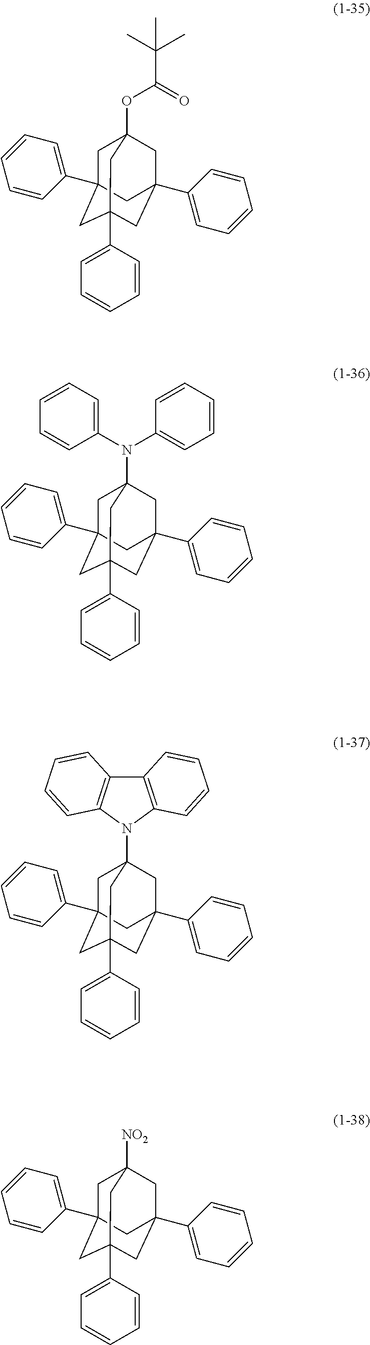

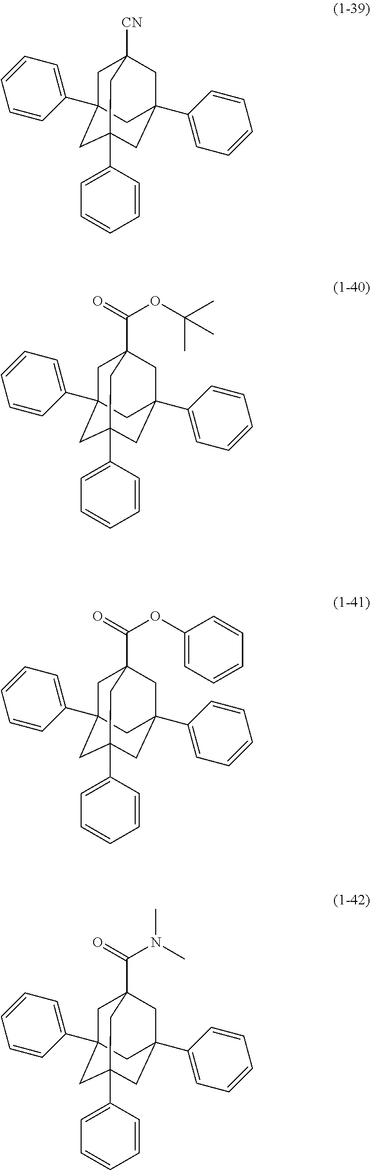

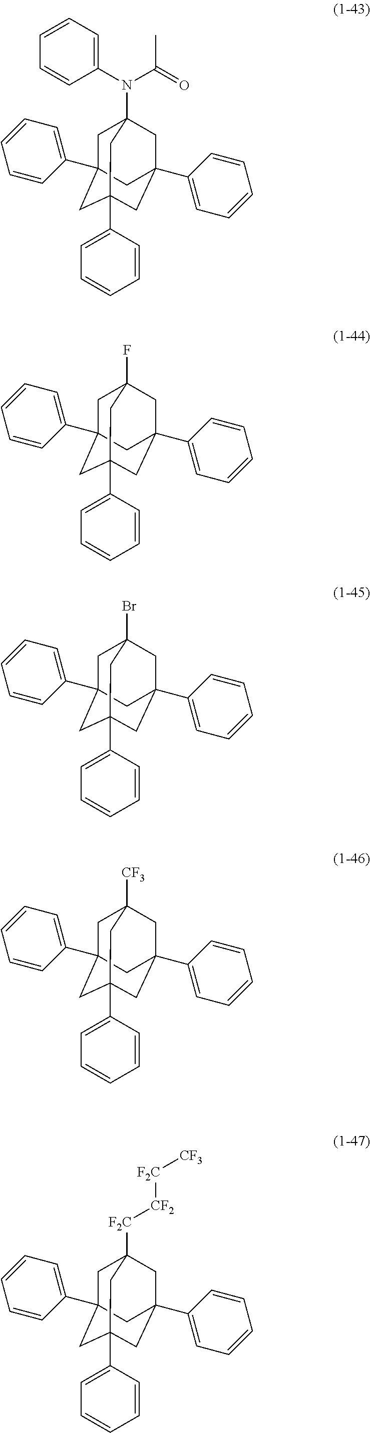

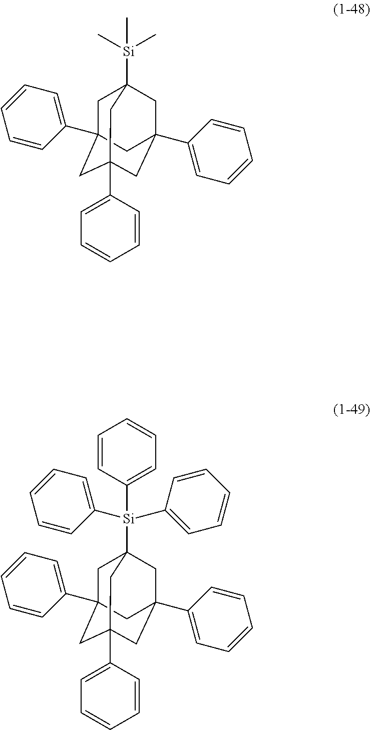

The compound represented by the formula (VI) can be synthesized by appropriately combining adamantane or haloadamantane with haloalkane or alkylmagnesium halide (Grignard reagent). For instance, it is possible to provide coupling between haloadamantane and haloalkane by use of indium (Reference 1). Alternatively, it is possible to convert haloalkane into an alkylcopper reagent and further to couple the reagent to Grignard reagent of an aromatic compound (Reference 2). Further, the coupling of haloalkane can also be performed using an appropriate arylboric acid and a palladium catalyst (Reference 3).
Reference 1: Tetrahedron Lett. 39, 9557-9558 (1998)
Reference 2: Tetrahedron Lett. 39, 2095-2096 (1998)
Reference 3: J. Am. Chem. Soc. 124, 13662-13663 (2002)

The adamantane structure having an aryl group can be synthesized by appropriately combining adamantane or halo adamantane with the corresponding arene or haloarene.

Additionally, even when defined substituents undergo changes under certain synthesis conditions in those production methods or they are unsuitable for carrying out those methods, the intended compounds can be produced with ease by adopting e.g. methods for protecting and deprotecting functional groups (T. W. Greene, Protective Groups in Organic Synthesis, John Wiley & Sons Inc. (1981)). Further, it is also possible to change the order of reaction steps, including a substituent introduction step, as appropriate, if needed.

In the composition of the invention, the content of the compound represented by formula (1) is preferably in the range of 15% by mass or more and 95% by mass or less based on all the solids content in the composition, and more preferably in the range of 40% by mass or more and 95% by mass. The content of the compound represented by formula (D-1) is preferably in the range of 1% by mass or more and 30% by mass or less based on all the solids content in the composition, and more preferably in the range of 5% by mass or more and 20% by mass.

### (Organic Electroluminescence Device)

The organic electroluminescence device according to the invention includes a substrate having thereon a pair of electrodes and at least one organic layer including a light-emitting layer containing a light-emitting material between the pair of electrodes, wherein the light-emitting layer contains at least each of the compound represented by formula (1) and the compound represented by formula (D-1).

In the present organic electroluminescence devices, the light emitting layer is an organic layer, and two or more organic layers may further be included.

In terms of properties of the luminescence device, it is preferred that at least either of the two electrodes, an anode and a cathode, be transparent or translucent.

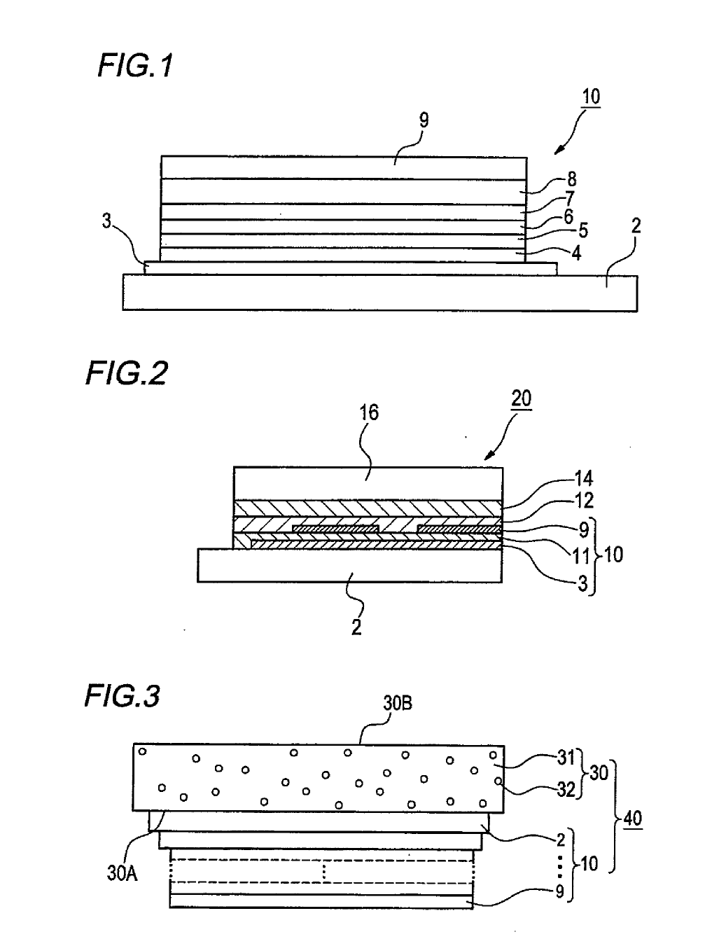

FIG. 1 shows one example of structures of the present organic electroluminescence devices. The present organic electroluminescence device 10 shown in FIG. 1 has, on a supporting substrate 2, a light emitting layer 6 sandwiched between an anode 3 and a cathode 9. More specifically, between an anode 3 and a cathode 9, a hole injection layer 4, a hole transport layer 5, a light emitting layer 6, a hole-blocking layer 7 and an electron transport layer 8 are stacked on in the order of mention.

### (Structure of Organic Layers)

The organic layer has no particular restriction on its layer structure, and the layer structure thereof can be selected appropriately according to purposes of using the organic electroluminescence device. However, it is preferred that the organic layer be formed on the transparent electrode or the back electrode. In such a case, the organic layer is formed on the front of or all over the transparent electrode or the back electrode.

The organic layer has no particular limitations e.g. on its shape, size and thickness, and these factors can be selected as appropriate according to purposes given to the organic layer.

The following are specific examples of a layer structure, but these layer structures should not be construed as limiting the scope of the invention.
Anode/hole transport layer/light emitting layer/electron transport layer/cathode
Anode/hole transport layer/light emitting layer/block layer/electron transport layer/cathode
Anode/hole transport layer/light emitting layer/block layer/electron transport layer/electron injection layer/cathode
Anode/hole injection layer/hole transport layer/light emitting layer/block layer/electron transport layer/cathode
Anode/hole injection layer/hole transport layer/light emitting layer/block layer/electron transport layer/electron injection layer/cathode

The structure, substrate, cathode and anode of an organic electroluminescence device are described e.g. in JP-A-2008-270736, and the items described in such a reference can also be applied to the invention.

### (Substrate)

The substrate used in the invention is preferably a substrate which causes neither scattering nor damping of light emitted from the organic layer. When the substrate is made from an organic material, it is preferable that the organic material has excellent heat resistance, dimensional stability, solvent resistance, electrical insulation and workability.

### (Anode)

In ordinary cases, it is essential only that the anode should function as an electrode for supplying holes into the organic layer, and there is no particular limitation e.g. on anode's shape, structure and size. And the electrode material can be selected from heretofore known ones as appropriate according to uses and purposes of the luminescence device. As mentioned above, the anode is usually provided in a state of being transparent.

### (Cathode)

In ordinary cases, it is essential only that the cathode should function as an electrode for supplying electrons into the organic layer, and there is no particular limitation e.g. on anode's shape, structure and size. And the electrode material can be selected from heretofore known ones as appropriate according to uses and purposes of the luminescence device.

Regarding the substrate, anode and cathode, descriptions in JP-A-2008-270736, paragraphs [0070] to [0089] can be applied to the invention.

### (Organic Layers)

The organic layers in the invention are described below.

### —Formation of Organic Layers—

In the organic electroluminescence device of the invention, each organic layer can be preferably formed by any of dry film-forming methods such as a vacuum deposition method, a sputtering method, etc., and wet film-forming methods (wet process) such as a transfer method, a printing method, a spin coating method, etc.

In the invention, it is preferred from the viewpoint of the manufacture cost reduction to form the light-emitting layer containing at least each of the compound represented by formula (1) and the compound represented by formula (D-1) by the wet process.

### (Light-emitting Layer)

The light-emitting layer in the invention contains at least each of the compound represented by formula (1) and the compound represented by formula (D-1).

### (Light-emitting Material)

The light-emitting material in the invention is preferably a compound represented by formula (D-1).

The light-emitting material in the light-emitting layer is preferably contained in the light-emitting layer in an amount of 0.1% by mass to 50% by mass based on the mass of all the compounds generally to form the light-emitting layer, more preferably 1% by mass to 50% by mass in view of durability and external quantum efficiency, and still more preferably 2% by mass to 40% by mass.

The compound represented by formula (D-1) in the light-emitting layer is preferably contained in the light-emitting layer in an amount of 1% by mass to 30% by mass in view of durability and external quantum efficiency, and more preferably 5% by mass to 20% by mass.

The thickness of the light-emitting layer is not especially restricted, but is generally preferably 2 nm to 500 mu, more preferably 3 nm to 200 nm in the point of external quantum efficiency, and still more preferably 5 nm to 100 nm.

The light-emitting layer in the device of the invention may be a mixed layer of a light-emitting material and a host material. The light-emitting material may be either a fluorescent material or a phosphorescent material, and the dopant may consist of one or two or more. The host material is preferably a charge-transporting material. The host material may consist of one or two or more kinds and, for example, a constitution of a mixture of an electron-transporting host material and a hole-transporting host material is exemplified. Further, a material not having a charge-transporting property and not emitting light may be contained in the light-emitting layer.

The light-emitting layer may be a single layer or a multilayer structure comprising two or more layers. Further, each light-emitting layer may emit light of a different luminescent color.

### (Host Material)

The host material used in the invention may contain the following compounds. Examples thereof include pyrrole, indole, carbazole (including CBP (4,4′-di(9-carbazolyl)biphenyl)), azaindole, azacarbazole, triazole, oxazole, oxadiazole, pyrazole, imidazole, thiophene, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, porphyrin compounds, polysilane compounds, poly(N-vinylcarbazole), aniline copolymers, thiophene oligomers, oligomers of conductive polymers like polythiophene, organic silanes, carbon film, pyridine, pyrimidine, triazine, anthraquinodimethane, anthrone, diphenylquinone, thiopyran dioxide, carbodiimide, fluorelenylidenemethane, distyrylpyrazine, fluoro-substituted aromatic compounds, tetracarboxylic acid anhydrides of condensed aromatic ring compounds such as naphthalene and perylene, phthalocyanine, various kinds of metal complexes, typified by metal complexes of 8-quinolinol derivatives and metal complexes whose ligands are metallo-phthalocyanines, benzoxazole or benzothiazole molecules, and derivatives of the above-recited metal complexes (e.g. those replaced with substituents or those condensed with other rings).

In the light-emitting layer of the invention, in the points of color purity, light emitting efficiency and driving durability, it is preferred that the minimum triplet excited state energy (T1 energy) of the host material is higher than T1 energy of the phosphorescent material.

The host material is preferably the compound represented by formula (1).

Further, the content of the host compound in the invention is not especially restricted but from the viewpoints of light emitting efficiency and driving voltage, the content is preferably 15% by mass or more and 95% by mass or less based on the mass of all the compounds constituting the light-emitting layer.

The content of the compound represented by formula (1) in the light-emitting layer is, from the viewpoints of light emitting efficiency and driving voltage, preferably 15% by mass or more and 95% by mass or less based the mass of all the compounds forming the light-emitting layer, and more preferably 40% by mass or more and 95% by mass or less.

### (Fluorescent Material)

Examples of a fluorescent material usable in the invention include benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, condensed aromatic compounds, perinone derivatives, oxadiazole derivatives, oxazine derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, diketopyrrolopyrrole derivatives, aromatic dimethylidyne derivatives, various kinds of complexes typified by complexes of 8-quinolinol derivatives and complexes of pyrromethene derivatives, polymeric compounds such as polythiophene, polyphenylene and polyphenylenevinylene, and compounds like organic silane derivatives.

### (Phosphorescent Material)

Examples of a phosphorescent material usable in the invention include the phosphorescent compounds as disclosed in U.S. Pat. No. 6,303,238B1, U.S. Pat. No. 6,097,147, WO 00/57676, WO 00/70655, WO 01/08230, WO 01/39234A2, WO 01/41512A1, WO 02/02714A2, WO 02/15645A1, WO 02/44189A1, WO 05/19373A2, JP-A-2001-247859, JP-A-2002-302671, JP-A-2002-117978, JP-A-2003-133074, JP-A-2002-235076, JP-A-2003-123982, JP-A-2002-170684, EP 1211257, JP-A-2002-226495, JP-A-2002-234894, JP-A-2001-247859, JP-A-2001-298470, JP-A-2002-173674, JP-A-2002-203678, JP-A-2002-203679, JP-A-2004-357791, JP-A-2006-256999, JP-A-2007-19462, JP-A-2007-84635 and JP-A-2007-96259. Examples of luminescent dopants which are far preferred among those compounds include the Ir complexes, the Pt complexes, the Cu complexes, the Re complexes, the W complexes, the Rh complexes, the Ru complexes, the Pd complexes, the Os complexes, the Eu complexes, the Tb complexes, the Gd complexes, the Dy complexes and the Ce complexes. Of these complexes, Ir complexes, the Pt complexes and the Re complexes are particularly preferable, notably Ir complexes, the Pt complexes and the Re complexes each having at least one kind of coordination bond selected from metal-carbon, metal-nitrogen, metal-oxygen and metal-sulfur coordinate bonds. In terms of luminous efficiency, durability under driving, chromaticity and so on, the Ir complexes, the Pt complexes and the Re complexes each having a polydentate ligand, including a tridentate ligand or higher, are preferred over the others.

The content of the phosphorescent material in the light-emitting layer is preferably in the range of 0.1% by mass or more and 50% by mass or less based on the total mass of the light-emitting layer, more preferably in the range of 0.2% by mass or more and 50% by mass or less, still more preferably in the range of 0.3% by mass or more and 40% by mass or less, and most preferably in the range of 20% by mass or more and 30% by mass or less.

The content of the phosphorescent material that can be used in the invention is preferably in the range of 0.1% by mass or more and 50% by mass or less based on the total mass of the light-emitting layer, more preferably in the range of 1% by mass or more and 40% by mass or less, and most preferably in the range of 5% by mass or more and 30% by mass or less. In particular, in the range of 5% by mass or more and 30% by mass or less, chromaticity of light emission of the organic electroluminescence device is little in dependency upon additive concentration of the phosphorescent material.

### —Hole Injection Layer and Hole Transport Layer—

The hole injection layer and the hole transport layer are layers having functions of receiving holes from an anode or an anode side and transporting the holes to a cathode side.

Concerning the invention, it is preferred to include a hole-injecting layer and a hole-transporting layer containing an electron-accepting dopant as organic layers.

### —Electron Injection Layer and Electron Transport Layer—

The electron injection layer and the electron transport layer are layers having functions of receiving electrons from a cathode or a cathode side and transporting the electrons to an anode side.

With respect to the hole injection layer, the hole transport layer, the electron injection layer and the electron transport layer, the matters described in JP-A-2008-270736, paragraph numbers [0165] to [0167], are applicable in the invention.

### —Hole-blocking Layer—

The hole-blocking layer is a layer having a function of blocking the holes transported from an anode side to the light emitting layer from passing on through to the cathode side. In the invention, the hole-blocking layer can be provided as an organic layer adjacent to the light emitting layer in the cathode side.

Examples of an organic compound which forms the hole-blocking layer include aluminum complexes such as aluminum(III) bis(2-methyl-8-quinolinato) 4-phenylphenolate (abbreviated to BAlq), triazole derivatives, and phenanthroline derivatives such as 2,9-dimethyl-4,7-diphenyl-1,10-phenanthroline (abbreviated to BCP).

The thickness of the hole-blocking layer is preferably from 1 nm to 500 nm, far preferably from 5 nm to 200 nm, further preferably from 10 nm to 100 nm.

The hole-blocking layer may have either a single-layer structure made up of one or more than one material as recited above or a multiple-layer structure made up of two or more layers which are identical or different in composition.

### —Electron Block Layer—

The electron blocking layer is a layer having a function of preventing the electrons transported from the cathode side to the light emitting layer from passing through to the anode side. In the invention, the electron blocking layer can be provided as an organic layer adjacent to the light emitting layer on the anode side.

As the examples of the compounds constituting the electron blocking layer, for instance, the hole transport materials described above can be applied.

The thickness of the electron blocking layer is preferably from 1 nm to 500 nm, more preferably from 5 nm to 200 nm, still more preferably from 10 nm to 100 nm.

The electron blocking layer may have a single layer structure composed of one or more of the above materials or may be a multilayer structure composed of two or more layers having the same composition or different compositions.

### (Protective Layer)

In the invention, the whole of the organic EL device may be coated with a protective layer.

With respect to the protective layer, the matters described in JP-A-2008-270736, paragraph numbers [0169] to [0170], are applicable in the invention.

### (Sealing Enclosure)

The present devices may be sealed in their entirety through the use of sealing enclosure.

With respect to the sealing enclosure, the matters described in JP-A-2008-270736, paragraph number [0171], are applicable in the invention.

### (Driving)

The present organic electroluminescence devices each can produce luminescence when direct-current (which may include an alternating current component as required) voltage (ranging usually from 2 to 15 volts) or direct current is applied between the anode and the cathode.

To a driving method for the present organic electroluminescence devices, the driving methods as disclosed in JP-A-2-148687, JP-A-6-301355, JP-A-5-29080, JP-A-7-134558, JP-A-8-234685, JP-A-8-241047, Japanese Patent No. 2784615, U.S. Pat. Nos. 5,828,429 and 6,023,308 can be applied.

The present organic electroluminescence devices can be heightened in light extraction efficiency by utilizing various publicly-known improvements. For instance, it is possible to improve light extraction efficiency and increase external quantum efficiency by working on the substrate's surface profile (e.g. forming a pattern of microscopic asperities on the substrate's surface), or by controlling refractive indices of the substrate, the ITO layer and the organic layers, or by controlling thicknesses of the substrate, the ITO layer and the organic layers, or so on.

The luminescence device of the invention may take what is called a top emission system of collecting light emission from the anode side.

The present organic EL devices may have resonator structure. For instance, each device has on a transparent substrate a multilayer film mirror made up of a plurality of laminated films that have different refractive indices, a transparent or translucent electrode, a light emitting layer and a metal electrode which are superposed on top of each other. Reflections of light produced in the light emitting layer occur repeatedly between the multilayer film mirror and the metal electrode which function as reflector plates, thereby producing resonance.

In another aspect, the transparent or translucent electrode and the metal electrode function as reflector plates, respectively, on the transparent substrate, and reflections of light produced in the light emitting layer occur repeatedly between the reflector plates, thereby producing resonance.

In order to form a resonance structure, the optical distance determined from effective refractive indices of the two reflector plates, and refractive indices and thicknesses of each layers sandwiched between the two reflector plates are adjusted to have optimum values for achieving the desired resonance wavelength. The calculating formula in the first aspect case is described in JP-A-9-180883, and that in the second aspect case is described in JP-A-2004-127795.

The external quantum efficiency of the organic electroluminescence device in the invention is preferably 5% or more, and more preferably 7% or more. As the value of external quantum efficiency, the maximum value of external quantum efficiency at the time of driving the device at 20° C., alternatively the value of external quantum efficiency near 100 to 300 cd/m² at the time of driving the device at 20° C., can be used.

The internal quantum efficiency of the organic electroluminescence device in the invention is preferably 30% or more, more preferably 50% or more, and still more preferably 70% or more. The internal quantum efficiency of the device is computed by dividing the external quantum efficiency by the light collecting efficiency. The light collecting efficiency of ordinary organic EL devices is about 20%, but the light collecting efficiency can be made 20% or more by variously designing the shape of substrate, the shape of electrode, the thickness of organic layer, the thickness of inorganic layer, the refractive index of organic layer, the refractive index of inorganic layer, etc.

The organic electroluminescence device in the invention preferably has maximum light emitting wavelength (the strongest wavelength of light emission spectrum) of 350 nm or more and 700 nm or less, more preferably 350 nm or more and 600 nm or less, still more preferably 400 nm or more and 520 nm or less, and especially preferably 400 nm or more and 465 nm or less.

### (Use of Present Luminescence Device)

The present luminescence devices can be used suitably for light luminous apparatus, pixels, indication devices, displays, backlights, electrophotographic devices, illumination light sources, recording light sources, exposure light sources, readout light sources, sign, billboards, interior decorations or optical communications, especially preferably for devices driven in a region of high-intensity luminescence, such as illumination apparatus and display apparatus.

Next the present light luminous apparatus is explained by reference to FIG. 2.

The present light luminous apparatus incorporates any one of the present organic electroluminescence devices.

FIG. 2 is a cross-sectional diagram schematically showing one example of the present light luminous apparatus.

The light luminous apparatus 20 in FIG. 2 includes a transparent substrate 2 (supporting substrate), an organic electroluminescence device 10, a sealing enclosure 16 and so on.

The organic electroluminescence device 10 is formed by stacking on the substrate 2 an anode 3 (first electrode), an organic layer 11 and a cathode 9 (second electrode) in the order of mention. In addition, a protective layer 12 is superposed on the cathode 9, and on the protective layer 12 a sealing enclosure 16 is further provided via an adhesive layer 14. Incidentally, part of each of the electrodes 3 and 9, a diaphragm and an insulating layer are omitted in FIG. 2.

Herein, a light cure adhesive such as epoxy resin, or a thermosetting adhesive can be used for the adhesive layer 14. Alternatively, a thermosetting adhesive sheet may be used as the adhesive layer 14.

The present light luminous apparatus has no particular restrictions as to its uses, and specifically, it can be utilized e.g. as not only illumination apparatus but also display apparatus of a television set, a personal computer, a mobile phone, an electronic paper or the like.

Then, illumination apparatus relating to an embodiment of the invention is explained by reference to FIG. 3.

FIG. 3 is a cross-sectional diagram schematically showing one example of the illumination apparatus relating to an embodiment of the invention.

As shown in FIG. 3, the illumination apparatus 40 relating to an embodiment of the invention is equipped with the organic electroluminescence device 10 and a light scattering member 30. More specifically, the illumination apparatus 40 is configured to bring the substrate 2 of the organic electroluminescence device 10 into a contact with the light scattering member 30.

Light-scattering member 30 is not especially restricted so long as it can scatter light, but in FIG. 3, light-scattering member 30 is a member having transparent substrate 31 containing fine particles 32 dispersed therein. As transparent substrate 31, e.g., a glass substrate is preferably exemplified. As fine particles 32, transparent resin fine particles are preferably exemplified. As the glass substrate and transparent resin fine particles, known materials can be used. In such illumination apparatus 40, light emitted from the organic electroluminescence device 10 enters the light scattering member 30 at the light incidence plane 30A, the entering light is scattered by the light scattering member, and the light scattered emerges from the light exit plane 30B as light for illumination.

### EXAMPLES

### Manufacture of Organic Electroluminescence Devices

### Example 1

### Manufacture of Device in Comparative Example 1-1

A cleaned ITO substrate is put in a deposition apparatus, copper phthalocyanine is deposited on the ITO substrate in a thickness of 10 nm, NPD ((N,N′-di-α-naphthyl-N,N′-diphenyl)-benzidine) is deposited on the copper phthalocyanine film in a thickness of 70 mm (a hole-transporting layer), Compound H-1 (shown below) and Compound A-1 (shown below) in a ratio of 90/10 (a mass ratio) are deposited thereon in a thickness of 30 nm (a light-emitting layer), BAlq [bis-(2-methyl-8-quinolinolate)-4-phenylphenolate aluminum] is deposited thereon in a thickness of 30 nm (an electron-transporting layer), lithium fluoride is deposited thereon in a thickness of 3 nm, and aluminum is deposited thereon in a thickness of 60 nm. The obtained product is put in a glove box replaced with argon gas so as not to be in contact with air, and sealed with a stainless steel sealing can and a UV-curing type adhesive (XNR5516HV, manufactured by Nagase-Chiba Ltd.) to obtain an organic electroluminescent device in Comparative Example 1-1. The obtained organic EL device is subjected to application of DC constant voltage with a source measure unit Model 2400 (manufactured by Toyo Corp.) to emit light, as a result, emission of phosphorescence originating in Compound A-1 is obtained.

[Manufacture of devices in Examples 1-1 to 1-42 and Comparative Examples 1-2 to 1-19]

The devices of Examples 1-1 to 1-43 and Comparative Examples 1-2 to 1-19 were produced in the same manner as in Example 1-1 except for changing the compounds as the light-emitting materials and host materials used in Comparative Example 1-1 to the compounds shown in Table 1 below, and were evaluated. Luminescence of phosphorescence derived from each light-emitting material used is obtained. The results obtained are shown in Table 1 below.

### [Evaluation of Devices]

### (Evaluation of Driving Durability)

Each of the obtained organic electroluminescence devices is set in OLED Test System ST-D (manufactured by TSK Co.) and driven on the condition of outside air temperature of 70° C., at initial luminance of 1,000 cd/m² and 10,000 cd/m² in a constant current mode, and respective half life times of luminance are measured.

### (Evaluation of Chromaticity)

D.C. Voltage is applied to the device so as to reach luminance of 10,000 cd/m² and light emission spectrum is measured with light emission spectrum-measuring system ELS 1500 (manufactured by Shimadzu Corporation), from which chromaticity (CIE chromaticity) is computed. Initial chromaticity and chromaticity after decrease to half luminance are evaluated as the chromaticity. The absolute value of the difference in initial chromaticity and chromaticity after decrease to half luminance is found as difference in chromaticity. The smaller the difference in chromaticity, the smaller is the shift in chromaticity after deterioration, and the device is excellent.

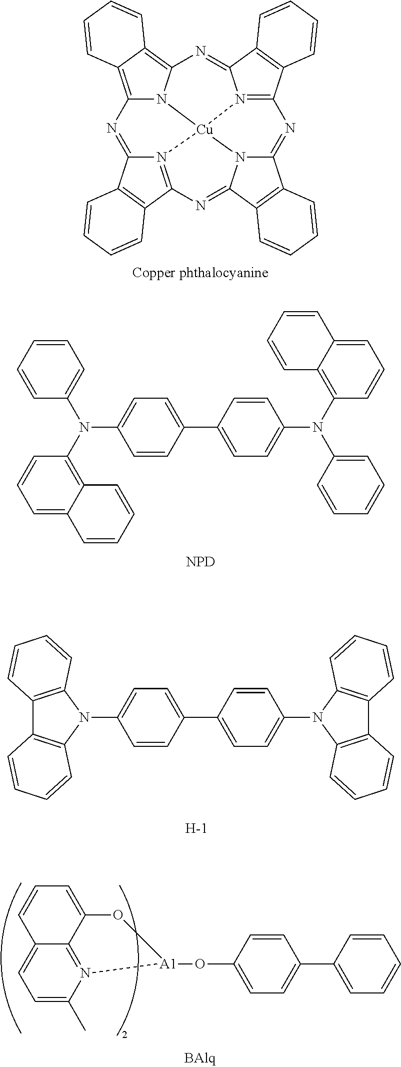

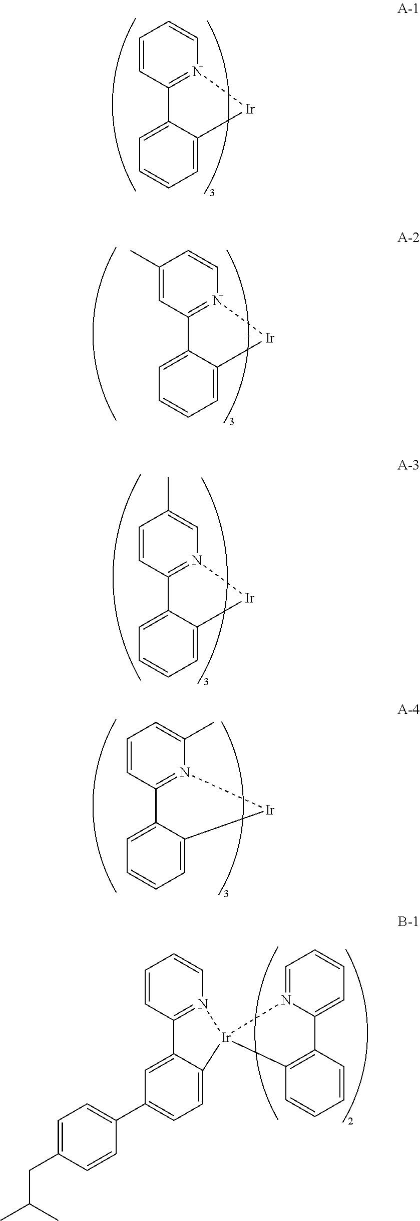

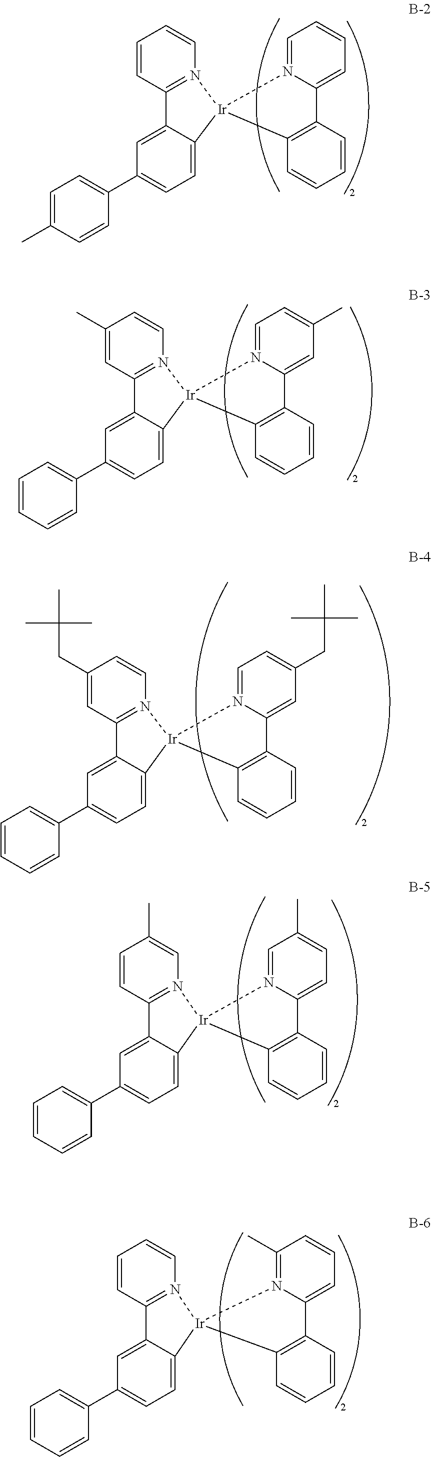

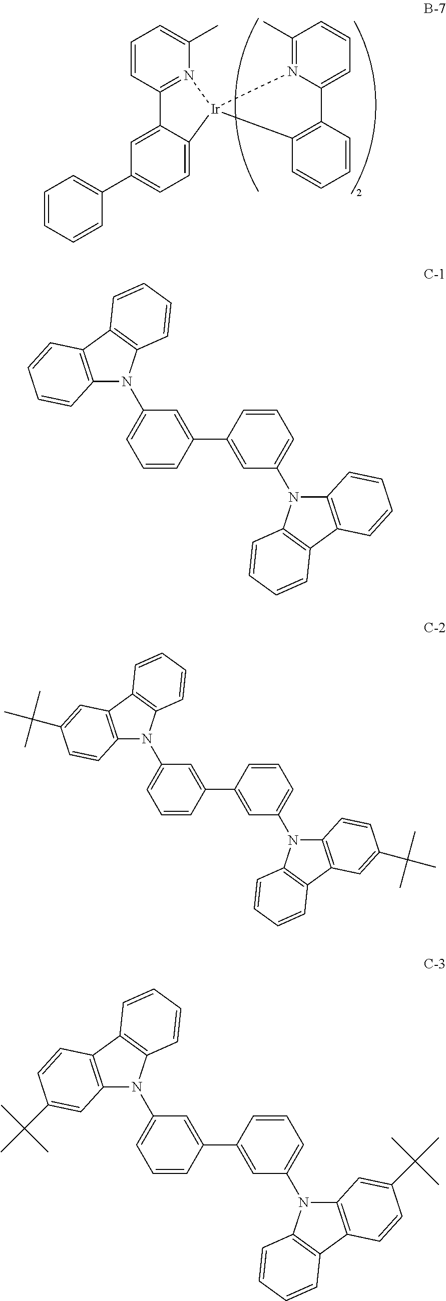

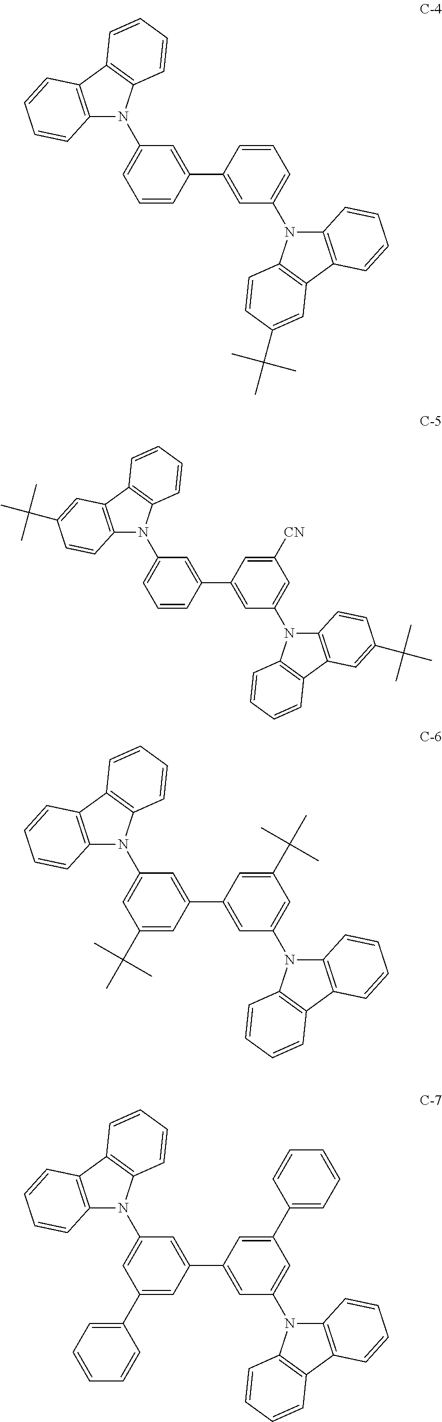

TABLE 1

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative Example 1-1 | A-1 | H-1 | 1,000 | 131 | (0.32, 0.62) | (0.36, 0.60) | (0.04, 0.02) |
| Comparative Example 1-2 | A-1 | C-1 | 1,081 | 163 | (0.31, 0.62) | (0.36, 0.61) | (0.05, 0.01) |
| Comparative Example 1-3 | A-1 | C-2 | 1,183 | 178 | (0.31, 0.62) | (0.36, 0.60) | (0.05, 0.02) |
| Comparative Example 1-4 | B-1 | H-1 | 1,058 | 155 | (0.33, 0.63) | (0.37, 0.61) | (0.04, 0.02) |
| Comparative Example 1 -5 | B-2 | H-1 | 1,116 | 162 | (0.33, 0.62) | (0.38, 0.61) | (0.05, 0.01) |
| Example 1-1 | B-1 | C-1 | 1,298 | 245 | (0.33, 0.62) | (0.35, 0.61) | (0.02, 0.01) |
| Example 1-2 | B-1 | C-2 | 1,327 | 313 | (0.33, 0.63) | (0.35, 0.62) | (0.02, 0.01) |
| Example 1-3 | B-1 | C-3 | 1,304 | 267 | (0.33, 0.62) | (0.36, 0.61) | (0.03, 0.01) |
| Example 1-4 | B-1 | C-4 | 1,317 | 264 | (0.33, 0.62) | (0.36, 0.61) | (0.03, 0.01) |
| Example 1-5 | B-1 | C-6 | 1,213 | 225 | (0.33, 0.63) | (0.36, 0.62) | (0.03, 0.01) |
| Example 1-6 | B-1 | C-7 | 1,277 | 234 | (0.33, 0.62) | (0.35, 0.61) | (0.02, 0.01) |
| Example 1-7 | B-2 | C-1 | 1,309 | 263 | (0.33, 0.63) | (0.36, 0.62) | (0,03, 0.01) |
| Example 1-8 | B-2 | C-2 | 1,563 | 340 | (0.33, 0.63) | (0.36, 0.62) | (0.03, 0.01) |
| Example 1-9 | B-2 | C-3 | 1,388 | 294 | (0.33, 0.63) | (0.35, 0.61) | (0.02, 0.02) |
| Example 1-10 | B-2 | C-4 | 1,414 | 289 | (0.32, 0.62) | (0.35, 0.60) | (0.03, 0.02) |
| Example 1-11 | B-2 | C-6 | 1,226 | 213 | (0.33, 0.63) | (0.36, 0.62) | (0.03, 0.01) |
| Example 1-12 | B-2 | C-7 | 1,283 | 238 | (0.33, 0.62) | (0.36, 0.62) | (0.03, 0.00) |
| Comparative Example 1-6 | A-2 | H-1 | 932 | 133 | (0.31, 0.62) | (0.36, 0.60) | (0.05, 0.02) |
| Comparative Example 1-7 | A-2 | C-1 | 964 | 139 | (0.30, 0.62) | (0.36, 0.61) | (0.06, 0.01) |
| Comparative Example 1-8 | A-2 | C-2 | 986 | 145 | (0.30, 0.62) | (0.35, 0.60) | (0.05, 0.02) |
| Comparative Example 1-9 | B-3 | H-1 | 991 | 153 | (0.32, 0.62) | (0.37, 0.61) | (0.05, 0.01) |
| Comparative Example 1-10 | B-4 | H-1 | 983 | 148 | (0.32, 0.62) | (0.38, 0.60) | (0.06, 0.02) |
| Example 1-13 | B-3 | C-1 | 1,184 | 221 | (0.32, 0.62) | (0.35, 0.60) | (0.03, 0.02) |
| Example 1-14 | B-3 | C-2 | 1,233 | 289 | (0.32, 0.62) | (0.36, 0.60) | (0.04, 0.02) |
| Example 1-15 | B-3 | C-3 | 1,210 | 245 | (0.32, 0.61) | (0.36, 0.60) | (0.04, 0.01) |
| Example 1-16 | B-3 | C-5 | 1,005 | 240 | (0.32, 0.62) | (0.35, 0.60) | (0.03, 0.02) |
| Example 1-17 | B-3 | C-6 | 1,087 | 198 | (0.32, 0.62) | (0.36, 0.61) | (0.03, 0.01) |
| Example 1-18 | B-3 | C-7 | 1,144 | 214 | (0.32, 0.62) | (0.35, 0.60) | (0.03, 0.02) |
| Example 1-19 | B-4 | C-1 | 1,133 | 241 | (0.31, 0.62) | (0.34, 0.61) | (0.03, 0.01) |
| Example 1-20 | B-4 | C-2 | 1,197 | 318 | (0.32, 0.62) | (0.35, 0.60) | (0.03, 0.02) |
| Example 1-21 | B-4 | C-3 | 1,141 | 273 | (0.32, 0.61) | (0.35, 0.61) | (0.03, 0.00) |
| Example 1-22 | B-4 | C-4 | 1,023 | 266 | (0.32, 0.62) | (0.35, 0.60) | (0.03, 0.02) |
| Example 1-23 | B-4 | C-6 | 1,051 | 206 | (0.32, 0.62) | (0.35, 0.61) | (0.03, 0.01) |
| Example 1-24 | B-4 | C-7 | 1,092 | 233 | (0.32, 0.62) | (0.34, 0.60) | (0.02, 0.02) |
| Comparative Example 1-11 | A-3 | H-1 | 488 | 44 | (0.30, 0.63) | (0.35, 0.61) | (0.05, 0.02) |
| Comparative Example 1-12 | A-3 | C-1 | 537 | 52 | (0.30, 0.63) | (0.34, 0.60) | (0.04, 0.03) |
| Comparative Example 1-13 | A-3 | C-2 | 511 | 56 | (0.30, 0.62) | (0.36, 0.60) | (0.06, 0.02) |
| Comparative Example 1-14 | B-5 | H-1 | 560 | 68 | (0.32, 0.62) | (0.37, 0.59) | (0.05, 0.03) |
| Example 1-25 | B-5 | C-1 | 663 | 131 | (0.32, 0.62) | (0.34, 0.60) | (0.02, 0.02) |
| Example 1-26 | B-5 | C-2 | 707 | 158 | (0.32, 0.61) | (0.34, 0.61) | (0.02, 0.00) |
| Example 1-27 | B-5 | C-3 | 652 | 133 | (0.32, 0.62) | (0.34, 0.61) | (0.02, 0.01) |
| Example 1-28 | B-5 | C-4 | 668 | 147 | (0.32, 0.62) | (0.35, 0.60) | (0.03, 0.02) |
| Example 1-29 | B-5 | C-6 | 606 | 108 | (0.32, 0.62) | (0.35, 0.61) | (0.03, 0.01) |
| Example 1-30 | B-5 | C-7 | 637 | 129 | (0.32, 0.62) | (0.34, 0.60) | (0.02, 0.02) |
| Comparative Example 1-15 | A-4 | H-1 | 653 | 63 | (0.30, 0.62) | (0.36, 0.60) | (0.06, 0.02) |
| Comparative Example 1-16 | A-4 | C-1 | 669 | 66 | (0.30, 0.61) | (0.36, 0.59) | (0.06, 0.02) |
| Comparative Example 1-17 | A-4 | C-2 | 679 | 71 | (0.30, 0.61) | (0.36, 0.60) | (0.06, 0.01) |
| Comparative Example 1-18 | B-6 | H-1 | 765 | 77 | (0.32, 0.63) | (0.37, 0.61) | (0.05, 0.02) |
| Comparative Example 1-19 | B-7 | H-1 | 652 | 73 | (0.30, 0.63) | (0.36, 0.60) | (0.06, 0.03) |
| Example 1-31 | B-6 | C-1 | 853 | 189 | (0.32, 0.63) | (0.35, 0.61) | (0.03, 0.02) |
| Example 1-32 | B-6 | C-2 | 922 | 231 | (0.32, 0.63) | (0.34, 0.61) | (0.02, 0.02) |
| Example 1-33 | B-6 | C-3 | 822 | 196 | (0.32, 0.62) | (0.35, 0.60) | (0.03, 0.02) |
| Example 1-34 | B-6 | C-5 | 810 | 177 | (0.32, 0.63) | (0.35, 0.60) | (0.03, 0.03) |
| Example 1-35 | B-6 | C-6 | 814 | 179 | (0.32, 0.63) | (0.34, 0.61) | (0.02, 0.02) |
| Example 1-36 | B-6 | C-7 | 834 | 183 | (0.32, 0.62) | (0.35, 0.60) | (0.03, 0.02) |
| Example 1-37 | B-7 | C-1 | 768 | 176 | (0.30, 0.63) | (0.34, 0.62) | (0.04, 0.01) |
| Example 1-38 | B-7 | C-2 | 859 | 221 | (0.29, 0.62) | (0.33, 0.61) | (0.04, 0.01) |
| Example 1-39 | B-7 | C-3 | 794 | 182 | (0.30, 0.63) | (0.33, 0.62) | (0.03, 0.01) |
| Example 1-40 | B-7 | C-5 | 703 | 167 | (0.30, 0.62) | (0.34, 0.60) | (0.04, 0.02) |
| Example 1-41 | B-7 | C-6 | 720 | 168 | (0.30, 0.63) | (0.33, 0.62) | (0.03, 0.01) |
| Example 1-42 | B-7 | C-7 | 735 | 173 | (0.30, 0.62) | (0.34, 0.61) | (0.04, 0.01) |

As can be apparently seen from the above results, the devices in Examples of the invention show high driving durability (in particular, at the time of high luminance drive) and little in aberration of chromaticity after deterioration as compared with the devices in Comparative Examples. Incidentally, difference in chromaticity is the absolute value of the difference in initial chromaticity and chromaticity after decrease to half luminance, for example, in Comparative Example 1-1, difference in chromaticity is (|0.32-0.36|, |0.62-0.60|)=(0.04, 0.02).

### Example 2

### Manufacture of Device in Example 2-1

The organic EL device in Example 2-1 is manufactured in the same manner as in the manufacture of the device in Comparative Example 1-1, except for performing deposition by changing H-1 and A-1 of the film composition of the light-emitting layer in a ratio of 90/10 (mass ratio) to C-8 and B-2 in a ratio of 90/10 (mass ratio) (film thickness: 30 nm). The obtained organic EL device is subjected to application of DC constant voltage with a source measure unit Model 2400 (manufactured by Toyo Corp.) to emit light, as a result, light luminescence derived from Compound B-2 is obtained.

### (Manufacture of Devices in Examples 2-2 to 2-9)

The organic EL devices in Examples 2-2 to 2-9 are manufactured in the same manner as in the manufacture of the device in Example 2-1, except for changing the materials used in Example 2-1 to the materials shown in Table 2 below. The obtained organic EL devices are subjected to application of DC constant voltage with a source measure unit Model 2400 (manufactured by Toyo Corp.) to emit light, as a result, light emissions of the colors originating in respective light-emitting materials are obtained.

### [Evaluation of Devices]

### (Evaluation of Driving Durability)

Evaluation is performed in the same manner as in Example 1.

### (Evaluation of Chromaticity)

Evaluation is performed in the same manner as in Example 1.

The results of evaluations are shown in Table 2. The results of the devices manufactured in Comparative Examples 1-5, 1-9 and 1-18, and Examples 1-8, 1-14 and 1-32 are also shown in the same table for comparison.

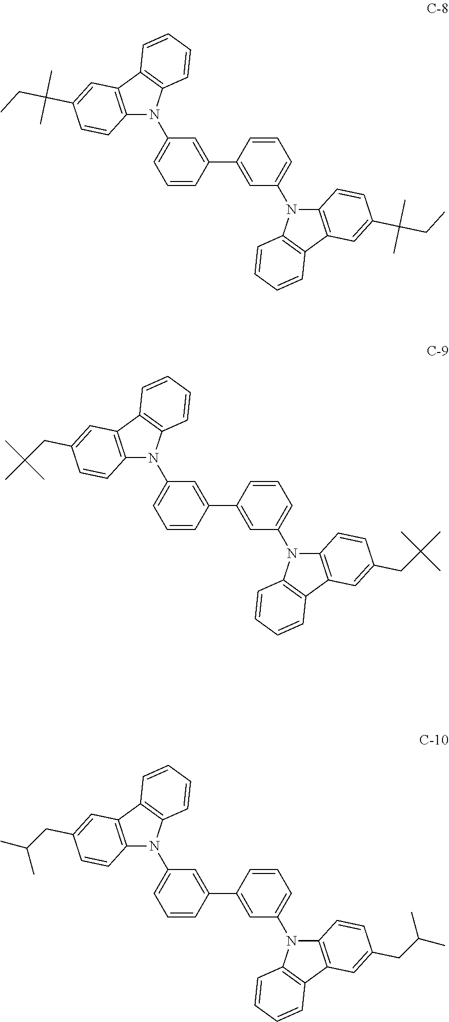

TABLE 2

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative | B-2 | H-1 | 1,116 | 162 | (0.33, 0.62) | (0.38, 0.61) | (0.05, 0.01) |
| Example 1-5 | | | | | | | |
| Example 1-8 | B-2 | C-2 | 1,563 | 340 | (0.33, 0.63) | (0.36, 0.62) | (0.03, 0.01) |
| Example 2-1 | B-2 | C-8 | 1,488 | 320 | (0.33, 0.63) | (0.35, 0.61) | (0.02, 0.02) |
| Example 2-2 | B-2 | C-9 | 1,479 | 311 | (0.32, 0.62) | (0.35, 0.62) | (0.03, 0.00) |
| Example 2-3 | B-2 | C-10 | 1,374 | 286 | (0.33, 0.63) | (0.36, 0.60) | (0.03, 0.03) |
| Comparative | B-3 | H-1 | 991 | 153 | (0.32, 0.62) | (0.37, 0.61) | (0.05, 0.01) |
| Example 1-9 | | | | | | | |
| Example 1-14 | B-3 | C-2 | 1,233 | 289 | (0.32, 0.62) | (0.36, 0.60) | (0.04, 0.02) |
| Example 2-4 | B-3 | C-8 | 1,139 | 268 | (0.32, 0.61) | (0.35, 0.60) | (0.03, 0.01) |
| Example 2-5 | B-3 | C-9 | 1,164 | 273 | (0.32, 0.62) | (0.36, 0.60) | (0.04, 0.02) |
| Example 2-6 | B-3 | C-10 | 1,089 | 242 | (0.32, 0.62) | (0.36, 0.61) | (0.04, 0.01) |
| Comparative | B-6 | H-1 | 765 | 77 | (0.32, 0.63) | (0.37, 0.61) | (0.05, 0.02) |
| Example 1-18 | | | | | | | |
| Example 1-32 | B-6 | C-2 | 922 | 231 | (0.32, 0.63) | (0.34, 0.61) | (0.02, 0.02) |
| Example 2-7 | B-6 | C-8 | 858 | 206 | (0.32, 0.63) | (0.35, 0.61) | (0.03, 0.02) |
| Example 2-8 | B-6 | C-9 | 875 | 214 | (0.32, 0.63) | (0.34, 0.61) | (0.02, 0.02) |
| Example 2-9 | B-6 | C-10 | 807 | 189 | (0.32, 0.62) | (0.35, 0.60) | (0.03, 0.02) |

### Example 3

### Manufacture of Device in Example 3-1

The organic EL device in Example 3-1 is manufactured in the same manner as in the manufacture of the device in Comparative Example 1-1, except for performing deposition by changing H-1 and A-1 of the film composition of the light-emitting layer in a ratio of 90/10 (mass ratio) to C-1 and B-8 in a ratio of 90/10 (mass ratio) (film thickness: 30 nm). The obtained organic EL device is subjected to application of DC constant voltage with a source measure unit Model 2400 (manufactured by Toyo Corp.) to emit light, as a result, luminescence derived from Compound B-8 is obtained.

### (Manufacture of Devices in Examples 3-2 to 3-21 and Comparative Examples 3-1 to 3-3)

The organic EL devices in Examples 3-2 to 3-21 and Comparative Examples 3-1 to 3-3 are manufactured in the same manner as in the manufacture of the device in Example 3-1, except for changing the materials used in Example 3-1 to the materials shown in Table 3 below. The obtained organic EL devices are subjected to application of DC constant voltage with a source measure unit Model 2400 (manufactured by Toyo Corp.) to emit light, as a result, luminescence of the colors derived from respective light-emitting materials are obtained.

### [Evaluation of Devices]

### (Evaluation of Driving Durability)

Each of the obtained organic electroluminescence devices is set in OLED Test System ST-D (manufactured by TSK Co.) and driven on the condition of outside air temperature of 70° C., at initial luminance of 1,000 cd/m² and 10,000 cd/m² in a constant current mode, and respective half luminance times are measured.

### (Evaluation of Chromaticity)

Evaluation is performed in the same manner as in Example 1.

The results of evaluations are shown in Table 3. The results of the devices manufactured in Comparative Examples 1-1 to 1-3 and 1-15 to 1-17 are also shown in the same table for comparison.

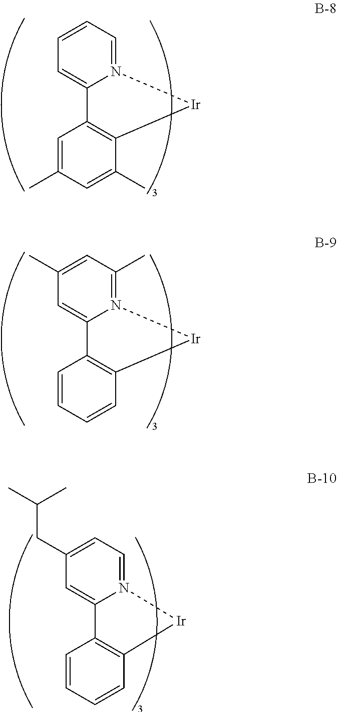

TABLE 3

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative | A-1 | H-1 | 1,000 | 131 | (0.32, 0.62) | (0.36, 0.60) | (0.04, 0.02) |
| Example 1-1 | | | | | | | |
| Comparative | A-1 | C-1 | 1,081 | 163 | (0.31, 0.62) | (0.36, 0.61) | (0.05, 0.01) |
| Example 1-2 | | | | | | | |
| Comparative | A-1 | C-2 | 1,183 | 178 | (0.31, 0.62) | (0.36, 0.60) | (0.05, 0.02) |
| Example 1-3 | | | | | | | |
| Comparative | B-8 | H-1 | 950 | 119 | (0.32, 0.63) | (0.35, 0.62) | (0.03, 0.01) |
| Example 3-1 | | | | | | | |
| Example 3-1 | B-8 | C-1 | 1,139 | 195 | (0.32, 0.63) | (0.34, 0.60) | (0.02, 0.03) |
| Example 3-2 | B-8 | C-2 | 1,216 | 211 | (0.32, 0.63) | (0.33, 0.61) | (0.01, 0.02) |
| Example 3-3 | B-8 | C-3 | 1,141 | 204 | (0.32, 0.63) | (0.33, 0,61) | (0.01, 0.02) |
| Example 3-4 | B-8 | C-4 | 1,125 | 196 | (0.32, 0.62) | (0.34, 0.60) | (0.02, 0.02) |
| Example 3-5 | B-8 | C-7 | 1,088 | 189 | (0.32, 0.63) | (0.33, 0.61) | (0.01, 0.02) |
| Example 3-6 | B-8 | C-8 | 1,143 | 195 | (0.32, 0.62) | (0.33, 0.61) | (0.01, 0.01) |
| Example 3-7 | B-8 | C-9 | 1,168 | 207 | (0.32, 0.63) | (0.34, 0.62) | (0.02, 0.01) |
| Comparative | A-4 | H-1 | 653 | 63 | (0.30, 0.62) | (0.36, 0.60) | (0.06, 0.02) |
| Example 1-15 | | | | | | | |
| Comparative | A-4 | C-1 | 669 | 66 | (0.30 0.61) | (0.36, 0.59) | (0.06, 0.02) |
| Example 1-16 | | | | | | | |
| Comparative | A-4 | C-2 | 679 | 71 | (0.30, 0.61) | (0.36, 0.60) | (0.06, 0.01) |
| Example 1-17 | | | | | | | |
| Comparative | B-9 | H-1 | 583 | 59 | (0.32, 0.63) | (0.38, 0.61) | (0.06, 0.02) |
| Example 3-2 | | | | | | | |
| Example 3-8 | B-9 | C-1 | 735 | 123 | (0.31, 0.63) | (0.35, 0.60) | (0.04, 0.03) |
| Example 3-9 | B-9 | C-2 | 817 | 159 | (0.31, 0.62) | (0.33, 0.61) | (0.02, 0.01) |
| Example 3-10 | B-9 | C-3 | 746 | 138 | (0.31, 0.62) | (0.33, 0.61) | (0.02, 0.01) |
| Example 3-11 | B-9 | C-4 | 722 | 126 | (0.31, 0.63) | (0.34, 0.62) | (0.03, 0.01) |
| Example 3-12 | B-9 | C-7 | 701 | 117 | (0.31, 0.62) | (0.33, 0.61) | (0.02, 0.01) |
| Example 3-13 | B-9 | C-8 | 760 | 153 | (0.31, 0.62) | (0.34, 0.61) | (0.03, 0.01) |
| Example 3-14 | B-9 | C-9 | 784 | 152 | (0.31, 0.63) | (0.33, 0.62) | (0.02, 0.01) |
| Comparative | B-10 | H-1 | 605 | 60 | (0.31, 0.62) | (0.38, 0.60) | (0.07, 0.02) |
| Example 3-3 | | | | | | | |
| Example 3-15 | B-10 | C-1 | 688 | 173 | (0.31, 0.63) | (0.33, 0.62) | (0.02, 0.01) |
| Example 3-16 | B-10 | C-2 | 762 | 204 | (0.31, 0.62) | (0.33, 0.61) | (0.02, 0.01) |
| Example 3-17 | B-10 | C-3 | 685 | 185 | (0.31, 0.62) | (0.33, 0.62) | (0.02, 0.00) |
| Example 3-18 | B-10 | C-4 | 663 | 169 | (0.32, 0.62) | (0.34, 0.61) | (0.02, 0.01) |
| Example 3-19 | B-10 | C-7 | 659 | 151 | (0.31, 0.62) | (0.33, 0.61) | (0.02, 0.01) |
| Example 3-20 | B-10 | C-8 | 714 | 188 | (0.31, 0.63) | (0.34, 0.62) | (0.03, 0.01) |
| Example 3-21 | B-10 | C-9 | 729 | 197 | (0.31, 0.62) | (0.33, 0.61) | (0.02, 0.01) |

As can be apparently seen from the above results, the devices in Examples of the invention show high driving durability (in particular, at the time of high luminance drive) and little in aberration of chromaticity after deterioration as compared with the devices in Comparative Examples.

### Example 4

### Manufacture of Device in Example 4-1

The organic EL device in Example 4-1 is manufactured in the same manner as in the manufacture of the device in Comparative Example 1-1, except for performing deposition by changing H-1 and A-1 of the film composition of the light-emitting layer in a ratio of 90/10 (mass ratio) to C-1 and B-11 in a ratio of 90/10 (mass ratio) (film thickness: 30 nm). The obtained organic EL device is subjected to application of DC constant voltage with a source measure unit Model 2400 (manufactured by Toyo Corp.) to emit light, as a result, luminescence derived from Compound B-11 is obtained.

### (Manufacture of Devices in Example 4-2 to 4-9 and Comparative Examples 4-1 to 4-3)

The organic EL devices in Examples 4-2 to 4-9 and Comparative Examples 4-1 to 4-3 are manufactured in the same manner as in the manufacture of the device in Example 3-1, except for changing the materials used in Example 3-1 to the materials shown in Table 4 below. The obtained organic EL devices are subjected to application of DC constant voltage with a source measure unit Model 2400 (manufactured by Toyo Corp.) to emit light, as a result, luminescence of the colors derived from respective light-emitting materials are obtained.

### [Evaluation of Devices]

### (Evaluation of Driving Durability)

Evaluation is performed in the same manner as in Example 1.

### (Evaluation of Chromaticity)

Evaluation is performed in the same manner as in Example 1.

The results of evaluations are shown in Table 4. The results of the devices manufactured in Comparative Examples 1-5, 1-9 and 1-19, and Examples 1-8, 1-14, 1-38, 2-1, 2-2, 2-4 and 2-5 are also shown in the same table for comparison.

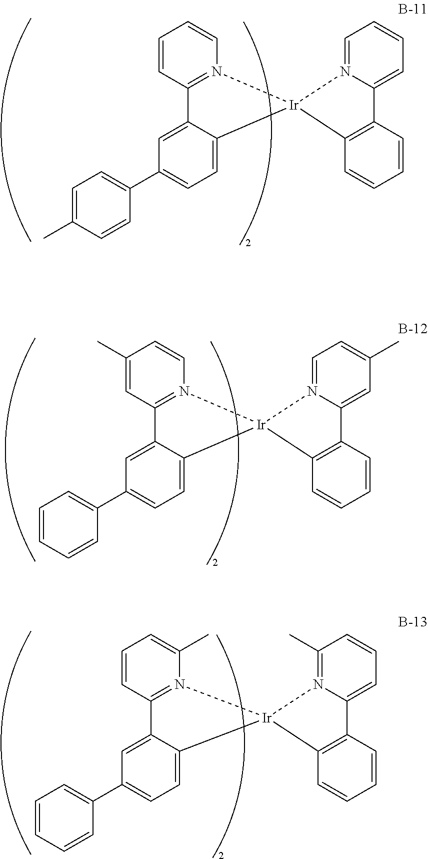

TABLE 4

| | Light-Emitting Layer | | Half Luminance | Half Luminance | | Chromaticity | |
|---|---|---|---|---|---|---|---|
| | Light- | | Time at | Time at | | After Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative | B-2 | H-1 | 1,116 | 162 | (0.33, 0.62) | (0.38, 0.61) | (0.05, 0.01) |
| Example 1-5 | | | | | | | |
| Example 1-8 | B-2 | C-2 | 1,563 | 340 | (0.33, 0.63) | (0.36, 0.62) | (0.03, 0.01) |
| Example 2-1 | B-2 | C-8 | 1,488 | 320 | (0.33, 0.63) | (0.35, 0.61) | (0.02, 0.02) |
| Example 2-2 | B-2 | C-9 | 1,479 | 311 | (0.32, 0.62) | (0.35, 0.62) | (0.03, 0.00) |
| Comparative | B-11 | H-1 | 1,038 | 136 | (0.33, 0.62) | (0.39, 0.61) | (0.06, 0.01) |
| Example 4-1 | | | | | | | |
| Example 4-1 | B-11 | C-2 | 1,413 | 312 | (0.33, 0.63) | (0.36, 0.62) | (0.03, 0.01) |
| Example 4-2 | B-11 | C-8 | 1,348 | 286 | (0.32, 0.63) | (0.36, 0.61) | (0.04, 0.02) |
| Example 4-3 | B-11 | C-9 | 1,355 | 288 | (0.32, 0.62) | (0.36, 0.62) | (0.04, 0.00) |
| Comparative | B-3 | H-1 | 991 | 153 | (0.32, 0.62) | (0.37, 0.61) | (0.05, 0.01) |
| Example 1-9 | | | | | | | |
| Example 1-14 | B-3 | C-2 | 1,233 | 289 | (0.31, 0.62) | (0.36, 0.60) | (0.05, 0.02) |
| Example 2-4 | B-3 | C-8 | 1,139 | 268 | (0.31, 0.61) | (0.35, 0.60) | (0.04, 0.01) |
| Example 2-5 | B-3 | C-9 | 1,164 | 273 | (0.31, 0.62) | (0.36, 0.60) | (0.05, 0.02) |
| Comparative | B-12 | H-1 | 881 | 136 | (0.31, 0.62) | (0.37, 0.61) | (0.06, 0.01) |
| Example 4-2 | | | | | | | |
| Example 4-4 | B-12 | C-2 | 1,132 | 266 | (0.31, 0.62) | (0.36, 0.61) | (0.05, 0.01) |
| Example 4-5 | B-12 | C-8 | 1,037 | 247 | (0.31, 0.61) | (0.35, 0.60) | (0.04, 0.01) |
| Example 4-6 | B-12 | C-9 | 1,055 | 250 | (0.31, 0.62) | (0.36, 0.61) | (0.05, 0.01) |
| Comparative | B-7 | H-1 | 652 | 73 | (0.30, 0.63) | (0.35, 0.62) | (0.05, 0.01) |
| Example 1-19 | | | | | | | |
| Example 1-38 | B-7 | C-2 | 859 | 221 | (0.29, 0.62) | (0.33, 0.61) | (0.04, 0.01) |
| Comparative | B-13 | H-1 | 549 | 61 | (0.30, 0.62) | (0.36, 0.62) | (0.06, 0.00) |
| Example 4-3 | | | | | | | |
| Example 4-7 | B-13 | C-2 | 746 | 185 | (0.29, 0.62) | (0.32, 0.61) | (0.03, 0.01) |
| Example 4-8 | B-13 | C-8 | 699 | 172 | (0.30, 0.62) | (0.33, 0.62) | (0.03, 0.00) |
| Example 4-9 | B-13 | C-9 | 710 | 178 | (0.30, 0.62) | (0.32, 0.61) | (0.02, 0.01) |

### Example 5

### (Manufacture of Device in Example 5-1)

The organic EL device in Example 5-1 is manufactured in the same manner as in the manufacture of the device in Comparative Example 1-1, except for performing deposition by changing H-1 and A-1 of the film composition of the light-emitting layer in a ratio of 90/10 (mass ratio) to C-1 and B-16 in a ratio of 90/10 (mass ratio) (film thickness: 30 nm). The obtained organic EL device is subjected to application of DC constant voltage with a source measure unit Model 2400 (manufactured by Toyo Corporation) to emit light, as a result, luminescence derived from Compound B-16 is obtained.

### (Manufacture of Devices in Examples 5-2 to 5-17 and Comparative Examples 5-1 to 5-4)

The organic EL devices in Examples 5-2 to 5-17 and Comparative Examples 5-1 to 5-4 are manufactured in the same manner as in the manufacture of the device in Example 5-1, except for changing the materials used in Example 5-1 to the materials shown in Table 5 below. The obtained organic EL devices are subjected to application of DC constant voltage with a source measure unit Model 2400 (manufactured by Toyo Corp.) to emit Tight, as a result, luminescence of the colors derived from respective light-emitting materials are obtained.

### [Evaluation of Devices]

### (Evaluation of Driving Durability)

Evaluation is performed in the same manner as in Example 1.

### (Evaluation of Chromaticity)

Evaluation is performed in the same manner as in Example 1.

The results of evaluations are shown in Table 5. The results of the devices manufactured in Comparative Examples 1-1, 1-3 and 4-1, and Examples 4-1 to 4-3 are also shown in the same table for comparison.

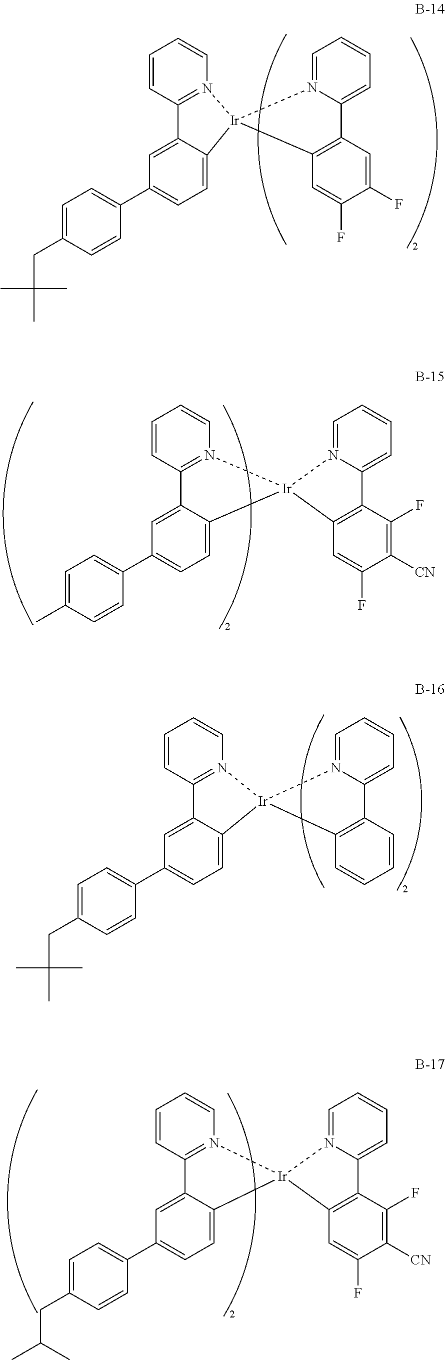

TABLE 5

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative | A-1 | H-1 | 1,000 | 131 | (0.32, 0.62) | (0.36, 0.60) | (0.04, 0.02) |
| Example 1-1 | | | | | | | |
| Comparative | A-1 | C-2 | 1,183 | 178 | (0.31, 0.62) | (0.36, 0.60) | (0.05, 0.02) |
| Example 1-3 | | | | | | | |
| Comparative | B-16 | H-1 | 1,093 | 158 | (0.33, 0.63) | (0.37, 0.61) | (0.04 0.02) |
| Example 5-1 | | | | | | | |
| Example 5-1 | B-16 | C-1 | 1,279 | 255 | (0.33, 0.62) | (0.36, 0.62) | (0.03, 0.00) |
| Example 5-2 | B-16 | C-2 | 1,510 | 343 | (0.33, 0.63) | (0.35, 0.62) | (0.02, 0.01) |
| Example 5-3 | B-16 | C-4 | 1,388 | 278 | (0.33, 0.62) | (0.36, 0.60) | (0.03, 0.02) |
| Example 5-4 | B-16 | C-8 | 1,419 | 321 | (0.33, 0.62) | (0.35, 0.61) | (0.02, 0.01) |
| Comparative | B-14 | H-1 | 1,231 | 171 | (0.33, 0.63) | (0.36, 0.62) | (0.03, 0.01) |
| Example 5-2 | | | | | | | |
| Example 5-5 | B-14 | C-1 | 1,447 | 368 | (0.32, 0.63) | (0.34, 0.63) | (0.02, 0.00) |
| Example 5-6 | B-14 | C-2 | 1,682 | 390 | (0.32, 0.63) | (0.34, 0.62) | (0.02, 0.01) |
| Example | B-14 | C-4 | 1,399 | 343 | (0.33, 0.63) | (0.35, 0.62) | (0.02, 0.01) |
| Example | B-14 | C-8 | 1,581 | 362 | (0.32, 0.63) | (0.34, 0.62) | (0.02, 0.01) |
| Comparative | B-11 | H-1 | 1,038 | 136 | (0.33, 0.62) | (0.39, 0.61) | (0.06, 0.01) |
| Example 4-1 | | | | | | | |
| Example 4-1 | B-11 | C-2 | 1,413 | 312 | (0.33, 0.63) | (0.36, 0.62) | (0.03, 0.01) |
| Example 4-2 | B-11 | C-8 | 1,348 | 286 | (0.32, 0.63) | (0.36, 0.61) | (0.04, 0.02) |
| Example 4-3 | B-11 | C-9 | 1,355 | 288 | (0.32, 0.62) | (0.36, 0.62) | (0.04, 0.00) |
| Comparative | B-15 | H-1 | 1,455 | 193 | (0.31, 0.62) | (0.35, 0.60) | (0.04, 0.02) |
| Example 5-3 | | | | | | | |
| Example 5-9 | B-15 | C-1 | 1,893 | 395 | (0.31, 0.62) | (0.33, 0.61) | (0.02, 0.01) |
| Example 5-10 | B-15 | C-2 | 2,258 | 425 | (0.31, 0.62) | (0.33, 0.62) | (0.02, 0.00) |
| Example 5-11 | B-15 | C-4 | 1,880 | 388 | (0.32, 0.62) | (0.34, 0.61) | (0.02, 0.01) |
| Example 5-12 | B-15 | C-8 | 2,129 | 396 | (0.31, 0.62) | (0.33, 0.61) | (0.02, 0.01) |
| Example 5-13 | B-15 | C-9 | 2,153 | 411 | (0.31, 0.62) | (0.33, 0.62) | (0.02, 0.00) |
| Comparative | B-17 | H-1 | 1,310 | 177 | (0.31, 0.63) | (0.35, 0.60) | (0.04, 0.03) |
| Example 5-4 | | | | | | | |
| Example 5-14 | B-17 | C-1 | 1,737 | 358 | (0.31, 0.62) | (0.34, 0.61) | (0.03, 0.01) |
| Example 5-15 | B-17 | C-2 | 2,004 | 384 | (0.31, 0.62) | (0.33, 0.62) | (0.02, 0.00) |
| Example 5-16 | B-17 | C-8 | 1,888 | 358 | (0.32, 0.63) | (0.33, 0.61) | (0.01, 0.02) |
| Example 5-17 | B-17 | C-9 | 1,924 | 368 | (0.31, 0.62) | (0.34, 0.60) | (0.03, 0.02) |

As can be apparently seen from the above results, the devices in Examples of the invention show high driving durability (in particular, at the time of high luminance drive) and little in aberration of chromaticity after deterioration as compared with the devices in Comparative Examples.

### Example 6

### (Manufacture of Device in Example 6-1)

The organic EL device in Example 6-1 is manufactured in the same manner as in the manufacture of the device in Comparative Example 1-1, except for performing deposition by changing H-1 and A-1 of the film composition of the light-emitting layer in a ratio of 90/10 (mass ratio) to C-1 and B-16 in a ratio of 90/10 (mass ratio) (film thickness: 30 nm). The obtained organic EL device is subjected to application of DC constant voltage with a source measure unit Model 2400 (manufactured by Toyo Corp.) to emit light, as a result, luminescence derived from Compound B-16 is obtained.

### (Manufacture of Devices in Examples 6-2 to 6-12)

The organic EL devices in Examples 6-2 to 6-12 are manufactured in the same manner as in the manufacture of the device in Example 6-1, except for changing the materials used in Example 6-1 to the materials shown in Table 6 below. The obtained organic EL devices are subjected to application of DC constant voltage with a source measure unit Model 2400 (manufactured by Toyo Corp.) to emit light, as a result, luminescence of the colors derived from respective light-emitting materials are obtained.

### [Evaluation of Devices]

### (Evaluation of Driving Durability)

Evaluation is performed in the same manner as in Example 1.

### (Evaluation of Chromaticity)

Evaluation is performed in the same manner as in Example 1.

The results of evaluations are shown in Table 6. The results of the devices manufactured in Comparative Examples 1-1 to 1-3, 1-12 and 1-13, and Examples 1-1, 1-2, 1-4, 1-7, 1-8, 1-10, 1-25 to 1-27, 5-1 to 5-4 are also shown in the same table for comparison.

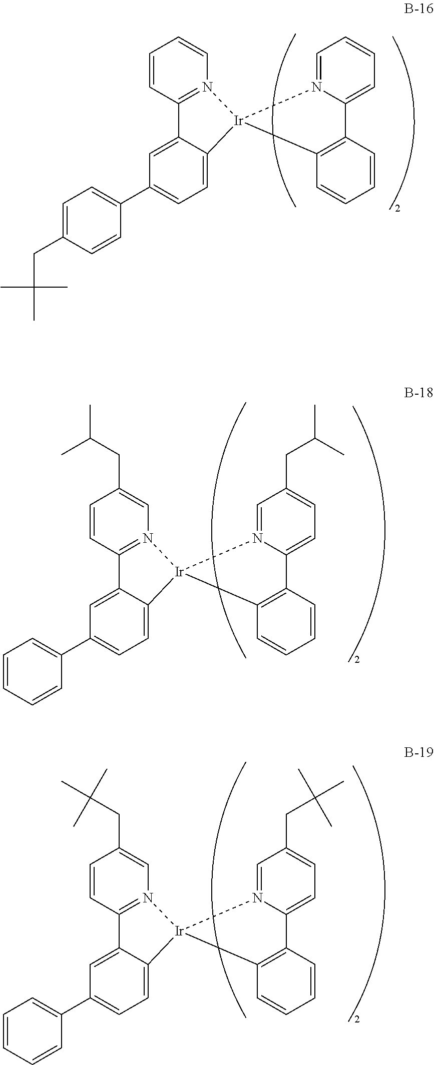

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative | A-1 | H-1 | 1,000 | 131 | (0.32, 0.62) | (0.36, 0.60) | (0.04, 0.02) |
| Example 1-1 | | | | | | | |
| Comparative | A-1 | C-1 | 1,081 | 163 | (0.31, 0.62) | (0.36, 0.61) | (0.05, 0.01) |
| Example 1-2 | | | | | | | |
| Comparative | A-1 | C-2 | 1,183 | 178 | (0.31, 0.62) | (0.36, 0.60) | (0.05, 0.02) |
| Example 1-3 | | | | | | | |
| Example 1-1 | B-1 | C-1 | 1,298 | 245 | (0.33, 0.62) | (0.35, 0.61) | (0.02, 0.01) |
| Example 1-2 | B-1 | C-2 | 1,327 | 313 | (0.33, 0.63) | (0.35, 0.62) | (0.02, 0.01) |
| Example 1-4 | B-1 | C-4 | 1,317 | 264 | (0.33, 0.62) | (0.36, 0.61) | (0.03, 0.01) |
| Example 1-7 | B-2 | C-1 | 1,309 | 263 | (0.33, 0.63) | (0.36, 0.62) | (0.03, 0.01) |
| Example 1-8 | B-2 | C-2 | 1,563 | 340 | (0.33, 0.63) | (0.36, 0.62) | (0.03, 0.01) |
| Example 1-10 | B-2 | C-4 | 1,414 | 289 | (0.33, 0.62) | (0.35, 0.60) | (0.02, 0.02) |
| Example 5-1 | B-16 | C-1 | 1,279 | 255 | (0.33, 0.62) | (0.36, 0.62) | (0.03, 0.00) |
| Example 5-2 | B-16 | C-2 | 1,510 | 343 | (0.33, 0.63) | (0.35, 0.62) | (0.02, 0.01) |
| Example 5-3 | B-16 | C-4 | 1,388 | 278 | (0.33, 0.62) | (0.36, 0.60) | (0.03, 0.02) |
| Example 5-4 | B-16 | C-8 | 1,419 | 321 | (0.33, 0.62) | (0.35, 0.61) | (0.02, 0.01) |
| Example 6-1 | B-16 | C-9 | 1,453 | 331 | (0.33, 0.62) | (0.35, 0.61) | (0.02, 0.01) |
| Comparative | A-3 | C-1 | 537 | 52 | (0.30, 0.63) | (0.34, 0.60) | (0.04, 0.03) |
| Example 1-12 | | | | | | | |
| Comparative | A-3 | C-2 | 511 | 56 | (0.30, 0.62) | (0.36, 0.60) | (0.06, 0.02) |
| Example 1-13 | | | | | | | |
| Example 1-25 | B-5 | C-1 | 663 | 131 | (0.32, 0.62) | (0.34, 0.60) | (0.02, 0.02) |
| Example 1-26 | B-5 | C-2 | 707 | 158 | (0.32, 0.61) | (0.34, 0.61) | (0.02, 0.00) |
| Example 1-27 | B-5 | C-3 | 652 | 133 | (0.32, 0.62) | (0.34, 0.61) | (0.02, 0.01) |
| Example 6-2 | B-18 | C-1 | 618 | 113 | (0.32, 0.63) | (0.34, 0.61) | (0.02, 0.02) |
| Example 6-3 | B-18 | C-2 | 666 | 137 | (0.33, 0.63) | (0.35, 0.61) | (0.02, 0.02) |
| Example 6-4 | B-18 | C-3 | 619 | 123 | (0.32, 0.62) | (0.35, 0.60) | (0.03, 0.02) |
| Example 6-5 | B-18 | C-8 | 624 | 125 | (0.33, 0.62) | (0.35, 0.61) | (0.02, 0.01) |
| Example 6-7 | B-18 | C-9 | 636 | 136 | (0.32, 0.62) | (0.35, 0.61) | (0.03, 0.01) |
| Example 6-8 | B-19 | C-1 | 673 | 138 | (0.33, 0.63) | (0.35, 0.61) | (0.02, 0.02) |
| Example 6-9 | B-19 | C-2 | 722 | 165 | (0.32, 0.63) | (0.34, 0.62) | (0.02, 0.01) |
| Example 6-10 | B-19 | C-3 | 661 | 130 | (0.33, 0.62) | (0.35, 0.61) | (0.02, 0.01) |
| Example 6-11 | B-19 | C-8 | 682 | 154 | (0.33, 0.63) | (0.35, 0.61) | (0.02, 0.02) |
| Example 6-12 | B-19 | C-9 | 699 | 162 | (0.32, 0.63) | (0.34, 0,62) | (0.02, 0.01) |

As can be apparently seen from the above results, the devices in Examples of the invention show high driving durability (in particular, at the time of high luminance drive) and little in aberration of chromaticity after deterioration as compared with the devices in Comparative Examples.

### Example 7

### Manufacture of Device in Comparative Example 7-1

A glass substrate having an ITO film having a thickness of 0.5 mm and 2.5 cm square (manufactured by Geomatec Co., Ltd., surface resistance: 10 Ω/sq.) is put in a clean vessel and subjected to ultrasonic washing in 2-propanol, and then to UV-ozone treatment for 30 minutes. A solution obtained by diluting poly(3,4-ethylenedioxy-thiophene)/polystyrene sulfonate (PEDOT/PSS) with pure water to 70% is coated on the ITO film with a spin coater to provide a hole-transporting layer having a thickness of 50 nm. A methylene chloride solution obtained by dissolving therein H-1 and A-1 in a ratio of 93/7 (mass ratio) is coated with a spin coater to provide a light-emitting layer having a thickness of 30 nm. Thereafter, BAlq [bis(2-methyl-8-quinolinolate)-4-phenylphenolate aluminum] was deposited thereon in a thickness of 40 nm. In a deposition apparatus, lithium fluoride is deposited in a thickness of 0.5 nm as a cathode buffer layer on the organic compound layer, and aluminum is deposited thereon in a thickness of 150 nm as a cathode. The obtained product is put in a glove box replaced with argon gas so as not to be in contact with air, and sealed with a stainless steel sealing can and a UV-curing type adhesive (XNR5516HV, manufactured by Nagase-Chiba Ltd.) to obtain an organic EL device in Comparative Example 7-1. The obtained organic EL device is subjected to application of DC constant voltage with a source measure unit Model 2400 (manufactured by Toyo Corporation) to emit light, as a result, luminescence originating in Compound A-1 is obtained.

### (Manufacture of Devices in Examples 7-1 to 7-21 and Comparative Example 7-2 to 7-7)

The organic EL devices in Comparative Examples 7-2 to 7-7 and Examples 7-1 to 7-21 are manufactured in the same manner as in the manufacture of the device in Comparative Example 7-1, except for changing the materials used in Comparative Example 7-1 to the materials shown in Table 7 below. The obtained organic EL devices are subjected to application of DC constant voltage with a source measure unit Model 2400 (manufactured by Toyo Corporation) to emit light, as a result, luminescence of the colors derived from respective light-emitting materials are obtained.

### [Evaluation of Devices]

### (Evaluation of Driving Durability)

Each of the obtained organic electroluminescence devices is set in OLED Test System ST-D (manufactured by TSK Co.) and driven on the condition of outside air temperature of 70° C., at initial luminance of 1,000 cd/m² and 5,000 cd/m² in a constant current mode, and respective half luminance times of are measured.

### (Evaluation of Chromaticity)

Evaluation is performed in the same manner as in Example 1.

The results of evaluations are shown in Table 7.

| | Light-Emitting Layer | | Half Luminance | Half Luminance | | Chromaticity | |
|---|---|---|---|---|---|---|---|
| | Light- | | Time at | Time at | | after Decrease | |
| | Emitting | Host | 1,000 cd/m² | 10,000 cd/m² | Initial | to Half | Difference in |
| Example No. | Material | Material | (relative value) | (relative value) | Chromaticity | Luminance | Chromaticity |
| Comparative Example 1-1 | A-1 | H-1 | 1,000 | 131 | (0.32, 0.62) | (0.36, 0.60) | (0.04, 0.02) |
| Comparative Example 1-2 | A-1 | C-1 | 1,081 | 163 | (0.31, 0.62) | (0.36, 0.61) | (0.05, 0.01) |
| Comparative Example 1-3 | A-1 | C-2 | 1,183 | 178 | (0.31, 0.62) | (0.36, 0.60) | (0.05, 0.02) |
| Comparative Example 1-4 | B-1 | H-1 | 1,058 | 155 | (0.33, 0.63) | (0.37, 0.61) | (0.04, 0.02) |
| Comparative Example 1-5 | B-2 | H-1 | 1,116 | 162 | (0.33, 0.62) | (0.38, 0.61) | (0.05, 0.01) |
| Example 1-1 | B-1 | C-1 | 1,298 | 245 | (0.33, 0.62) | (0.35, 0.61) | (0.02, 0.01) |
| Example 1-2 | B-1 | C-2 | 1,327 | 313 | (0.33, 0.63) | (0.35, 0.62) | (0.02, 0.01) |
| Example 1-3 | B-1 | C-3 | 1,304 | 267 | (0.33, 0.62) | (0.36, 0.61) | (0.03, 0.01) |
| Example 1-4 | B-1 | C-4 | 1,317 | 264 | (0.33, 0.62) | (0.36, 0.61) | (0.03, 0.01) |
| Example 1-5 | B-1 | C-6 | 1,213 | 225 | (0.33, 0.63) | (0.36, 0.62) | (0.03, 0.01) |
| Example 1-6 | B-1 | C-7 | 1,277 | 234 | (0.33, 0.62) | (0.35, 0.61) | (0.02, 0.01) |
| Example 1-7 | B-2 | C-1 | 1,309 | 263 | (0.33, 0.63) | (0.36, 0.62) | (0.03, 0.01) |
| Example 1-8 | B-2 | C-2 | 1,563 | 340 | (0.33, 0.63) | (0.36, 0.62) | (0.03, 0.01) |
| Example 1-9 | B-2 | C-3 | 1,388 | 294 | (0.33, 0.63) | (0.35, 0.61) | (0.02, 0.02) |
| Example 1-10 | B-2 | C-4 | 1,414 | 289 | (0.32, 0.62) | (0.35, 0.60) | (0.03, 0.02) |
| Example 1-11 | B-2 | C-6 | 1,226 | 213 | (0.33, 0.63) | (0.36, 0.62) | (0.03, 0.01) |
| Example 1-12 | B-2 | C-7 | 1,283 | 238 | (0.33, 0.62) | (0.36, 0.62) | (0.03, 0.00) |
| Comparative Example 1-6 | A-2 | H-1 | 932 | 133 | (0.31, 0.62) | (0.36, 0.60) | (0.05, 0.02) |
| Comparative Example 1-7 | A-2 | C-1 | 964 | 139 | (0.30, 0.62) | (0.36, 0.61) | (0.06, 0.01) |
| Comparative Example 1-8 | A-2 | C-2 | 986 | 145 | (0.30, 0.62) | (0.35, 0.60) | (0.05, 0.02) |
| Comparative Example 1-9 | B-3 | H-1 | 991 | 153 | (0.32, 0.62) | (0.37, 0.61) | (0.05, 0.01) |
| Comparative Example 1-10 | B-4 | H-1 | 983 | 148 | (0.32, 0.62) | (0.38, 0.60) | (0.06, 0.02) |
| Example 1-13 | B-3 | C-1 | 1,184 | 221 | (0.32, 0.62) | (0.35, 0.60) | (0.03, 0.02) |
| Example 1-14 | B-3 | C-2 | 1,233 | 289 | (0.32, 0.62) | (0.36, 0.60) | (0.04, 0.02) |
| Example 1-15 | B-3 | C-3 | 1,210 | 245 | (0.32, 0.61) | (0.36, 0.60) | (0.04, 0.01) |
| Example 1-16 | B-3 | C-5 | 1,005 | 240 | (0.32, 0.62) | (0.35, 0.60) | (0.03, 0.02) |
| Example 1-17 | B-3 | C-6 | 1,087 | 198 | (0.32, 0.62) | (0.36, 0.61) | (0.03, 0.01) |
| Example 1-18 | B-3 | C-7 | 1,144 | 214 | (0.32, 0.62) | (0.35, 0.60) | (0.03, 0.02) |
| Example 1-19 | B-4 | C-1 | 1,133 | 241 | (0.31, 0.62) | (0.34, 0.61) | (0.03, 0.01) |
| Example 1-20 | B-4 | C-2 | 1,197 | 318 | (0.32, 0.62) | (0.35, 0.60) | (0.03, 0.02) |

As can be apparently seen from the above results, the devices in Examples of the invention show high driving durability (in particular, at the time of high luminance drive) and little in aberration of chromaticity after deterioration as compared with the devices in Comparative Examples. The light-emitting layers are manufactured by coating in Example 7, which is excellent in the point of manufacturing cost.

### INDUSTRIAL APPLICABILITY

According to the present invention, an organic electroluminescence device having high durability (in particular, at the time of high luminance drive) and little in aberration of chromaticity after deterioration of the device can be provided.

This application is based on Japanese patent application No. 2009-201154 filed on Aug. 31, 2009, the entire content of which is hereby incorporated by reference, the same as if set forth at length.

### REFERENCE SIGNS LIST

2: Substrate
3: Anode
4: Hole-injecting layer
5: Hole-transporting layer
6: Light-emitting layer
7: Hole-blocking layer
8: Electron-transporting layer
9: Cathode
10: Organic electroluminescence device (organic EL device)
11: Organic layer
12: Protective layer
14: Adhesive layer
16: Sealing enclosure
20: Light emission apparatus
30: Light-scattering member
30A: Light incident plane
30B: Light outgoing plane
32: Fine particle
40: Illumination apparatus

1-17. (canceled)

18. An organic electroluminescence device comprising, on a substrate:
a pair of electrodes; and
at least one organic layer between the pair of electrodes, the organic layer including a light-emitting layer containing a light-emitting material,
wherein the light-emitting layer contains at least each of a compound represented by the following formula (1) and a compound represented by the following formula (D-1): 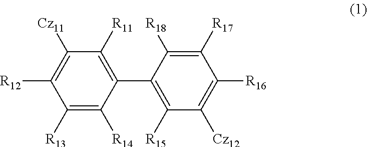
wherein R₁₁ to R₁₈ each independently represent a hydrogen atom, an alkyl group, or an aryl group; and
Cz₁₁ and Cz₁₂ each independently represent the following partial structure (Cz-1): 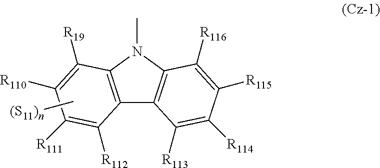
wherein R₁₉ to R₁₁₆ each independently represent a hydrogen atom or an alkyl group;
S₁₁ represents a group represented by the following (a), (b), (c), (d) or (e), which is substituted for any one of R₁₉ to R₁₁₂; and
n represents an integer of 0 or 1: 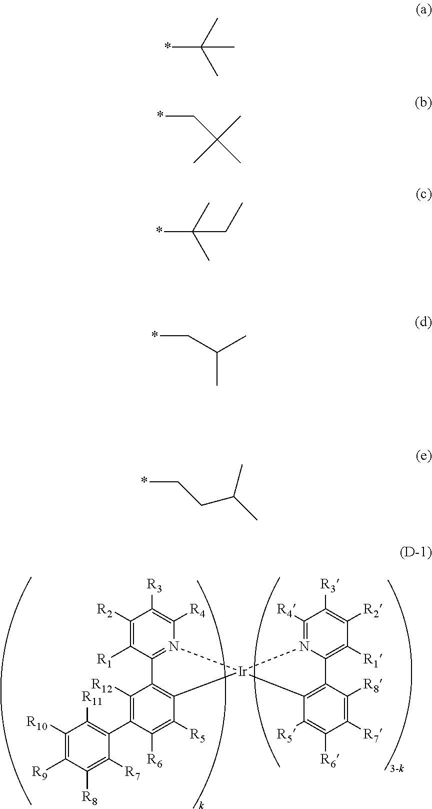
wherein R₁ to R₁₂ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
at least one of R₁ to R₁₂ and R₁′ to R₈′ represents an alkyl group or an aryl group; and
k is an integer of 0 to 3, and when k is 0, a total of the carbon atoms of R₁′ to R₈′ is 2 or more.

19. The organic electroluminescence device according to claim 18,
wherein the compound represented by formula (1) is a compound represented by the following formula (2): 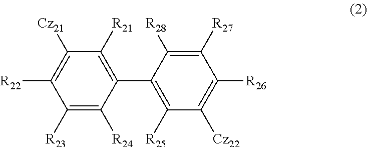
wherein R₂₁ to R₂₈ each independently represent a hydrogen atom, an alkyl group, or an aryl group; and
Cz₂₁ and Cz₂₂ each independently represent the following partial structure (Cz-2): 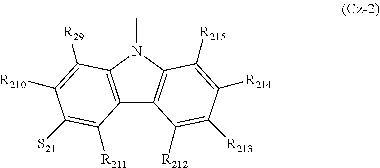
wherein R₂₉ to R₂₁₅ independently represents a hydrogen atom or an alkyl group; and
S₂₁ represents the group represented by the above (a), (b), (c), (d) or (e).

20. The organic electroluminescence device according to claim 18,
wherein the compound represented by formula (1) is a compound represented by the following formula (3): 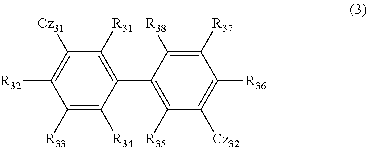
wherein R₃₁ to R₃₈ each independently represent a hydrogen atom, an alkyl group, or an aryl group; and
Cz₃₁ and Cz₃₂ each independently represent the following partial structure (Cz-3): 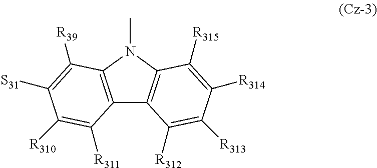
wherein R₃₉ to R₃₁₅ each independently represent a hydrogen atom or an alkyl group; and
S₃₁ represents the group represented by the above (a), (b), (c), (d) or (e).

21. The organic electroluminescence device according to claim 18,
wherein the compound represented by formula (D-1) is a compound represented by the following formula (D-2): 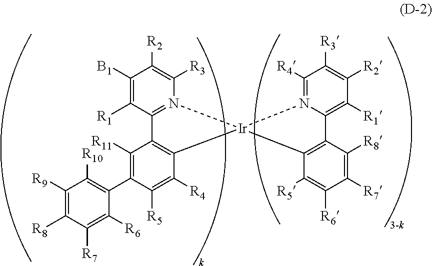
wherein R₁ to R₁₁ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
B₁ represents a methyl group, an isobutyl group, or a neopentyl group; and
k is an integer of 1 to 3.

22. The organic electroluminescence device according to claim 18,
wherein the compound represented by formula (D-1) is a compound represented by the following formula (D-3): 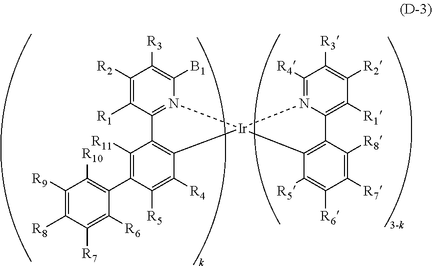
wherein R₁ to R₁₁ each independently represent a hydrogen atom, an alkyl group, an aryl group, a fluorine group, or a cyano group;
R₁′ to R₈′ each independently represent a hydrogen atom, alkyl group, a fluorine group, a trifluoromethyl group, or a cyano group;
B₁ represents a methyl group, an isobutyl group, or a neopentyl group; and
k is an integer of 1 to 3.

23. The organic electroluminescence device according to claim 18,
wherein the compound represented by formula (D-1) is a compound represented by the following formula (D-4): 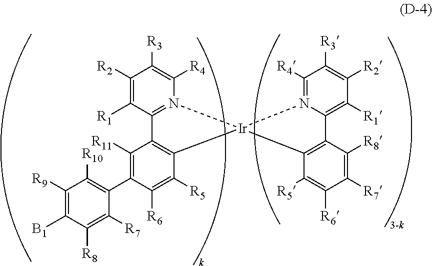
wherein R₁ to R₁₁ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
B₁ represents a methyl group, an isobutyl group, or a neopentyl group; and
k is an integer of 1 to 3.

24. The organic electroluminescence device according to claim 18,
wherein the compound represented by formula (D-1) is a compound represented by the following formula (D-5): 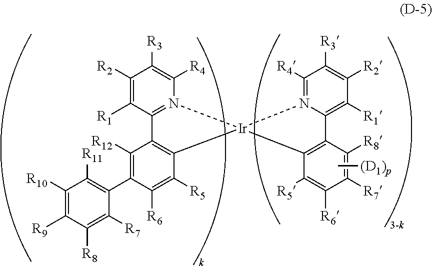
wherein R₁ to R₁₂ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
at least one of R₁ to R₁₂ and R₁′ to R₈′ represents a methyl group, an isobutyl group, or a neopentyl group;
D₁ represents an electron-withdrawing group selected from a fluorine atom, a trifluoromethyl group and a cyano group, which is substituted for any of R₅′ to R₈′, and D₁s may be the same with or different from every other D₁;
k represents an integer of 1 to 3; and
p represents an integer of 1 to 4.

25. The organic electroluminescence device according to claim 18,
wherein the compound represented by formula (D-1) is a compound represented by the following formula (D-6): 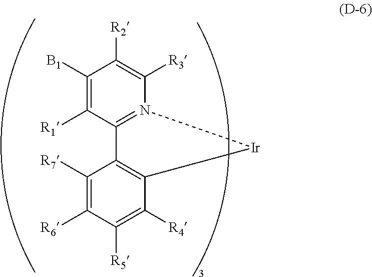
wherein R₁′ to R₇′ independently represent a hydrogen atom, an alkyl group, a fluorine group, a trifluoromethyl group, or a cyano group;
at least one of R₁′ to R₇′ represents an alkyl group; and
B₁ represents a methyl group, an isobutyl group, or a neopentyl group.

26. The organic electroluminescence device according to claim 18,
wherein the compound represented by formula (D-1) is a compound represented by the following formula (D-7): 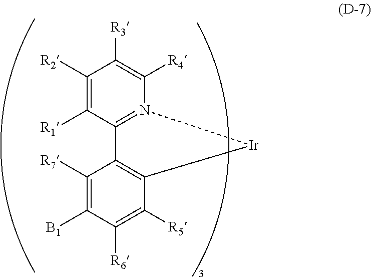
wherein R₁′ to R₇′ each independently represent a hydrogen atom, an alkyl group, a fluorine group, a trifluoromethyl group, or a cyano group;
at least one of R₁′ to R₇′ represents an alkyl group; and
B₁ represents a methyl group, an isobutyl group, or a neopentyl group.

27. The organic electroluminescence device according to claim 18,
wherein the light-emitting layer containing at least each of the compound represented by the above formula (1) and the compound represented by the above formula (D-1) is formed by a wet process.

28. A composition comprising at least each of a compound represented by the following formula (1) and a compound represented by the following formula (D-1): 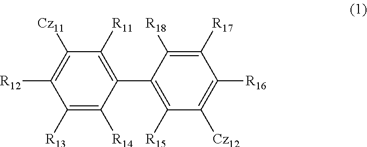
wherein R₁₁ to R₁₈ each independently represent a hydrogen atom, an alkyl group, or an aryl group; and
Cz₁₁ and Cz₁₂ each independently represent the following partial structure (Cz-1): 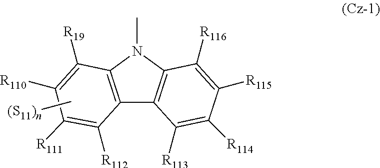
wherein R₁₉ to R₁₁₆ independently represent a hydrogen atom or an alkyl group;
S₁₁ represents the group represented by the following (a), (b), (c), (d) or (e), which is substituted for any one of R₁₉ to R₁₁₂, and
n represents an integer of 0 or 1: 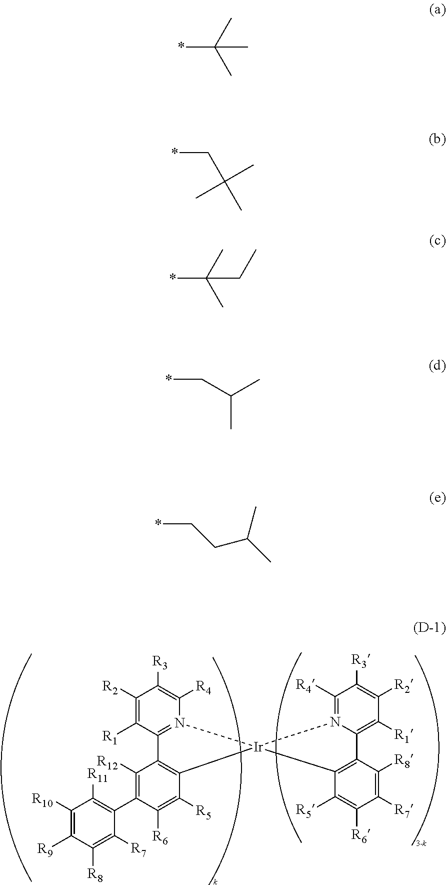
wherein R₁ to R₁₂ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
at least one of R₁ to R₁₂ and R₁′ to R₈′ represents an alkyl group or an aryl group; and
k is an integer of 0 to 3.

29. A light-emitting layer containing at least each of a compound represented by the following formula (1) and a compound represented by the following formula (D-1): 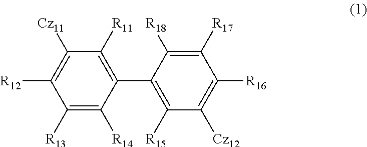
wherein R₁₁ to R₁₈ each independently represent a hydrogen atom, an alkyl group, or an aryl group; and
Cz₁₁ and Cz₁₂ each independently represent the following partial structure (Cz-1): 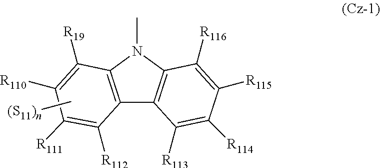
wherein R₁₉ to R₁₁₆ independently represent a hydrogen atom or an alkyl group;
S₁₁ represents the group represented by the following (a), (b), (c), (d) or (e), which is substituted for any one of R₁₉ to R₁₁₂, and
n represents an integer of 0 or 1: 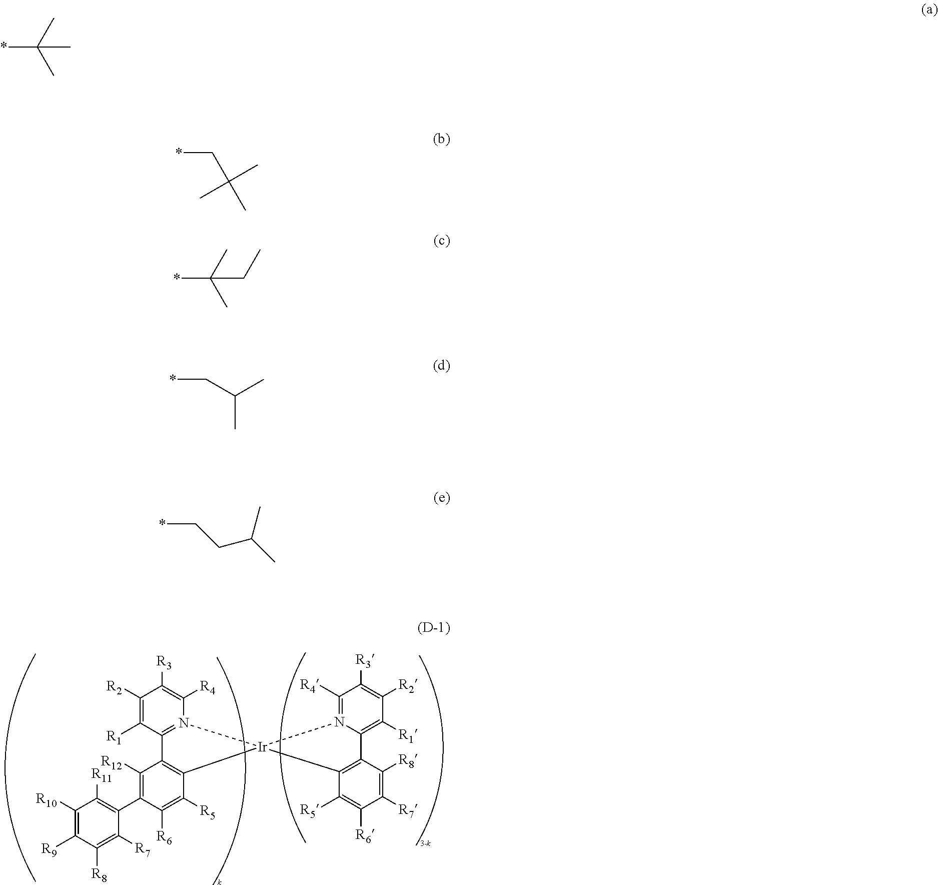
wherein R₁ to R₁₂ each independently represent a hydrogen atom, an alkyl group, an aryl group, a fluorine group, or a cyano group;
R₁′ to R₈′ each independently represent a hydrogen atom, an alkyl group, a fluorine group, a trifluoromethyl group, or a cyano group;
at least one of R₁ to R₁₂ and R₁′ to R₈′ represents an alkyl group or an aryl group; and
k is an integer of 0 to 3.

30. A light emission apparatus using the organic electroluminescence device according to claim 18.

31. A display apparatus using the organic electroluminescence device according to claim 18.

32. An illumination apparatus using the organic electroluminescence device according to claim 18.
